(19) United States
(12) Patent Application Publication
(10) Pub. No.: US 2016/0232457 A1
(43) Pub. Date: Aug. 11, 2016

(54) User Interface for Unified Data Science Platform Including Management of Models, Experiments, Data Sets, Projects, Actions and Features

(71) Applicant: Skytree, Inc., San Jose, CA (US)

(72) Inventors: Alexander Gray, Santa Clara, CA (US); Christopher Nelson, Los Altos, CA (US); Vladimir Rodeski, San Jose, CA (US); Lawrence Kite, Los Gatos, CA (US); Nitesh Kumar, Milpitas, CA (US); Maxsim Gibiansky, Sunnyvale, CA (US); Sachinder Chawla, Palo Alto, CA (US); Philip Song, San Jose, CA (US); Abhimanyu Aditya, San Jose, CA (US)

(21) Appl. No.: 15/042,086

(22) Filed: Feb. 11, 2016

Related U.S. Application Data
(60) Provisional application No. 62/115,135, filed on Feb. 11, 2015.

(51) Int. Cl. G06N 99/00; G06F 17/30; G06F 3/0482; G06F 3/0484; G06T 11/20

(52) U.S. Cl. CPC G06N 99/005; G06F 3/04842; G06T 11/206; G06F 3/0482; G06F 17/30572

(57) ABSTRACT

A system and method for providing various user interfaces is disclosed. In one embodiment, the various user interfaces include a series of user interfaces that guide a user through the machine learning process. In one embodiment, the various user interfaces are associated with a unified, project-based data scientist workspace to visually prepare, build, deploy, visualize and manage models, their results and datasets.

### CROSS REFERENCE TO RELATED APPLICATIONS

The present application claims priority, under 35 U.S.C. §119, of U.S. Provisional Patent Application No. 62/115,135, filed Feb. 11, 2015 and entitled “User Interface for Unified Data Science Platform Including Management of Models, Experiments, Data Sets, Projects, Actions, Reports and Features,” which is incorporated by reference in its entirety.

### BACKGROUND OF THE INVENTION

1. Field of the Invention

The present specification is related to facilitating analysis of big data. More specifically, the present specification relates to systems and method for providing a unified data science platform. Still more particularly, the present specification relates to user interfaces for a unified data science platform including management of models, experiments, data sets, projects, actions, reports and features.

2. Description of Related Art

The model creation process of the prior art is often described as a black art. At best, it is slow, tedious and inefficient process. At worst, it ultimately compromises model accuracy and delivers sub-optimal results more often than not. This is all exacerbated when the data sets are massive in the case of big data analysis. Existing solutions fail to be intuitive to the user with a learning curve that is intense and time consuming. Such a deficiency may lead to a decrease in user productivity as the user may waste effort trying to interpret the complexity inherent in data science without any success.

Thus, there is a need for a system and method that provides an enterprise class machine learning platform to automate data science and thus making machine learning much easier for enterprises to adopt and that provides intuitive user interfaces for the management and visualization of models, experiments, data sets, projects, actions, reports and features.

### SUMMARY OF THE INVENTION

The present invention overcomes one or more of the deficiencies of the prior art at least in part by providing a system and method for providing a unified, project-based data scientist workspace to visually prepare, build, deploy, visualize and manage models, their results and datasets.

According to one innovative aspect of the subject matter described in this disclosure, a system comprising one or more processors; and a memory including instructions that, when executed by the one or more processors, cause the system to: generate a data import interface for presentation to a user, the data import interface including a first set of one or more graphical elements that receive user interaction defining a dataset to be imported; generate a machine learning model creation interface for presentation to the user, the machine learning model creation interface including a second set of one or more graphical elements that receive user interaction defining a model to be generated; generate a model testing interface for presentation to the user, the model testing interface including a third set of one or more graphical elements defining a model to be tested and a test dataset; and generate a results interface for presentation to the user, the results interface including a fourth set of graphical elements informing the user of results obtained by testing the model to be tested with the test dataset.

In general, another innovative aspect of the subject matter described in this disclosure may be embodied in methods that include generating, using one or more processors, a data import interface for presentation to a user, the data import interface including a first set of one or more graphical elements that receive user interaction defining a dataset to be imported; generating, using the one or more processors, a machine learning model creation interface for presentation to the user, the machine learning model creation interface including a second set of one or more graphical elements that receive user interaction defining a model to be generated; generating, using the one or more processors, a model testing interface for presentation to the user, the model testing interface including a third set of one or more graphical elements defining a model to be tested and a test dataset; and generating, using the one or more processors, a results interface for presentation to the user, the results interface including a fourth set of graphical elements informing the user of results obtained by testing the model to be tested with the test dataset.

Other aspects include corresponding methods, systems, apparatus, and computer program products for these and other innovative features. These and other implementations may each optionally include one or more of the following features.

For instance, the operations further include: the first set of one or more graphical elements including a first graphical element, a second graphical element and one or more of a third and a fourth graphical element, and the method further comprises: receiving, via the user interacting with the first graphical element of the data import interface a user-defined source of the dataset to be imported; receiving, via the user interacting with the second graphical element of the data import interface, a user-defined file including the dataset to be imported; dynamically updating the data import interface for the user to preview at least a sample of the dataset to be imported; receiving, via user interaction with one or more of the third graphical element and the fourth graphical element of the data import interface, a selection of one or more of a text blob and identifier columns from the user, wherein the third graphical element, when interacted with by the user, selects a text blob column and the fourth graphical element, when interacted with by the user, selects an identifier column; and importing the dataset based on the user's interaction with the first graphical element, the second graphical element and one or more of the third graphical element and the fourth graphical element.

For instance, the operations further include: the second set of one or more graphical elements includes a first graphical element, a second graphical element, a third graphical element, a fourth element and a fifth graphical element, and the method further comprises: presenting to the user, via the first graphical element, a dataset used in generating the model to be generated; dynamically modifying the second graphical element based on one or more columns of the dataset to be used in generating the model; receiving, via user interaction with the second graphical element, a user-selected objective column to be used to generate the model, the objective column associated with the dataset to be used in generating the model; dynamically modifying a third graphical element to identify a type of machine learning task based on the received, user-selected objective column; dynamically modifying a fourth graphical element to include a set of one or more machine learning methods associated with the identified machine learning task; the set of machine learning methods omitting machine learning methods not associated with the machine learning task; dynamically modifying a fifth graphical element such that the fifth graphical element is associated with a user-definable parameter that is associated with a current selection from the set of a machine learning methods of the fourth graphical element; and generating, responsive to user input, the currently selected model using the user-definable parameter for the user-selected objective column of the dataset to be used for model generation. For instance, the features further include: the machine learning task is one of classification and regression. For instance, the features further include: the machine learning task is classification when the objective column is categorical and the machine learning task is regression when the objective column is continuous. For instance, the features further include: the machine learning task is one of classification and regression and the set of machine learning methods includes a plurality of machine learning methods associated with classification when the learning task is classification and the set of machine learning methods includes a plurality of machine learning methods associated with regression when the machine learning task is regression.

For instance, the operations further include: wherein the fourth set of one or more graphical elements includes one or more of a confusion matrix, a cost/benefit weighting, a score, and an interactive visualization of the results, wherein: the confusion matrix includes information about predicted positives and negatives and actual positives and negatives obtained when testing the model to be tested using the test dataset; the cost/benefit weighting, responsive to user interaction, changes the reward or penalty associated with one of more of a true positive, a true negative, a false positive and a false negative, the confusion matrix dynamically updated based on the cost/benefit weighting, the score includes one or more scoring metrics describing performance of the model to be tested subsequent to testing; and the interactive visualization presenting a visual representation of a portion of the results obtained by the testing. For instance, the features further include: wherein the fourth set of one or more graphical elements includes one or more of a graphical element associated with downloading one or more targets or labels, a graphical element associated with downloading one or more probabilities, and a graphical element that adjusts the probability threshold, wherein adjusting the probability threshold dynamically updates the score and the interactive visualization.

For instance, the operations further include: generating a visualization for presentation to the user, including one or more of a visualization of tuning results, a visualization of a tree, a visualization of importances, and a plot visualization, wherein the plot visualization includes one or more plots associated with one or more of a dataset, a model and a result.

According to yet another innovative aspect of the subject matter described in this disclosure, a system comprising: one or more processors; and a memory including instructions that, when executed by the one or more processors, cause the system to: generate a user interface associated with a machine learning project for presentation to a user, the user interface including a first graphical element, a second graphical element, a third graphical element, and a fourth graphical element, a data import interface for presentation to a user, wherein the first, second, third and fourth graphical elements are user selectable and a first portion of the user interface is modified based on which graphical element the user selects, the first, second, third and fourth graphical elements presented in a second portion of the user interface and the presentation of the first, second, third and fourth graphical elements is persistent regardless of which graphical element is selected except a selected graphical element is visually differentiated as the selected graphical element, the first graphical element associated with datasets for the machine learning project, and, when selected, the first portion of the user interface is modified to present a table of any datasets associated with the machine learning project and the first portion includes a graphical element to import a dataset, the second graphical element associated with models for the machine learning project, and, when selected, the first portion of the user interface is modified to present a table of any models associated with the machine learning project and the first portion includes a graphical element to create a new model, the third graphical element associated with results for the machine learning project, and, when selected, the first portion of the user interface is modified to present a table of any result sets associated with the machine learning project and the first portion includes a graphical element to create new results, and the fourth graphical element associated with plots for the machine learning project, and, when selected, the first portion of the user interface is modified to present any plots associated with the machine learning project and the first portion includes a graphical element to create a plot.

The present invention is particularly advantageous because it provides a unified, project-based data scientist workspace to visually prepare, build, deploy, visualize and manage models, their results and datasets. The unified workspace increases advanced data analytics adoption and makes machine learning accessible to a broader audience, for example, by providing a series of user interfaces to guide the user through the machine learning process in some embodiments. In some embodiments, the project-based approach allows users to easily manage items including projects, models, results, activity logs, and datasets used to build models, features, experiments, etc.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is an example block diagram of an embodiment of a system for automating data science tasks through intuitive user interfaces under a unified platform in accordance with the present invention.

FIG. 2 is a block diagram of an embodiment of a data science platform server in accordance with the present invention.

FIGS. 3A-3B are example graphical representations of embodiments of a user interface for importing a dataset.

FIG. 4 is an example graphical representation of an embodiment of a user interface displaying a list of datasets.

FIGS. 5A-5B are example graphical representations of an embodiment of a user interface displaying a model creation form for a classification model.

FIG. 6 is an example graphical representation of an embodiment of a user interface displaying a list of the models

FIG. 7 is an example graphical representation of an embodiment of a user interface displaying a model creation form for a regression model.

FIG. 8 is an example graphical representation of an embodiment of an updated user interface displaying a list of models.

FIG. 9 is an example graphical representation of an embodiment of a user interface displaying a model prediction and evaluation form.

FIG. 10 is an example graphical representation of an embodiment of a user interface displaying a list of results.

FIG. 11 is an example graphical representation of an embodiment of a user interface displaying a list of models.

FIG. 12 is an example graphical representation of another embodiment of a user interface displaying a model prediction and evaluation form.

FIG. 13 is an example graphical representation of an embodiment of an updated user interface displaying a list of results.

FIGS. 14A-14E are example graphical representations of embodiments of a user interface displaying details of results from testing a classification model.

FIG. 15 is an example graphical representation of an embodiment of a user interface displaying details of results from testing a regression model.

FIGS. 16A-16B are example graphical representations of embodiments of a user interface displaying upstream and downstream dependencies in a directed acyclic graph (DAG) for a classification model.

FIGS. 17A-17F are example graphical representations of embodiments of a user interface displaying details, tuning results, logs, visualizations, and model export options of a classification model.

FIGS. 18A-18B are example graphical representations of embodiments of a user interface displaying upstream and downstream dependencies in a directed acyclic graph (DAG) for a regression model.

FIGS. 19A-19F are example graphical representations of embodiments of a user interface displaying details, tuning results, logs, visualizations, and model export options of a regression model.

FIG. 20 is an example graphical representation of an embodiment of a user interface displaying an option for generating a plot.

FIGS. 21A-21G are example graphical representations of embodiments of a user interface displaying model visualization and result visualization of the classification model.

FIGS. 22A-22F are example graphical representations of embodiments of a user interface displaying model visualization and result visualization of the regression model.

FIG. 23 is an example graphical representation 2300 of another embodiment of a user interface displaying a list of datasets.

FIGS. 24A-24D are example graphical representations of embodiments of a user interface displaying data, features, scatter plot, and scatter plot matrices (SPLOM) for a dataset.

FIG. 25 is an example flowchart for a general method of guiding a user through machine learning model creation and evaluation according to one embodiment.

FIGS. 26A-B are an example flowchart for a more specific method of guiding a user through machine learning model creation and evaluation according to one embodiment.

FIG. 27 is an example flowchart for visualizing a dataset according to one embodiment.

FIG. 28 is an example flowchart for visualizing a model according to one embodiment.

FIG. 29 is an example flowchart for visualizing results according to one embodiment.

### DETAILED DESCRIPTION

A system and method for automating data science tasks through a user interface under a unified platform is described. In the following description, for purposes of explanation, numerous specific details are set forth in order to provide a thorough understanding of the invention. It will be apparent, however, to one skilled in the art that the invention may be practiced without these specific details. In other instances, structures and devices are shown in block diagram form in order to avoid obscuring the invention. For example, the present invention is described in one embodiment below with reference to particular hardware and software embodiments. However, the present invention applies to other types of implementations distributed in the cloud, over multiple machines, using multiple processors or cores, using virtual machines, appliances or integrated as a single machine.

Reference in the specification to “one implementation” or “an implementation” means that a particular feature, structure, or characteristic described in connection with the embodiment is included in at least one implementation of the invention. The appearances of the phrase “in one implementation” in various places in the specification are not necessarily all referring to the same implementation. In particular the present invention is described below in the context of multiple distinct architectures and some of the components are operable in multiple architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the method and system described herein, such as the logic, may also be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and so on.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is described without reference to any particular programming language. It will be appreciated that a variety of programming languages may be used to implement the teachings of the invention as described herein.

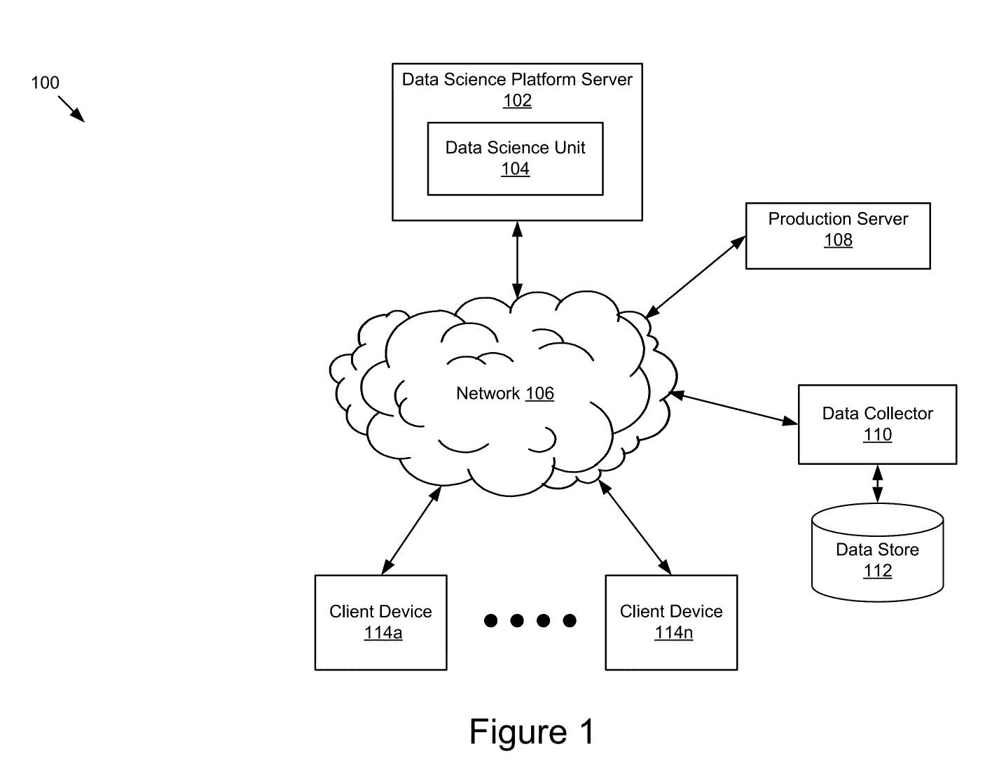

FIG. 1 shows an embodiment of a system 100 for automating data science tasks through intuitive user interfaces under a unified platform. In the depicted embodiment, the system 100 includes a data science platform server 102, a plurality of client devices 114a . . . 114n, a production server 108, a data collector 110 and associated data store 112. In FIG. 1 and the remaining figures, a letter after a reference number, e.g., “114a,” represents a reference to the element having that particular reference number. A reference number in the text without a following letter, e.g., “114,” represents a general reference to instances of the element bearing that reference number. In the depicted embodiment, these entities of the system 100 are communicatively coupled via a network 106.

In some implementations, the system 100 includes a data science platform server 102 coupled to the network 106 for communication with the other components of the system 100, such as the plurality of client devices 114a . . . 114n, the production server 108, and the data collector 110 and associated data store 112. In some implementations, the data science platform server 102 may either be a hardware server, a software server, or a combination of software and hardware. In some implementations, the data science platform server 102 is a computing device having data processing (e.g., at least one processor), storing (e.g., a pool of shared or unshared memory), and communication capabilities. For example, the data science platform server 102 may include one or more hardware servers, server arrays, storage devices and/or systems, etc.

In the example of FIG. 1, the components of the data science platform server 102 may be configured to implement data science unit 104 described in more detail below. In some implementations, the data science platform server 102 provides services to data analysis customers by providing intuitive user interfaces to automate data science tasks under an extensible and unified data science platform. For example, the data science platform server 102 automates data science operations such as model creation, model management, data preparation, report generations, visualizations and so on through user interfaces that change dynamically based on the context of the operation.

In some implementations, the data science platform server 102 may be a web server that couples with one or more client devices 114 (e.g., negotiating a communication protocol, etc.) and may prepare the data and/or information, such as forms, web pages, tables, plots, visualizations, etc. that is exchanged with one or more client devices 114. For example, the data science platform server 102 may generate a user interface to submit a set of data for processing and then return a user interface to display the results of machine learning method selection and parameter optimization as applied to the submitted data. Also, instead of or in addition, the data science platform server 102 may implement its own API for the transmission of instructions, data, results, and other information between the data science platform server 102 and an application installed or otherwise implemented on the client device 114.

Although only a single data science platform server 102 is shown in FIG. 1, it should be understood that there may be a number of data science platform servers 102 or a server cluster, which may be load balanced. Similarly, although only a production server 108 is shown in FIG. 1, it should be understood that there may be a number of production servers 108 or a server cluster, which may be load balanced.

The production server 108 is a computing device having data processing, storing, and communication capabilities. For example, the production server 108 may include one or more hardware servers, server arrays, storage devices and/or systems, etc. In some implementations, the production server 108 may include one or more virtual servers, which operate in a host server environment and access the physical hardware of the host server including, for example, a processor, memory, storage, network interfaces, etc., via an abstraction layer (e.g., a virtual machine manager). In some implementations, the production server 108 may include a web server (not shown) for processing content requests, such as a Hypertext Transfer Protocol (HTTP) server, a Representational State Transfer (REST) service, or other server type, having structure and/or functionality for satisfying content requests and receiving content from one or more computing devices that are coupled to the network 106 (e.g., the data science platform server 102, the data collector 110, the client device 114, etc.). In some implementations, the production server 108 may include machine learning models, receive a transformation sequence and/or machine learning models for deployment from the data science platform server 102, use the transformation sequence and/or models on a test dataset (in batch mode or online) for data analysis.

The data collector 110 is a server/service which collects data and/or analysis from other servers (not shown) coupled to the network 106. In some implementations, the data collector 110 may be a first or third-party server (that is, a server associated with a separate company or service provider), which mines data, crawls the Internet, and/or receives/retrieves data from other servers. For example, the data collector 110 may collect user data, item data, and/or user-item interaction data from other servers and then provide it and/or perform analysis on it as a service. In some implementations, the data collector 110 may be a data warehouse or belonging to a data repository owned by an organization. In some embodiments, the data collector 110 may receive data, via the network 106, from one or more of the data science platform server 102, a client device 114 and a production server 108. In some embodiments, the data collector 110 may receive data from real-time or streaming data sources.

The data store 112 is coupled to the data collector 108 and comprises a non-volatile memory device or similar permanent storage device and media. The data collector 110 stores the data in the data store 112 and, in some implementations, provides access to the data science platform server 102 to retrieve the data collected by the data store 112 (e.g. training data, response variables, rewards, tuning data, test data, user data, experiments and their results, learned parameter settings, system logs, etc.). In machine learning, a response variable, which may occasionally be referred to herein as a “response,” refers to a data feature containing the objective result of a prediction. A response may vary based on the context (e.g. based on the type of predictions to be made by the machine learning method). For example, responses may include, but are not limited to, class labels (classification), targets (general, but particularly relevant to regression), rankings (ranking/recommendation), ratings (recommendation), dependent values, predicted values, or objective values.

Although only a single data collector 110 and associated data store 112 is shown in FIG. 1, it should be understood that there may be any number of data collectors 110 and associated data stores 112. In some implementations, there may be a first data collector 110 and associated data store 112 accessed by the data science platform server 102 and a second data collector 110 and associated data store 112 accessed by the production server 108. It should also be recognized that a single data collector 112 may be associated with multiple homogenous or heterogeneous data stores (not shown) in some embodiments. For example, the data store 112 may include a relational database for structured data and a file system (e.g. HDFS, NFS, etc.) for unstructured or semi-structured data. It should also be recognized that the data store 112, in some embodiments, may include one or more servers hosting storage devices (not shown).

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another embodiment, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, WAP, email, etc.

The client devices 114a . . . 114n include one or more computing devices having data processing and communication capabilities. In some implementations, a client device 114 may include a processor (e.g., virtual, physical, etc.), a memory, a power source, a communication unit, and/or other software and/or hardware components, such as a display, graphics processor (for handling general graphics and multimedia processing for any type of application), wireless transceivers, keyboard, camera, sensors, firmware, operating systems, drivers, various physical connection interfaces (e.g., USB, HDMI, etc.). The client device 114a may couple to and communicate with other client devices 114n and the other entities of the system 100 via the network 106 using a wireless and/or wired connection.

A plurality of client devices 114a . . . 114n are depicted in FIG. 1 to indicate that the data science platform server 102 may communicate and interact with a multiplicity of users on a multiplicity of client devices 114a . . . 114n. In some implementations, the plurality of client devices 114a . . . 114n may include a browser application through which a client device 114 interacts with the data science platform server 102, an application installed enabling the client device 114 to couple and interact with the data science platform server 102, may include a text terminal or terminal emulator application to interact with the data science platform server 102, or may couple with the data science platform server 102 in some other way. In the case of a standalone computer embodiment of the data science task automation system 100, the client device 114 and data science platform server 102 are combined together and the standalone computer may, similar to the above, generate a user interface either using a browser application, an installed application, a terminal emulator application, or the like. In some implementations, the plurality of client devices 114a . . . 114n may support the use of Application Programming Interface (API) specific to one or more programming platforms to allow the multiplicity of users to develop program operations for analyzing, visualizing and generating reports on items including datasets, models, results, features, etc. and the interaction of the items themselves and to export the program operations for representation in a library.

Examples of client devices 114 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 114a and 114n are depicted in FIG. 1, the system 100 may include any number of client devices 114. In addition, the client devices 114a . . . 114n may be the same or different types of computing devices.

It should be understood that the present disclosure is intended to cover the many different embodiments of the system 100 that include the network 106, the data science platform server 102 having a data science unit 104, the production server 108, the data collector 110 and associated data store 112, and one or more client devices 114. In a first example, the data science platform server 102 and the production server 108 may each be dedicated devices or machines coupled for communication with each other by the network 106. In a second example, any one or more of the servers 102 and 108 may each be dedicated devices or machines coupled for communication with each other by the network 106 or may be combined as one or more devices configured for communication with each other via the network 106. For example, the data science platform server 102 and the production server 108 may be included in the same server. In a third example, any one or more of the servers 102 and 108 may be operable on a cluster of computing cores in the cloud and configured for communication with each other. In a fourth example, any one or more of one or more servers 102 and 108 may be virtual machines operating on computing resources distributed over the internet. In a fifth example, any one or more of the servers 102 and 108 may each be dedicated devices or machines that are firewalled or completely isolated from each other (i.e., the servers 102 and 108 may not be coupled for communication with each other by the network 106). For example, the data science platform server 102 and the production server 108 may be included in different servers that are firewalled or completely isolated from each other.

While the data science platform server 102 and the production server 108 are shown as separate devices in FIG. 1, it should be understood that in some embodiments, the data science platform server 102 and the production server 108 may be integrated into the same device or machine. Particularly, where they are performing online learning, a unified configuration may be preferred. While the system 100 shows only one device 102, 106, 108, 110 and 112 of each type, it should be understood that there could be any number of devices of each type. Moreover, it should be understood that some or all of the elements of the system 100 could be distributed and operate in the cloud using the same or different processors or cores, or multiple cores allocated for use on a dynamic as needed basis. Furthermore, it should be understood that the data science platform server 102 and the production server 108 may be firewalled from each other and have access to separate data collector 110 and associated data store 112. For example, the data science platform server 102 and the production server 108 may be in a network isolated configuration.

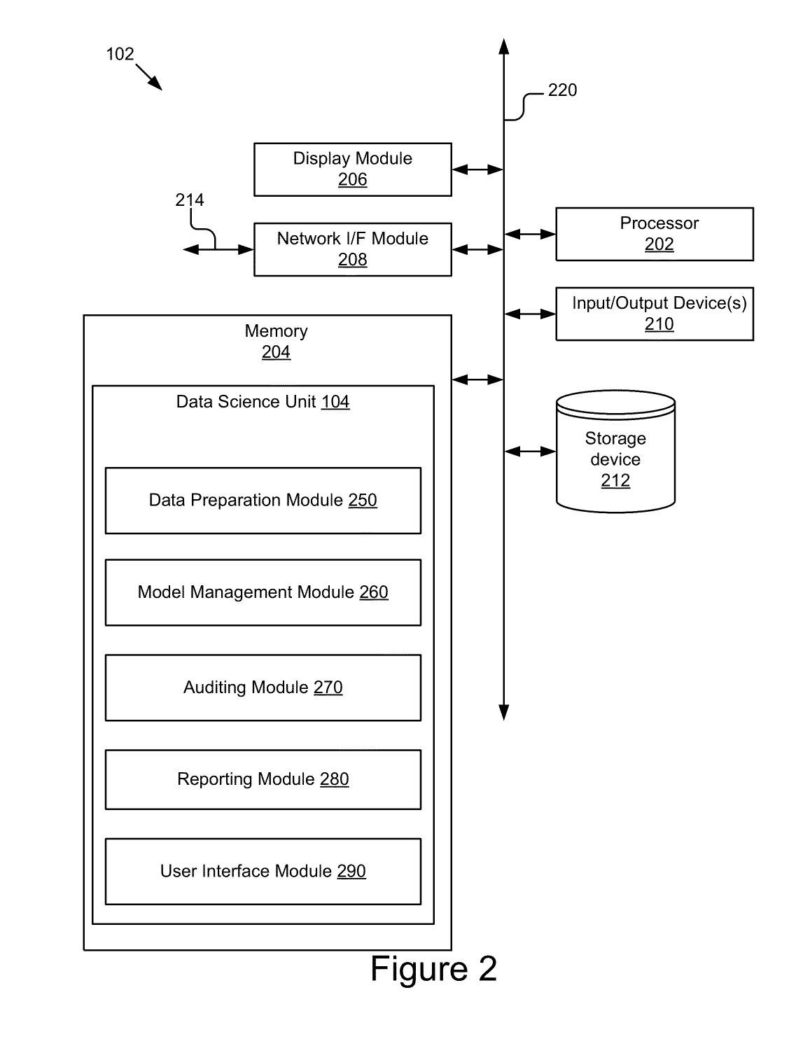

Referring now to FIG. 2, an embodiment of a data science platform server 102 is described in more detail. The data science platform server 102 comprises a processor 202, a memory 204, a display module 206, a network I/F module 208, an input/output device 210 and a storage device 212 coupled for communication with each other via a bus 220. The data science platform server 102 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the data science platform server 102 may include various operating systems, sensors, additional processors, and other physical configurations.

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays and physical configurations are possible. In some implementations, the processor(s) 202 may be coupled to the memory 204 via the bus 220 to access data and instructions therefrom and store data therein. The bus 220 may couple the processor 202 to the other components of the data science platform server 102 including, for example, the display module 206, the network I/F module 208, the input/output device(s) 210, and the storage device 212.

The memory 204 may store and provide access to data to the other components of the data science platform server 102. The memory 204 may be included in a single computing device or a plurality of computing devices. In some implementations, the memory 204 may store instructions and/or data that may be executed by the processor 202. For example, as depicted in FIG. 2, the memory 204 may store the data science unit 104, and its respective components, depending on the configuration. The memory 204 is also capable of storing other instructions and data, including, for example, an operating system, hardware drivers, other software applications, databases, etc. The memory 204 may be coupled to the bus 220 for communication with the processor 202 and the other components of data science platform server 102.

The instructions stored by the memory 204 and/or data may comprise code for performing any and/or all of the techniques described herein. The memory 204 may be a dynamic random access memory (DRAM) device, a static random access memory (SRAM) device, flash memory or some other memory device known in the art. In some implementations, the memory 204 also includes a non-volatile memory such as a hard disk drive or flash drive for storing information on a more permanent basis. The memory 204 is coupled by the bus 220 for communication with the other components of the data science platform server 102. It should be understood that the memory 204 may be a single device or may include multiple types of devices and configurations.

The display module 206 may include software and routines for sending processed data, analytics, or results for display to a client device 114, for example, to allow an administrator to interact with the data science platform server 102. In some implementations, the display module may include hardware, such as a graphics processor, for rendering interfaces, data, analytics, or recommendations.

The network I/F module 208 may be coupled to the network 106 (e.g., via signal line 214) and the bus 220. The network I/F module 208 links the processor 202 to the network 106 and other processing systems. The network I/F module 208 also provides other conventional connections to the network 106 for distribution of files using standard network protocols such as TCP/IP, HTTP, HTTPS and SMTP as will be understood to those skilled in the art. In an alternate embodiment, the network I/F module 208 is coupled to the network 106 by a wireless connection and the network I/F module 208 includes a transceiver for sending and receiving data. In such an alternate embodiment, the network I/F module 208 includes a Wi-Fi transceiver for wireless communication with an access point. In another alternate embodiment, network I/F module 208 includes a Bluetooth® transceiver for wireless communication with other devices. In yet another embodiment, the network I/F module 208 includes a cellular communications transceiver for sending and receiving data over a cellular communications network such as via short messaging service (SMS), multimedia messaging service (MMS), hypertext transfer protocol (HTTP), direct data connection, WAP, email, etc. In still another embodiment, the network I/F module 208 includes ports for wired connectivity such as but not limited to USB, SD, or CAT-5, CAT-5e, CAT-6, fiber optic, etc.

The input/output device(s) (“I/O devices”) 210 may include any device for inputting or outputting information from the data science platform server 102 and may be coupled to the system either directly or through intervening I/O controllers. The I/O devices 210 may include a keyboard, mouse, camera, stylus, touch screen, display device to display electronic images, printer, speakers, etc. An input device may be any device or mechanism of providing or modifying instructions in the data science platform server 102. An output device may be any device or mechanism of outputting information from the data science platform server 102, for example, it may indicate status of the data science platform server 102 such as: whether it has power and is operational, has network connectivity, or is processing transactions.

The storage device 212 is an information source for storing and providing access to data, such as a plurality of datasets, transformations, model(s) and transformation pipeline associated with the plurality of datasets. The data stored by the storage device 212 may be organized and queried using various criteria including any type of data stored by it. The storage device 212 may include data tables, databases, or other organized collections of data. The storage device 212 may be included in the data science platform server 102 or in another computing system and/or storage system distinct from but coupled to or accessible by the data science platform server 102. The storage device 212 may include one or more non-transitory computer-readable mediums for storing data. In some implementations, the storage device 212 may be incorporated with the memory 204 or may be distinct therefrom. In some implementations, the storage device 212 may store data associated with a relational database management system (RDBMS) operable on the data science platform server 102. For example, the RDBMS could include a structured query language (SQL) RDBMS, a NoSQL RDMBS, various combinations thereof, etc. In some instances, the RDBMS may store data in multi-dimensional tables comprised of rows and columns, and manipulate, e.g., insert, query, update and/or delete, rows of data using programmatic operations. In some implementations, the storage device 212 may store data associated with a Hadoop distributed file system (HDFS) or a cloud based storage system such as Amazon™ S3.

The bus 220 represents a shared bus for communicating information and data throughout the data science platform server 102. The bus 220 may include a communication bus for transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the data science platform server 102 (operating systems, device drivers, etc.), and any of the components of the data science unit 104 may cooperate and communicate via a communication mechanism included in or implemented in association with the bus 220. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

As depicted in FIG. 2, the data science unit 104 may include and may signal the following to perform their functions: a data preparation module 250 that imports a dataset from a data source (for example, from the data collector 110 and associated data store 112, the client device 114, the storage device 212, etc.), processes the dataset for extracting metadata and stores the metadata in the storage device 212, a model management module 260 that manages the training, testing and tuning of models, an auditing module 270 that generates an audit trail for documenting changes in datasets, models, results, and other items, a reporting module 280 that generates reports, visualizations plots on items and a user interface module 290 that cooperates and coordinates with other components of the data science unit 104 to generate a user interface that may present the user experiments, features, models, data sets, or projects. These components 250, 260, 270, 280, 290, and/or components thereof, may be communicatively coupled by the bus 220 and/or the processor 202 to one another and/or the other components 206, 208, 210, and 212 of the data science platform server 102. In some implementations, the components 250, 260, 270, 280 and/or 290 may include computer logic (e.g., software logic, hardware logic, etc.) executable by the processor 202 to provide their acts and/or functionality. In any of the foregoing implementations, these components 250, 260, 270, 280 and/or 290 may be adapted for cooperation and communication with the processor 202 and the other components of the data science platform server 102.

It should be recognized that the data science unit 104 and disclosure herein applies to and may work with Big Data, which may have billions or trillions of elements (rows x columns) or even more, and that the user interface elements are adapted to scale to deal with such large datasets, resulting large models and results and provide visualization, while maintaining intuitiveness and responsiveness to interactions.

The data preparation module 250 includes computer logic executable by the processor 202 to receive a request from a user to import a dataset from various information sources, such as computing devices (e.g. servers) and/or non-transitory storage media (e.g., databases, Hard Disk Drives, etc.). In some implementations, the data preparation module 250 imports data from one or more of the servers 108, the data collector 110, the client device 114, and other content or analysis providers. For example, the data preparation module 250 may import a local file. In another example, the data preparation module 250 may link to a dataset from a non-local file (e.g. a Hadoop distributed file system (HDFS)). In some implementations, the data preparation module 250 processes a sample of the dataset and sends instructions to the user interface module 290 to generate a preview of the sample of the dataset. In some implementations, the data preparation module 250 identifies a text blob column in the dataset. For example, the text blob column may include a path to an external file or an inline piece of text that can be large. The data preparation module 250 performs special data preparation processing to import the external file during the import of the dataset. In some implementations, the data preparation module 250 processes the imported dataset to retrieve metadata. For example, the metadata can include, but is not limited to, name of the feature or column, a type of the feature (e.g., integer, text, etc.), whether the feature is categorical (e.g., true or false), a distribution of the feature in the dataset based on whether the data state is sample or full, a dictionary (e.g., when the feature is categorical), a minimum value, a maximum value, mean, standard deviation (e.g. when the feature is numerical), etc. In some implementations, the data preparation module 250 scans the dataset on import and automatically infers the data types of the columns in the dataset based on rules and/or heuristics and/or dynamically using machine learning. For example, the data preparation module 209 may identify a column as categorical based on a rule. In another example, the data preparation module 209 may determine that 80 percent of the values in a column to be unique and may identify that column to be an identifier type column of the dataset. In yet another example, the data preparation module 209 may detect time series of values, monotonic variables, etc. in columns to determine appropriate data types. In some implementations, the data preparation module 250 determines the column types in the dataset based on machine learning on data from past usage.

The model management module 260 includes computer logic executable by the processor 202 for generating one or more models based on the data prepared by the data preparation module 250. In some implementations, the model management module 260 includes a one-step process to train, tune and test models. The model management module 260 may use any number of various machine learning techniques to generate a model. In some implementations, the model management module 260 automatically and simultaneously selects between distinct machine learning models and finds optimal model parameters for various machine learning tasks. Examples of machine learning tasks include, but are not limited to, classification, regression, and ranking. The performance can be measured by and optimized using one or more measures of fitness. The one or more measures of fitness used may vary based on the specific goal of a project. Examples of potential measures of fitness include, but are not limited to, error rate, F-score, area under curve (AUC), Gini, precision, performance stability, time cost, etc. In some implementations, the model management module 260 provides the machine learning specific data transformations used most by data scientists when building machine learning models, significantly cutting down the time and effort needed for data preparation on big data.

In some implementations, the model management module 260 identifies variables or columns in a dataset that were important to the model being built and sends the variables to the reporting module 280 for creating partial dependence plots (PDP). In some implementations, the model management module 260 determines the tuning results of models being built and sends the information to the user interface module 290 for display. In some implementations, the model management module 260 stores the one or more models in the storage device 212 for access by other components of the data science unit 104. In some implementations, the model management module 260 performs testing on models using test datasets, generates results and stores the results in the storage device 212 for access by other components of the data science unit 104.

The auditing module 270 includes computer logic executable by the processor 202 to create a full audit trail of models, projects, datasets, results and other items. In some implementations, the auditing module 270 creates self-documenting models with an audit trail. Thus, the auditing module 270 improves model management and governance with self-documenting models, which includes a full audit trail. The auditing module 270 generates an audit trail for items so that they may be reviewed to see when/how they were changed and who made the changes. Moreover, models generated by the model management module 260 automatically document all datasets, transformations, algorithms and results, which are displayed in an easy to understand visual format. The auditing module 270 tracks all changes and creates a full audit trail that includes information on what changes were made, when and by whom. This level of model management and governance is critical for data science teams working in enterprises of all sizes, including regulated industries. The auditing module 270 also provide the rewind function that allows a user to re-create any past pipelines. The auditing module 270 also tracks software versioning information. The auditing module 270 also records the provenance of data sets, models and other files. The auditing module 270 also provides for file importation and review of files or previous versions.

The reporting module 280 includes computer logic executable by the processor 202 for generates reports, visualizations, and plots on items including models, datasets, results, etc. In some implementations, the reporting module 280 determines a visualization that is a best fit based on variables being compared. For example, in partial dependence plot visualization, if the two PDP variables being compared are categorical-categorical, then the plot may be heat map visualization. In another example, if the two PDP variables being compared are continuous-categorical, then the plot may be a bar chart visualization. In some implementations, the reporting module 280 receives one or more custom visualizations developed in different programming platforms from the client devices 114, receives metadata relating to the custom visualizations and adds the visualizations to the visualization library, and makes the visualizations accessible across project-to-project, model-to-model or user-to-user through the visualization library.

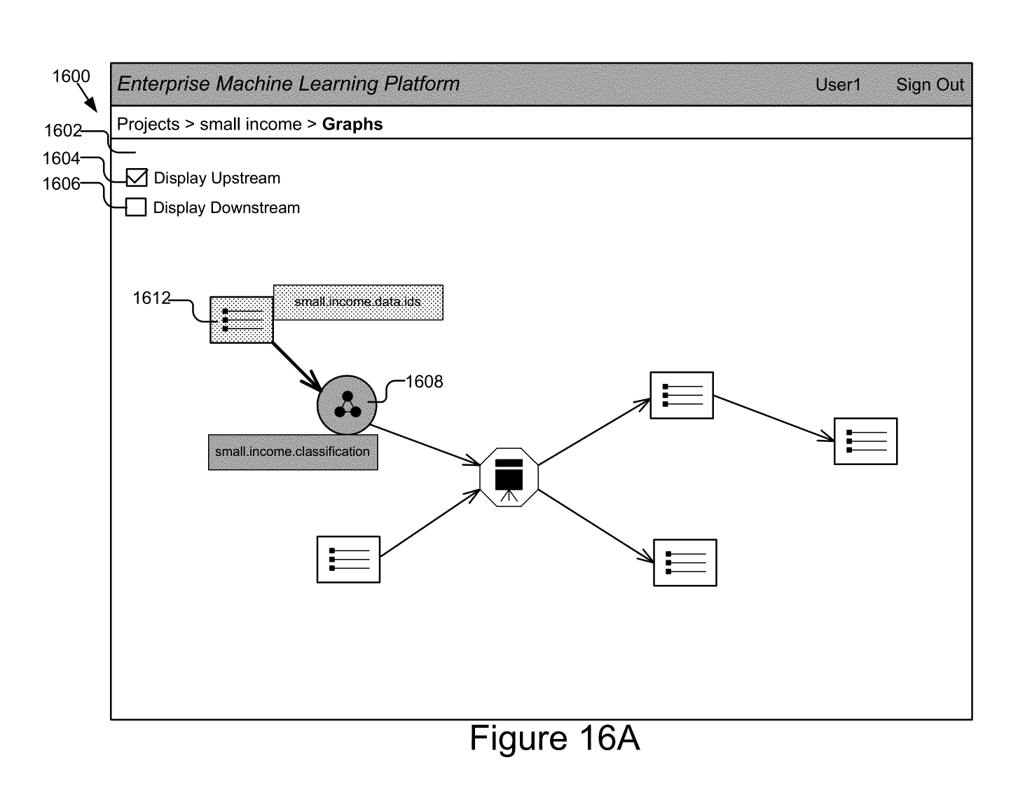

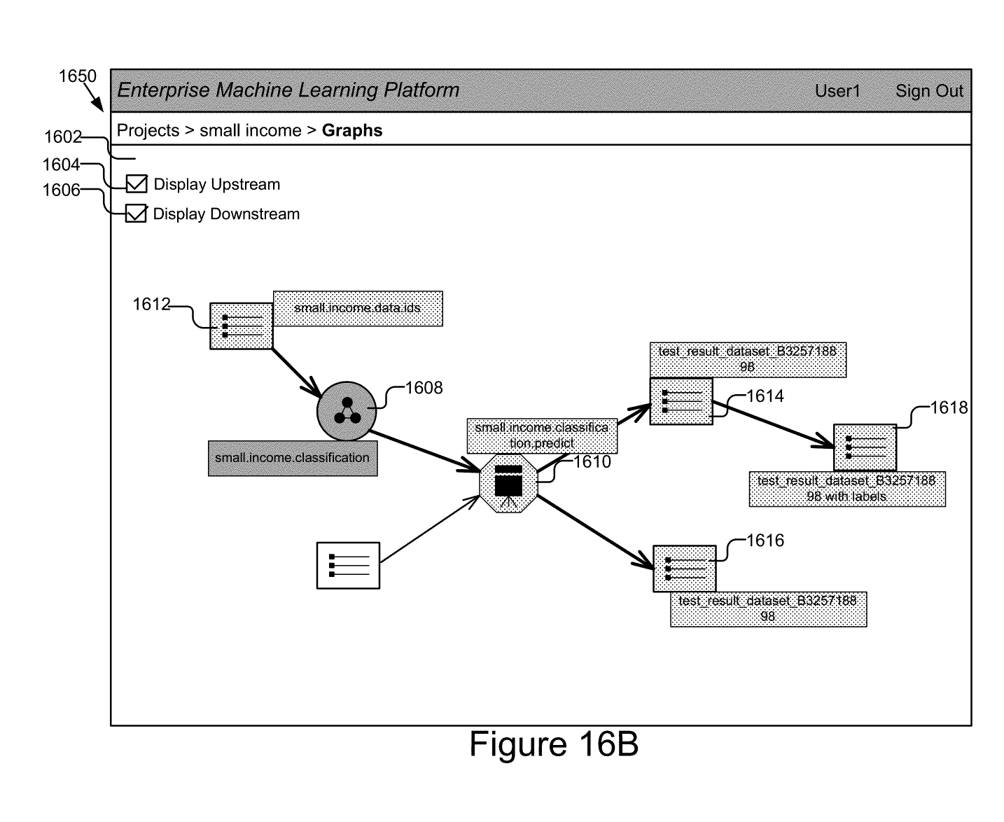

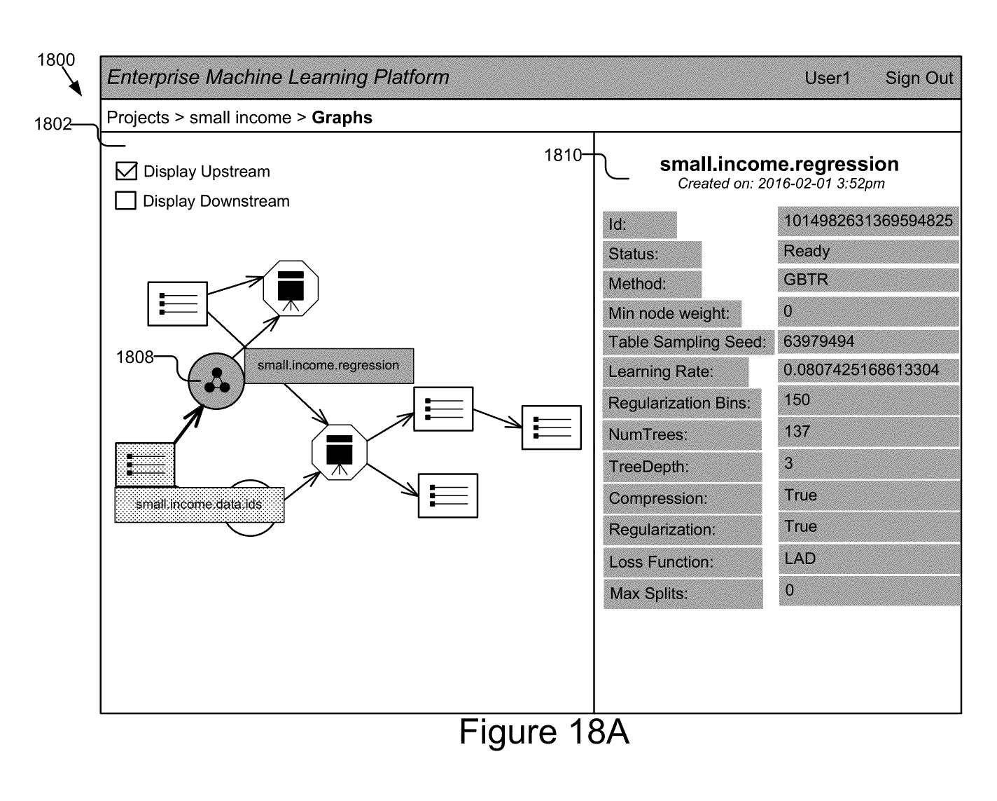

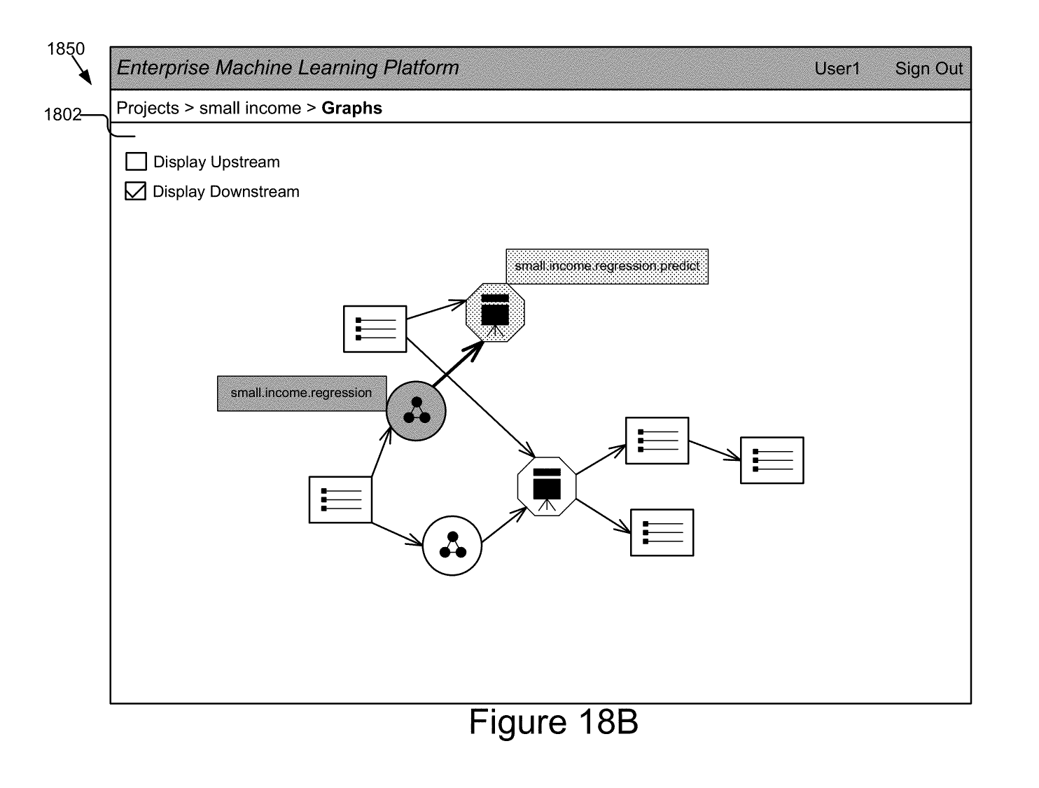

In some implementations, the reporting module 280 cooperates with the user interface module 290 to identify any information provided in the user interfaces to be output in a report format individually or collectively. Moreover, the visualizations, the interaction of the items (e.g., experiments, features, models, data sets, and projects), the audit trail or any other information provided by the user interface module 290 can be output as a report. For example, the reporting module 280 allows for the creation of directed acyclic graphs (DAG) and a representation of it in the user interface as shown below in example of FIGS. 16A-16B and 18A-18B. The reporting module 280 generates the reports in any number of formats including, MS-PowerPoint, portable document format, HTML, XML, etc.

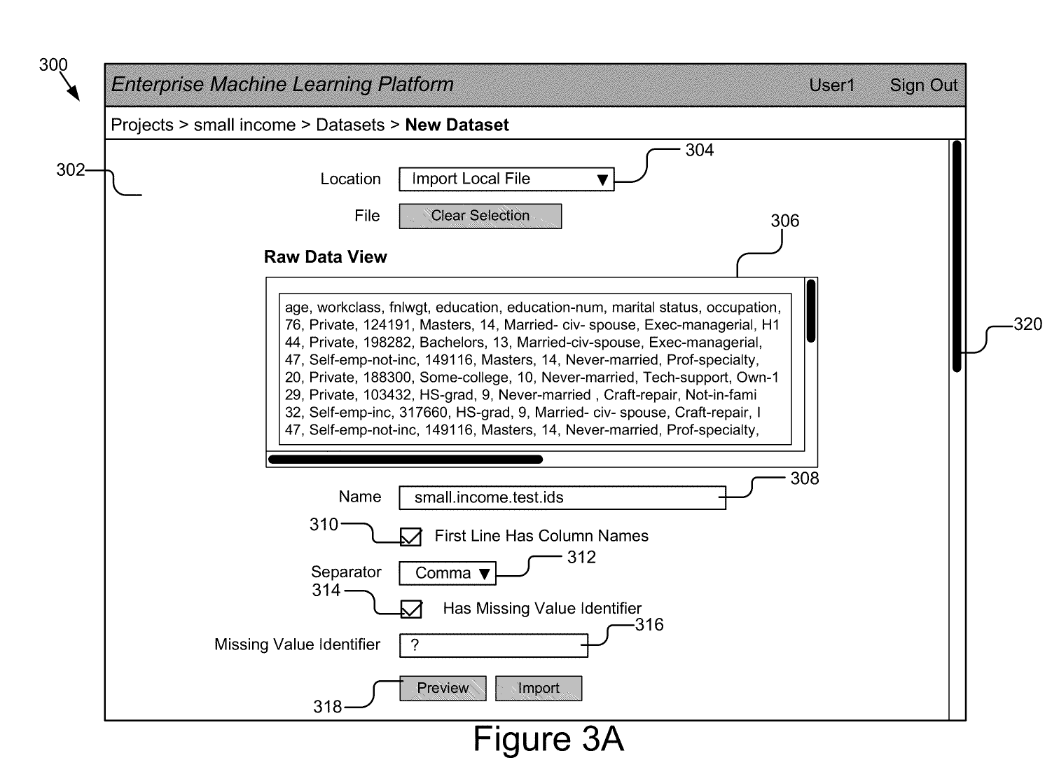

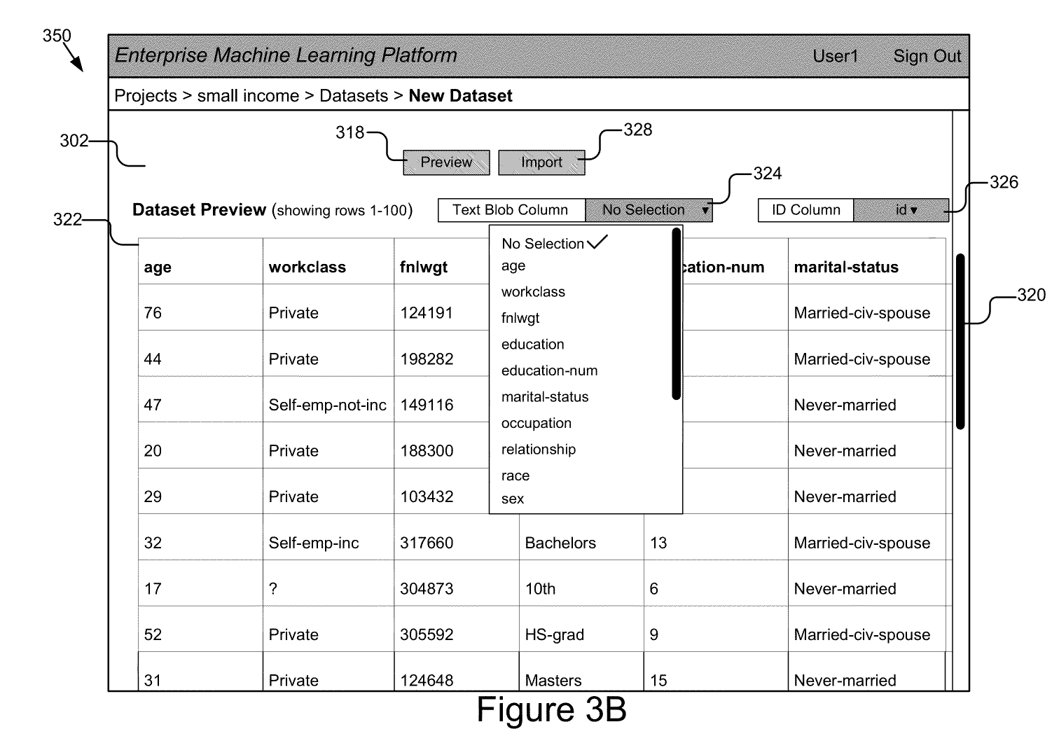

The user interface module 290 includes computer logic executable by the processor 202 for creating any or all of the user interfaces illustrated in FIGS. 3A-24D and providing optimized user interfaces, control buttons and other mechanisms. In some implementations, the user interface module 290 provides a unified, project-based data scientist workspace to visually prepare, build, deploy, visualize and manage models. The unified workspace increases advanced data analytics adoption and makes machine learning accessible to a broader audience, for example, by providing a series of user interfaces to guide the user through the machine learning process in some embodiments. The project-based approach allows users to easily manage items including projects, models, results, activity logs, and datasets used to build models, features, experiments, etc. In one embodiment, the user interface module 290 provides at least a subset of the items in a table or database of each of the items with the controls and operations applicable to the items. Examples of the unified workspace are shown in user interfaces illustrated in FIGS. 3A-24D and described in detail below.

In some implementations, the user interface module 290 cooperates and coordinates with other components of the data science unit 104 to generate a user interface that allows the user to perform operations on experiments, features, models, data sets and projects in the same user interface. This is advantageous because it may allow the user to perform operations and modifications to multiple items at the same time. The user interface includes graphical elements that are interactive. The graphical elements can include, but are not limited to, radio buttons, selection buttons, checkboxes, tabs, drop down menus, scrollbars, tiles, text entry fields, icons, graphics, directed acyclic graph (DAG), plots, tables, etc.

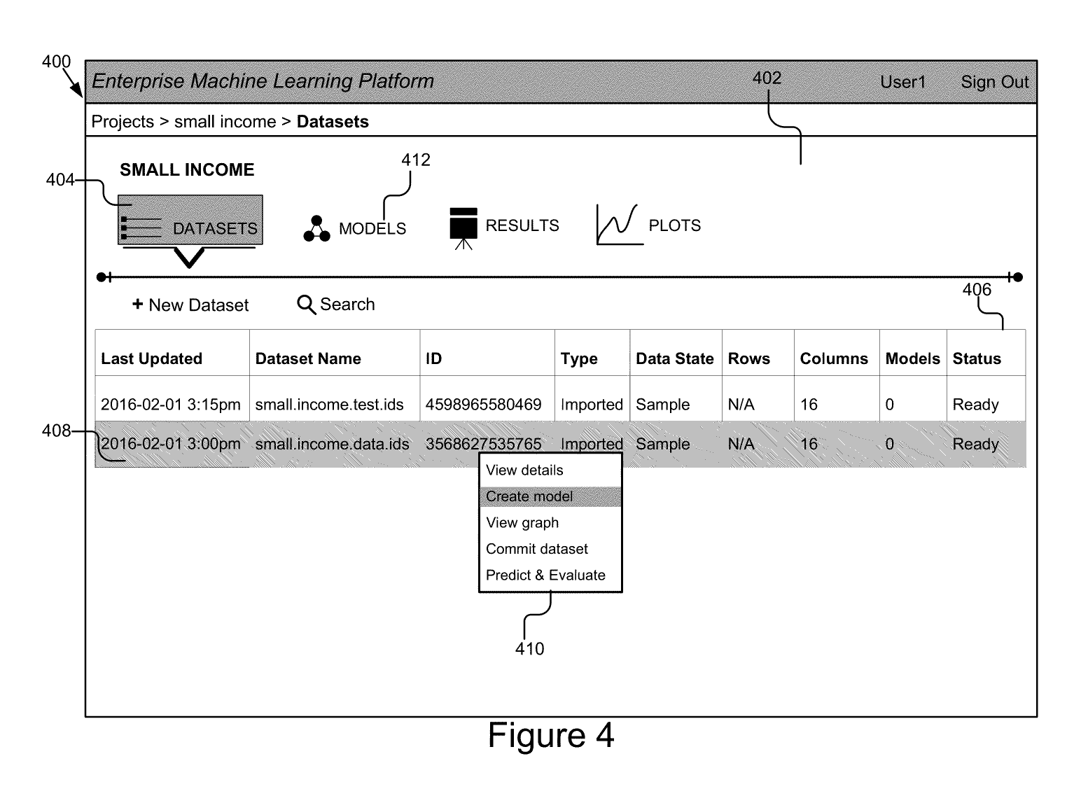

In some implementations, the user interface module 290 receives processed information of a dataset from the data preparation module 250 and generates a user interface for importing the dataset. The processed information may include, for example, a preview of the dataset that can be displayed to the user in the user interface. In one embodiment, the preview samples a set of rows from the dataset which the user may verify and then confirm in the user interface for importing the dataset as shown in the example of FIGS. 3A-3B. The user interface module 290 provides the imported datasets in a table with controls, options and operations applicable to the datasets and based on the key characteristics of the datasets as shown in the example of FIG. 4. In some implementations, the user interface module 290 receives relevant metadata determined for the dataset on import from the data preparation module 250.

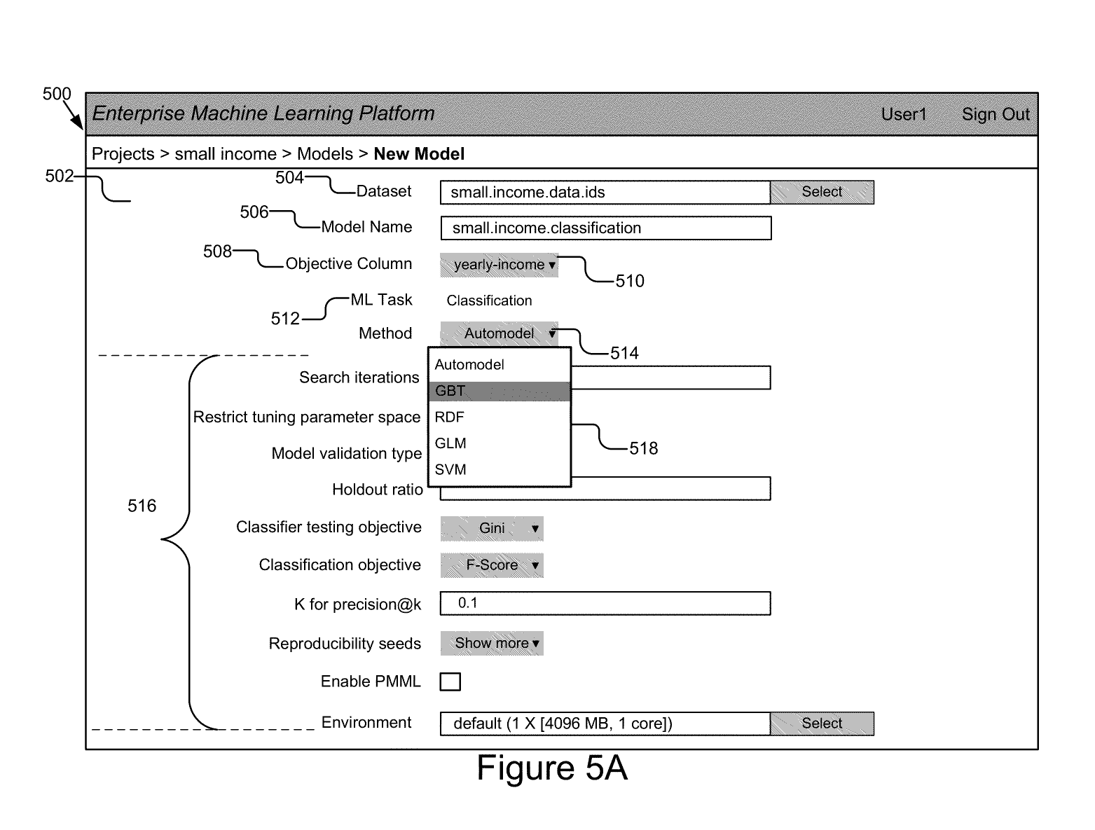

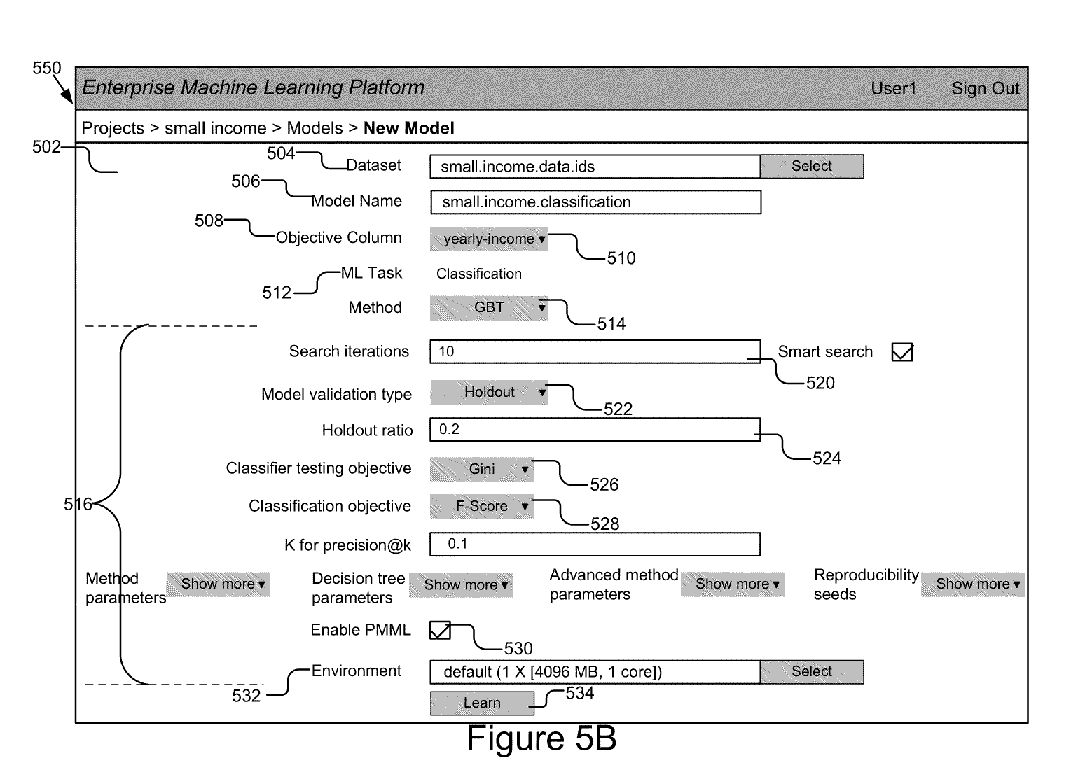

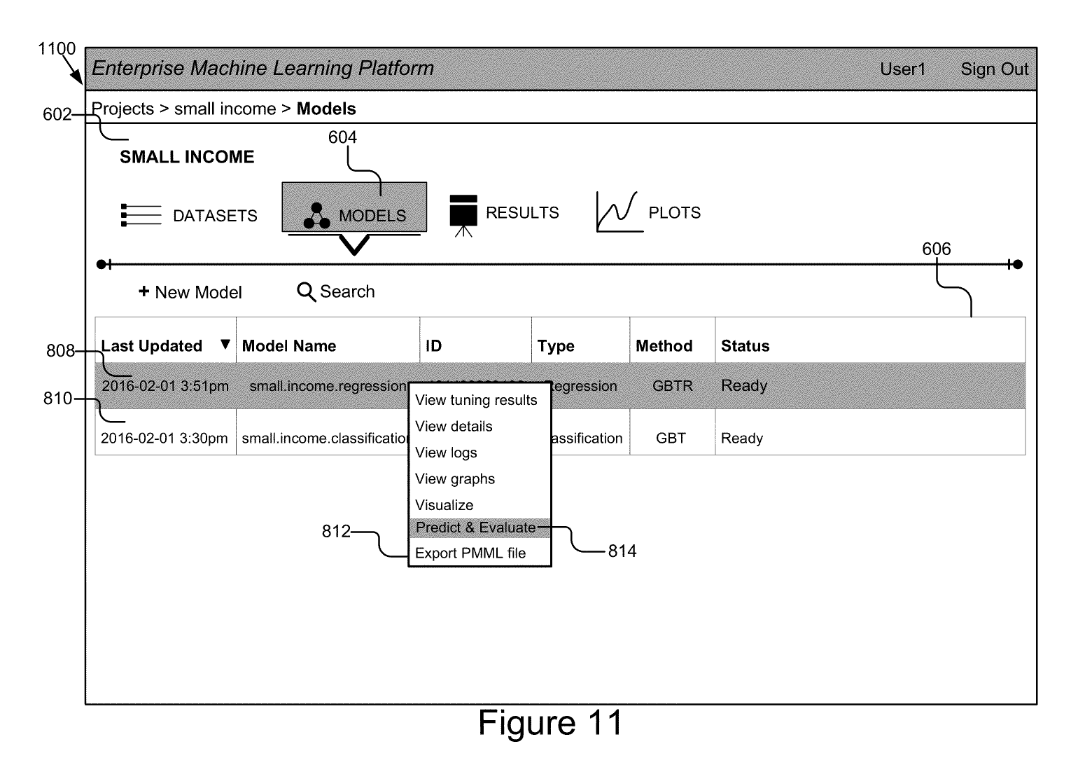

In some implementations, the user interface module 290 cooperates with other components of the data science unit 104 to recommend a next, suggested action to the user on the user interface. In some implementations, the user interface module 290 generates a user interface including a form that serves as a guiding wizard in building a model. The user interface module 290 receives a library of machine learning models from the model management module 260 and updates the user interface to include the models in a menu for user selection. The user interface module 290 receives the location of the dataset from the data preparation module 250 for presenting in the user interface. The user interface module 290 receives a selection of a model from the user on the user interface. The user interface module 290 requests a specification of the model from the model management module 260. The user interface module 290 identifies what set of parameters the selected model expects as input parameters and dynamically updates the parameters on the form of the user interface to guide the user in building the model as shown in the examples of FIGS. 5A-5B. In some implementations, the user interface module 209 generates a user interface that lists the models generated on datasets as entries in a table for the user to manage the models as shown in the example of FIG. 11.

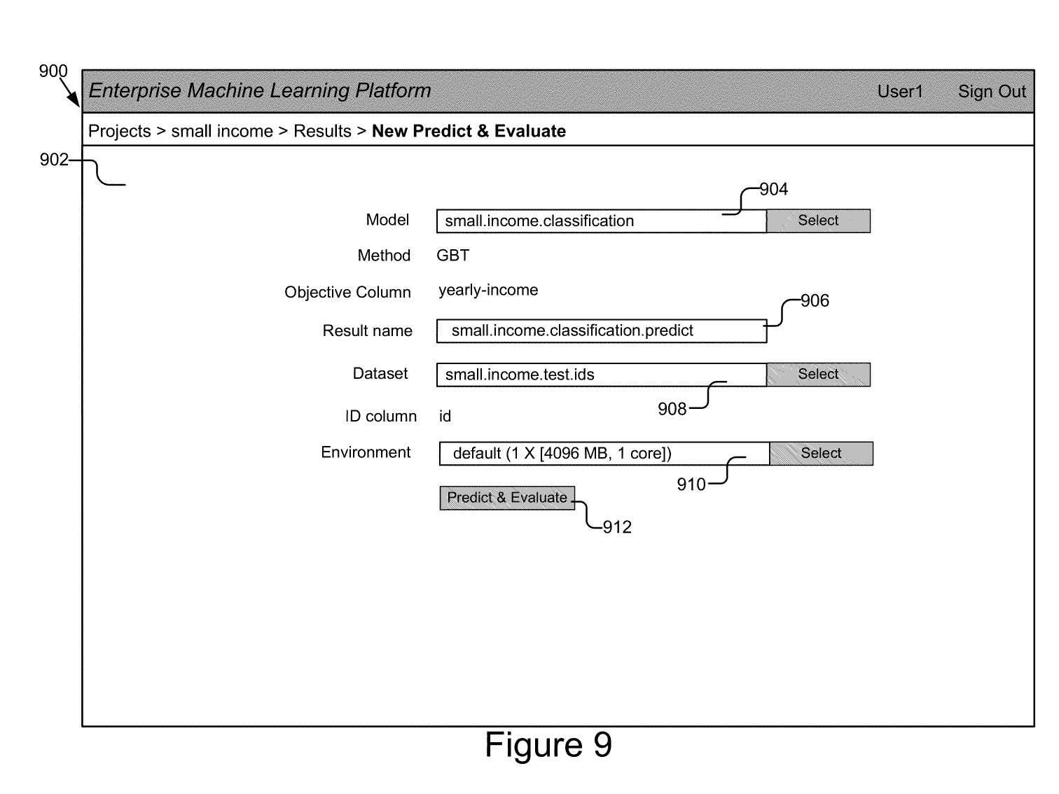

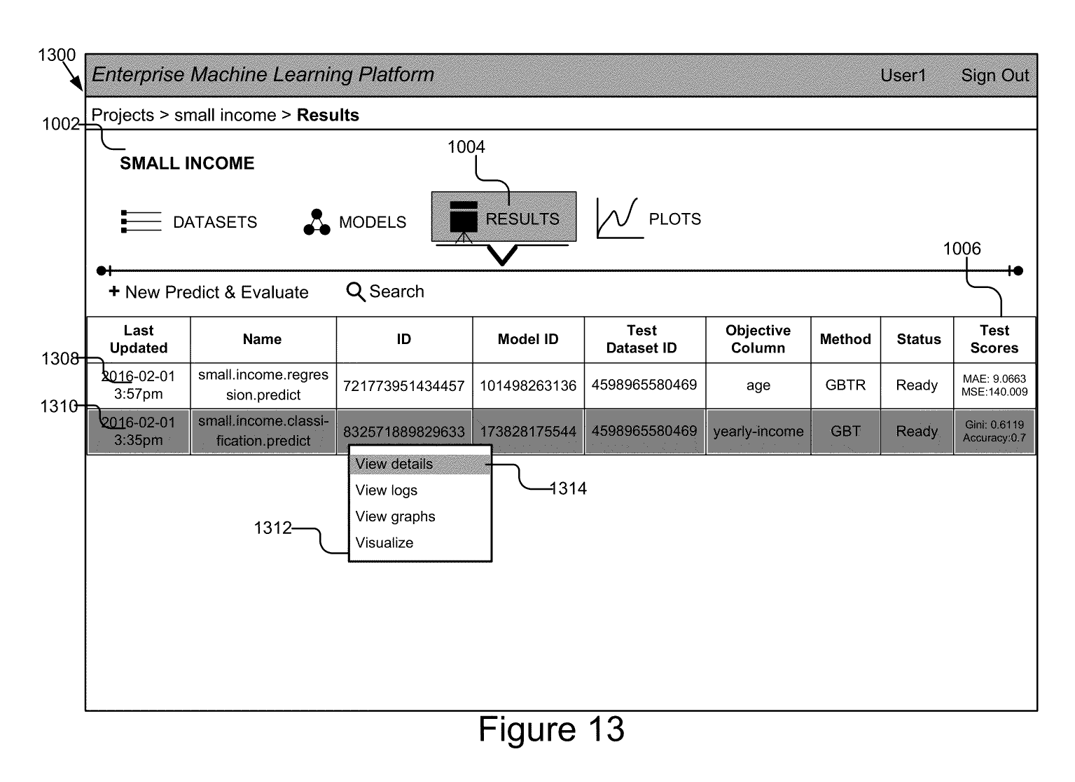

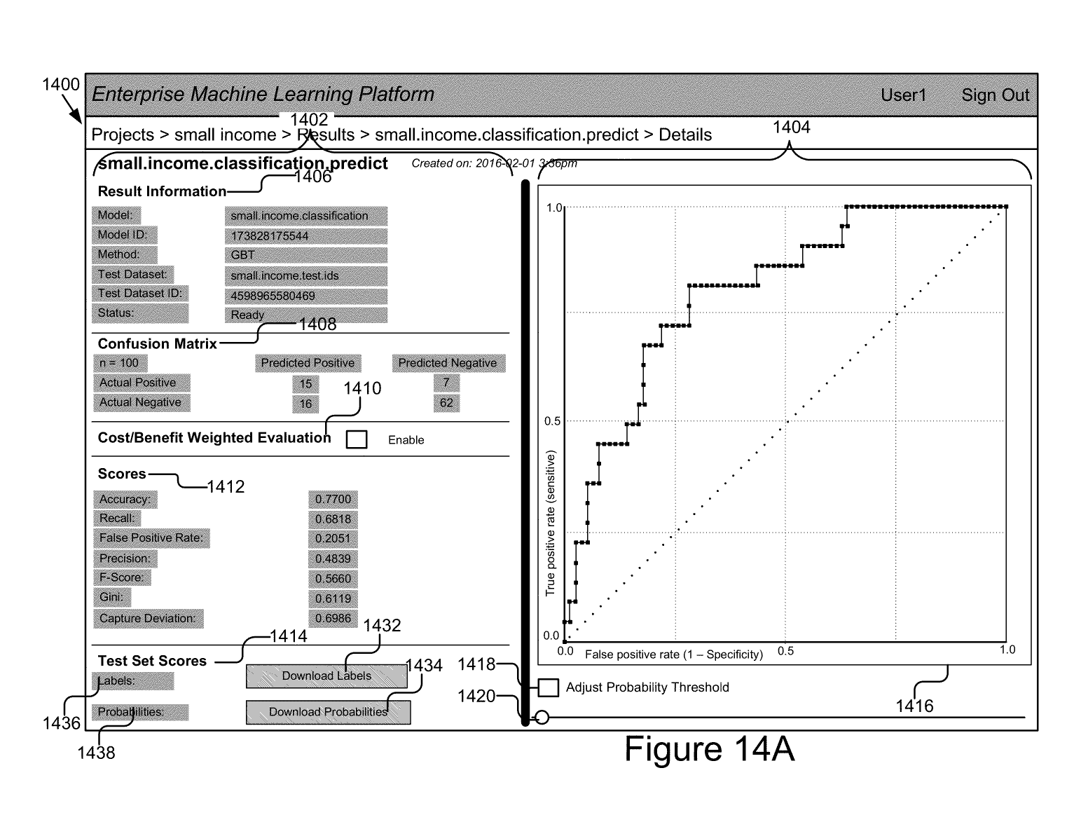

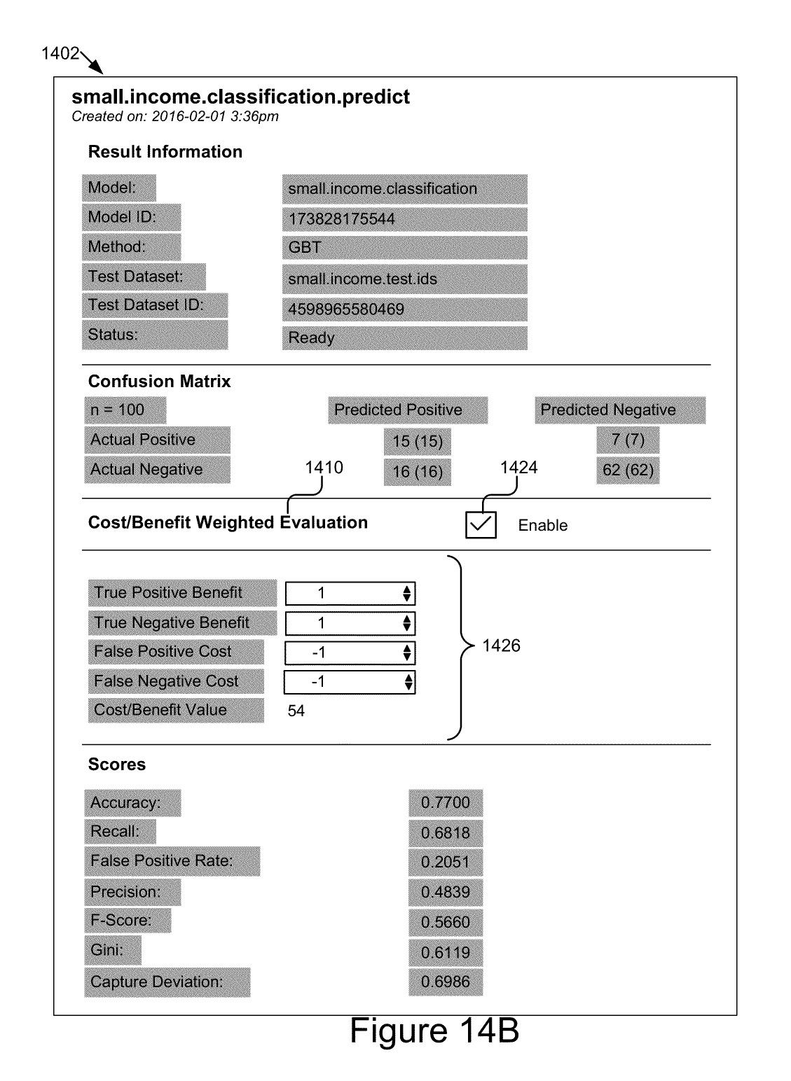

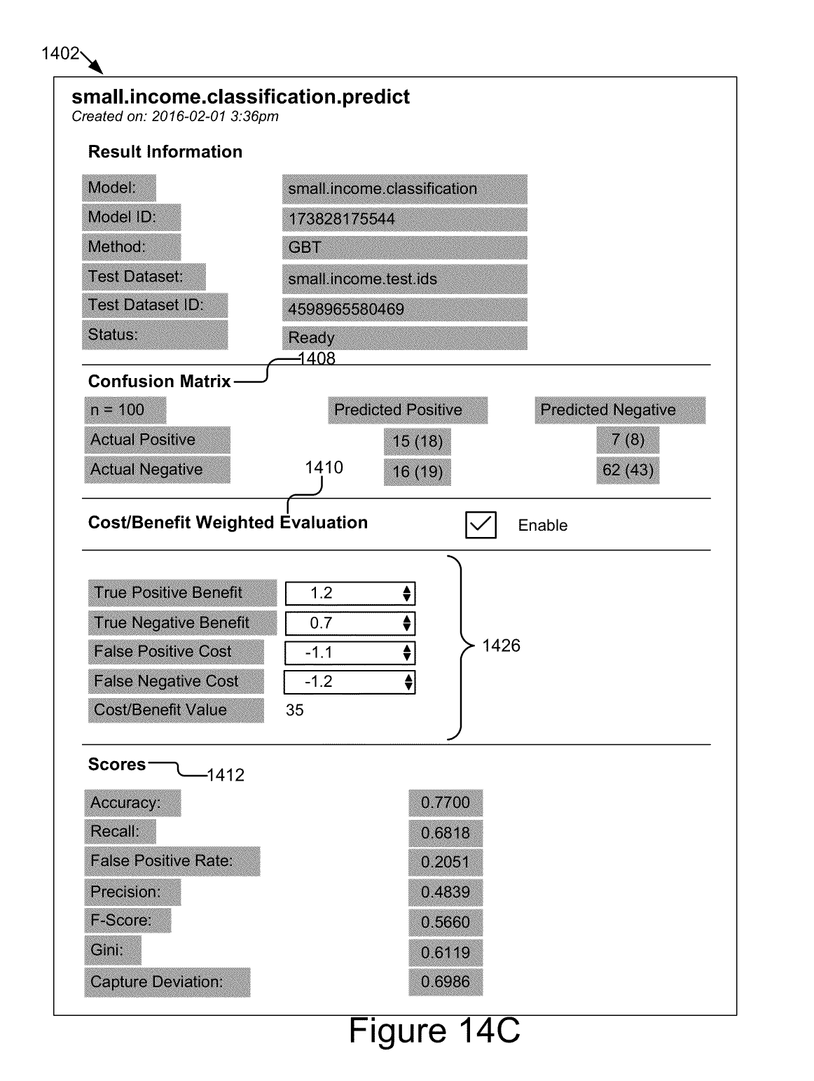

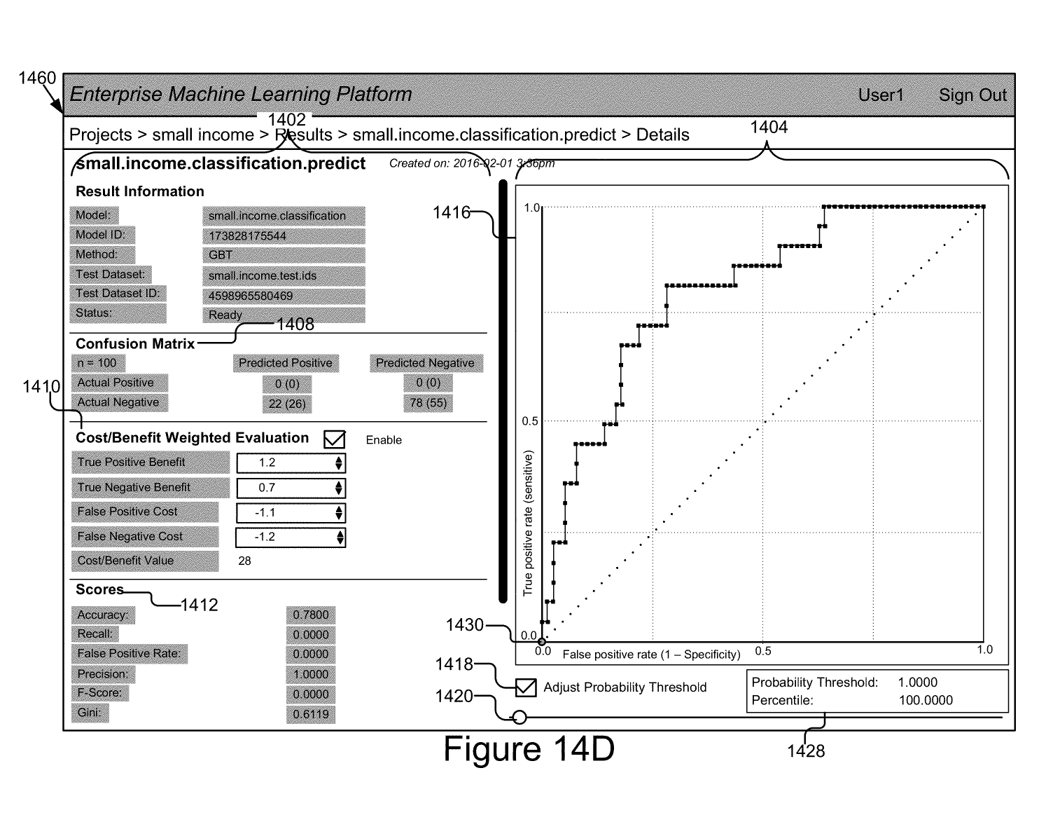

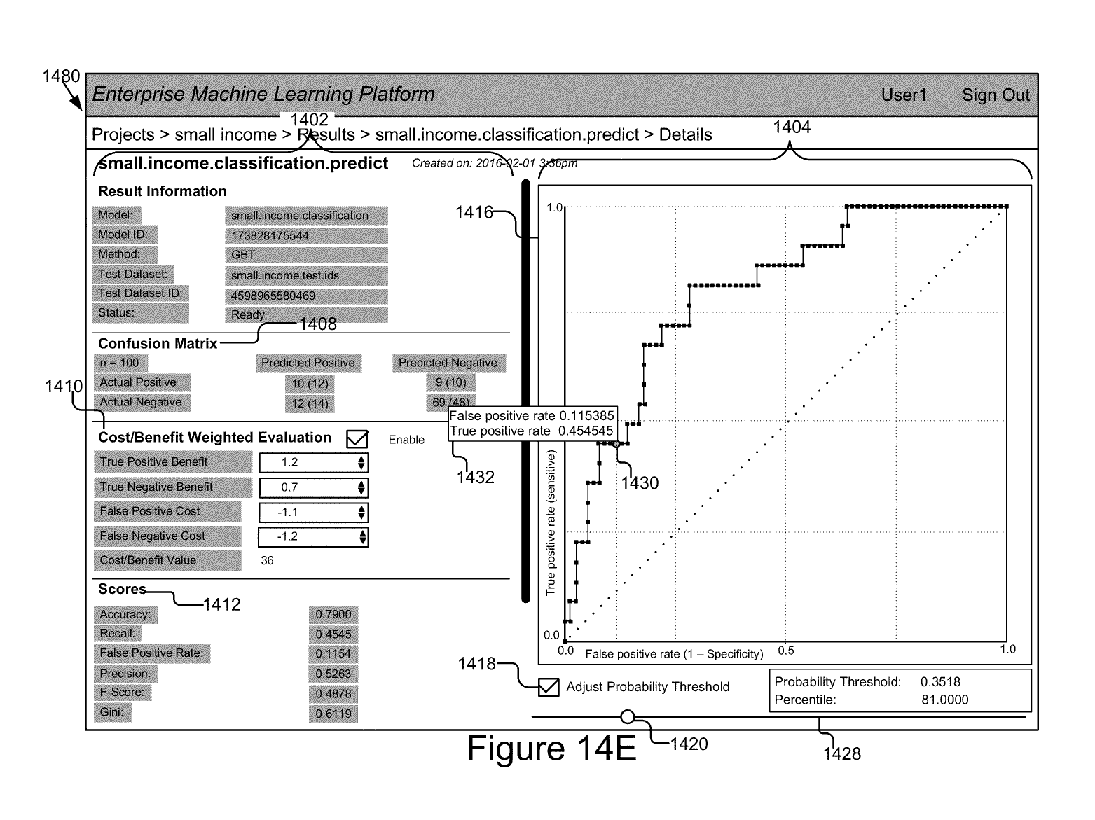

In some implementations, the user interface module 290 generates a user interface including a form to test and evaluate performance of models on a dataset. The user interface module 290 receives user input selecting models for testing on the form as shown in the example of FIG. 9. The user interface module 290 sends the request to the model management module 260 to perform the model testing on a test dataset. In some implementations, the user interface module 290 provides a scoreboard for the model test experiments. The user interface module 290 receives the test results from the model management module 260 and tabulates the test results in table of experiments as shown in the example of FIG. 13. Each row in the table (i.e. scoreboard) represents a machine learning model candidate (experiment). The user may select a parameter (e.g., scores) by which to rank the rows (machine learning model candidates) to identify the best candidate model. In some implementations, the user interface module 290 receives a user selection to view details of the best candidate model. The user interface module 290 generates a user interface that displays a confusion matrix, cost/benefit weighted evaluation parameters and a visualization to adjust probability threshold and identify changes in the confusion matrix and scores as shown in the example of FIGS. 14A-14E.

In some implementations, the user interface module 290 cooperates with the reporting module 280 to generate a user interface displaying dependencies of items and the interaction of the items (e.g., experiments, features, models, data sets, and projects) in a directed acyclic graph (DAG) view. The user interface module 290 receives information representing the DAG visualization from the reporting module 280 and generates a user interface as shown in the example of FIGS. 16A-16B and FIGS. 18A-18B. For each node in the DAG, the reporting module 280 and the user interface module 290 cooperate to allow the user to select the node and retrieve associated information in the form one or more textual elements or one or more visual elements that indicate to the user dependencies of the selected node. This provides the user with the ultimate level of flexibility in the project workspace. The user can see the node dependencies in the DAG and may choose to delete a few. The user interface module 290 can identify the deletions and dynamically update the tables corresponding to the item that was deleted.

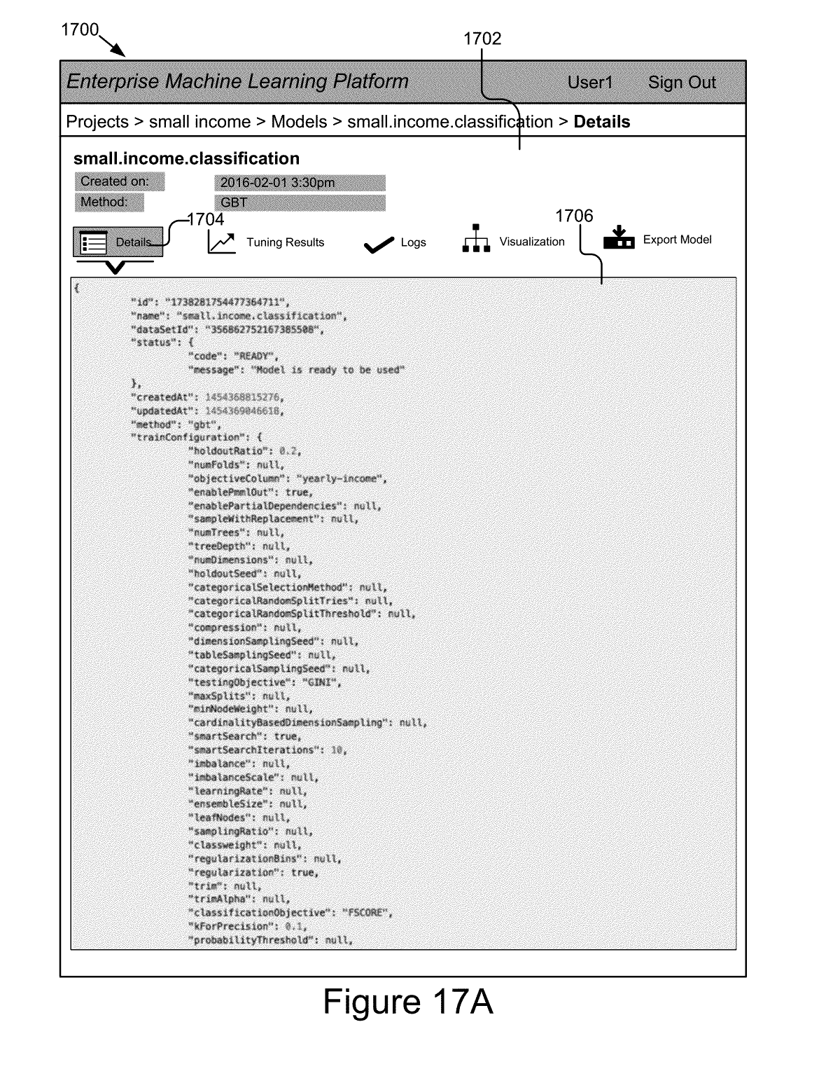

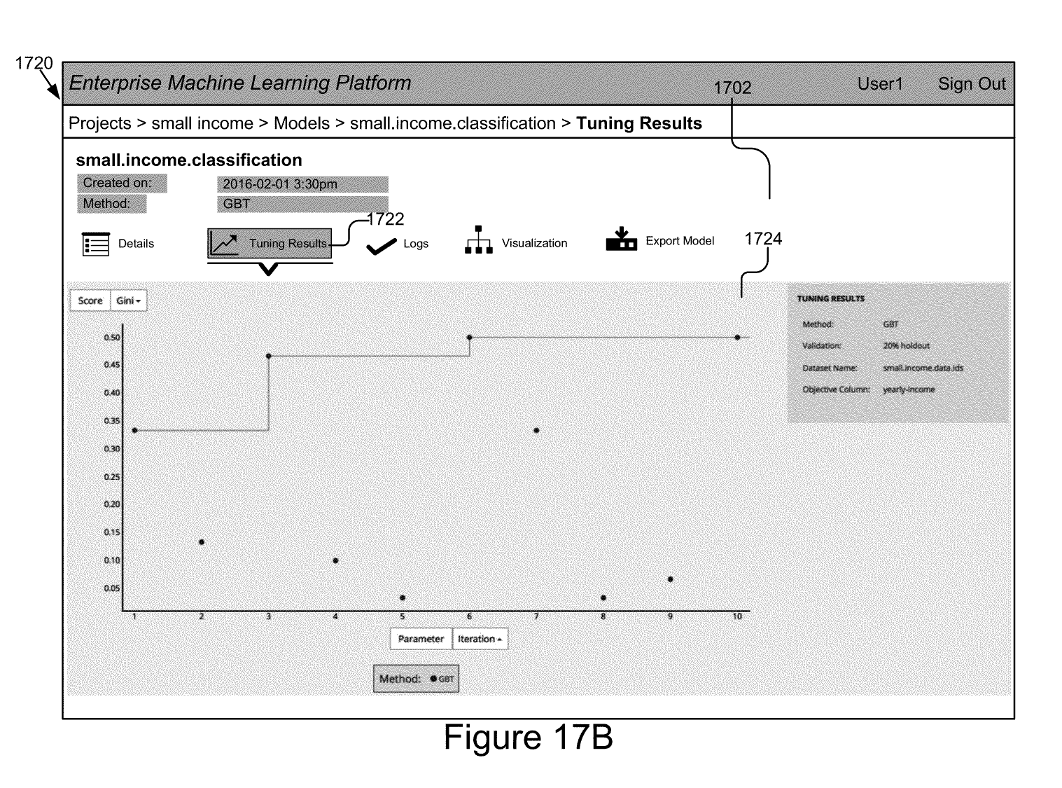

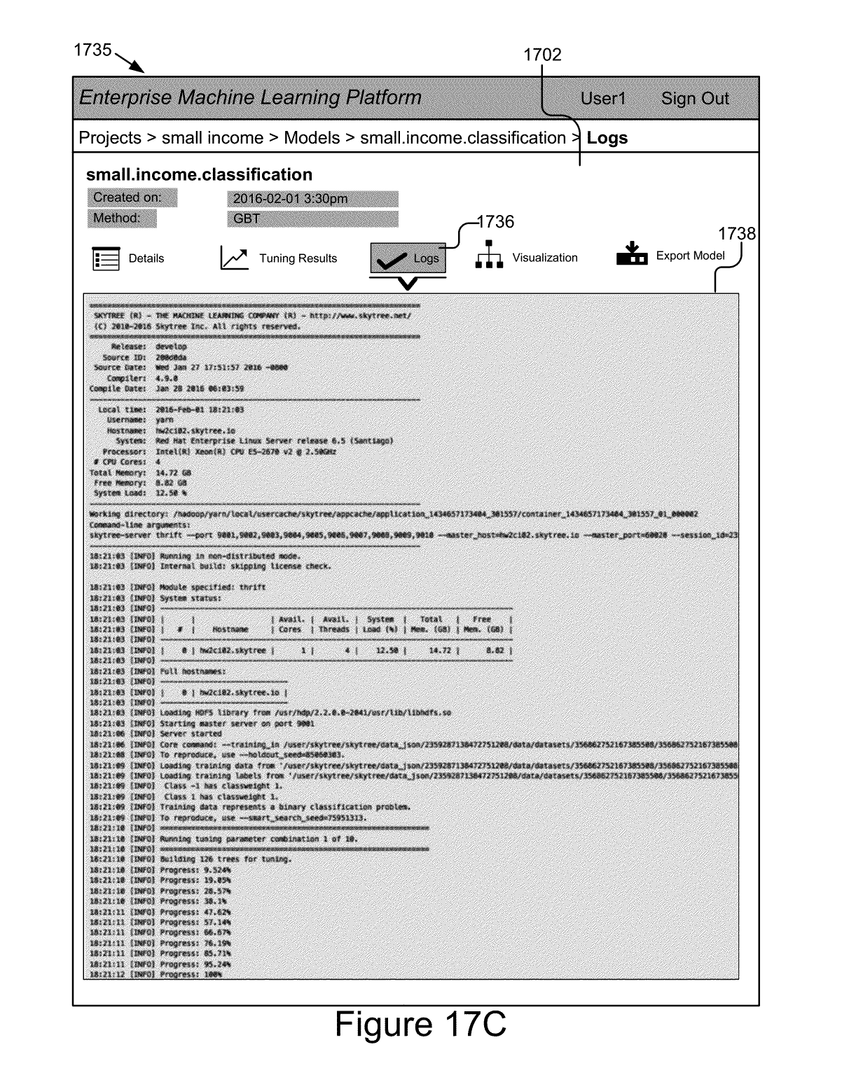

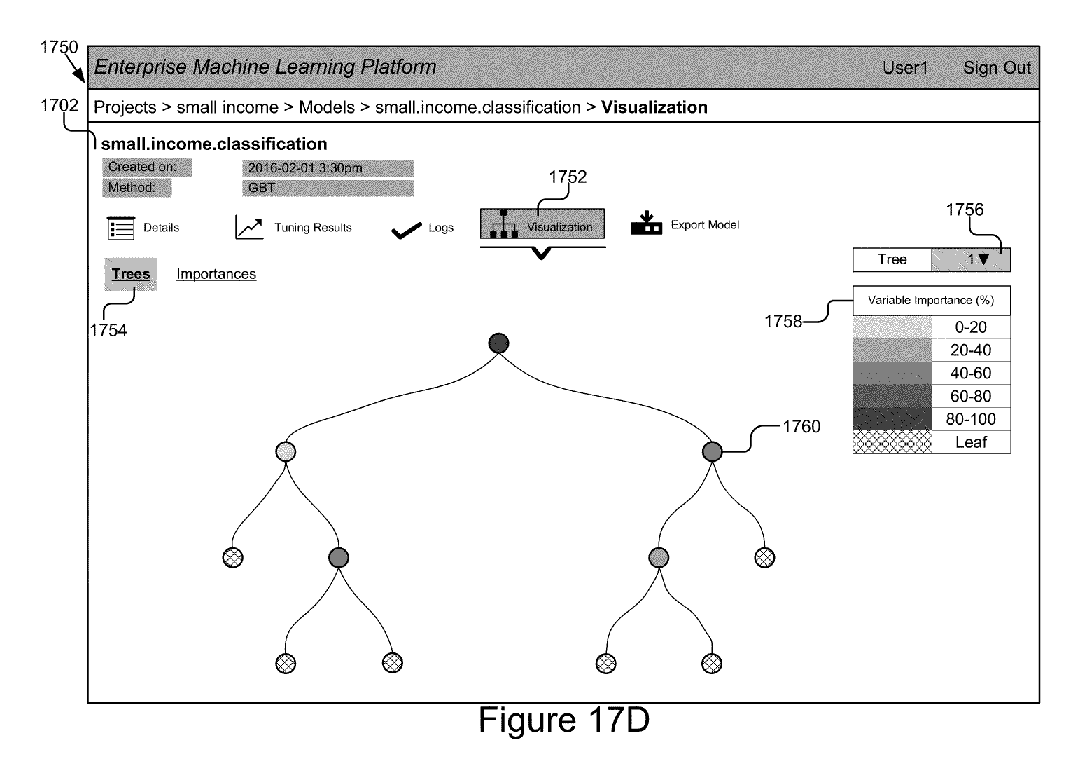

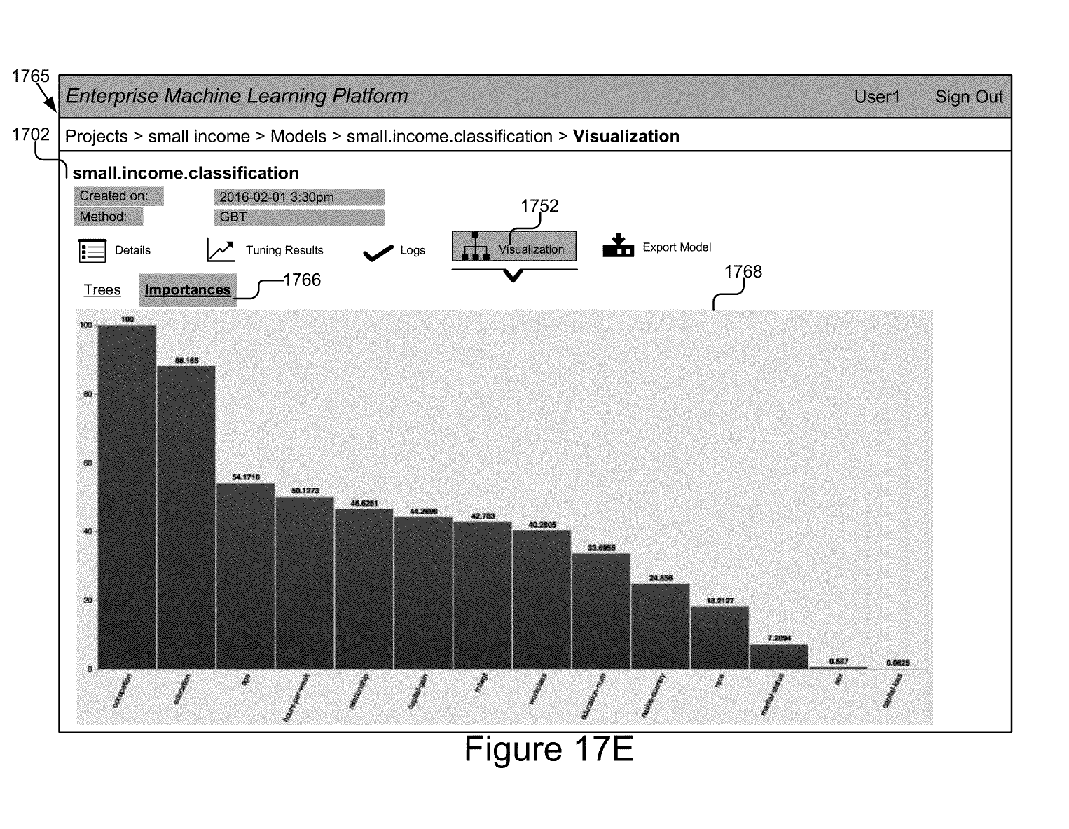

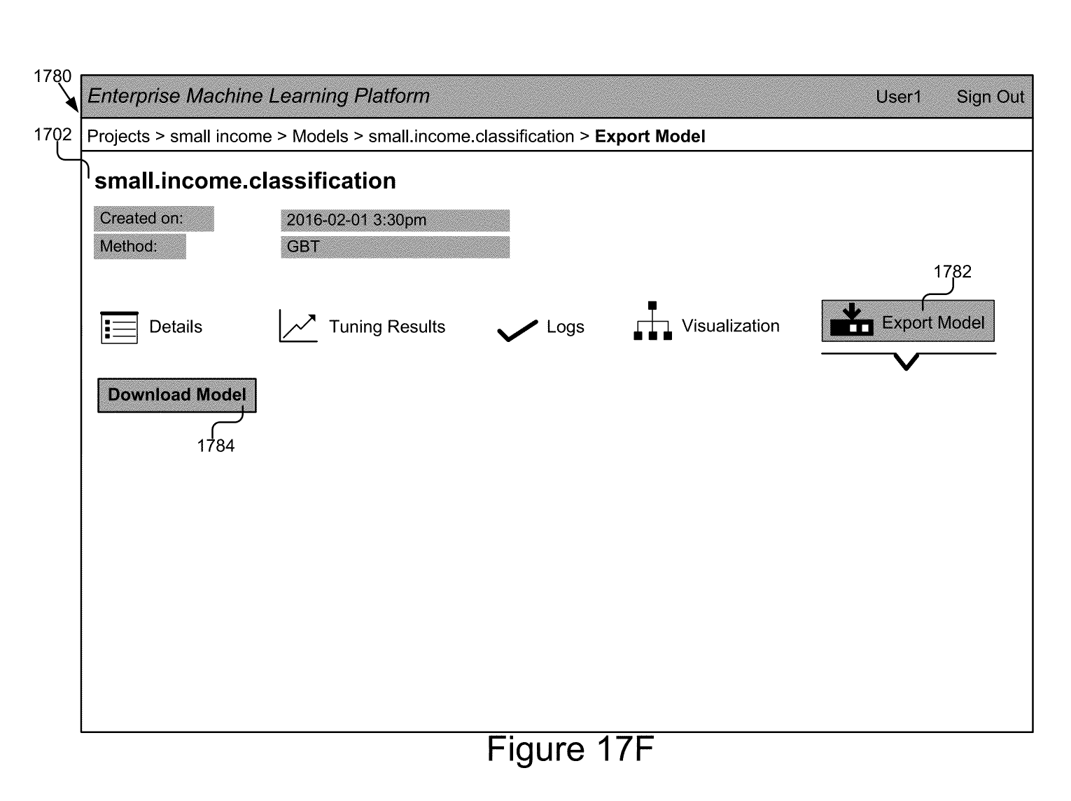

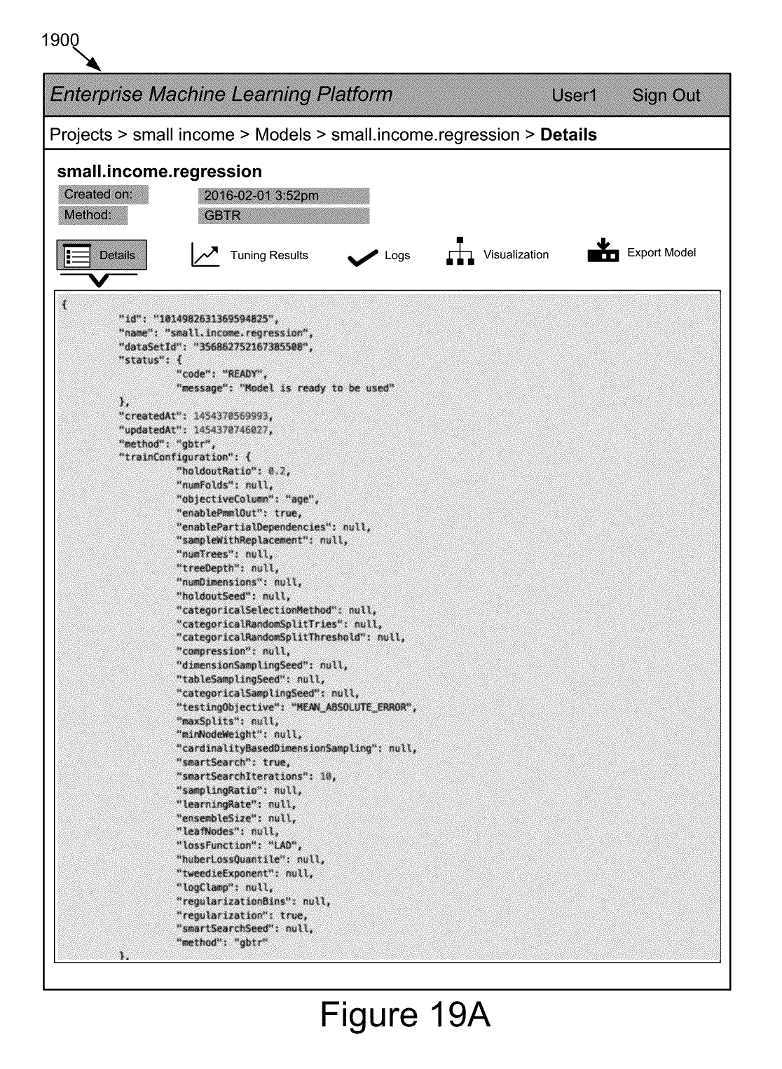

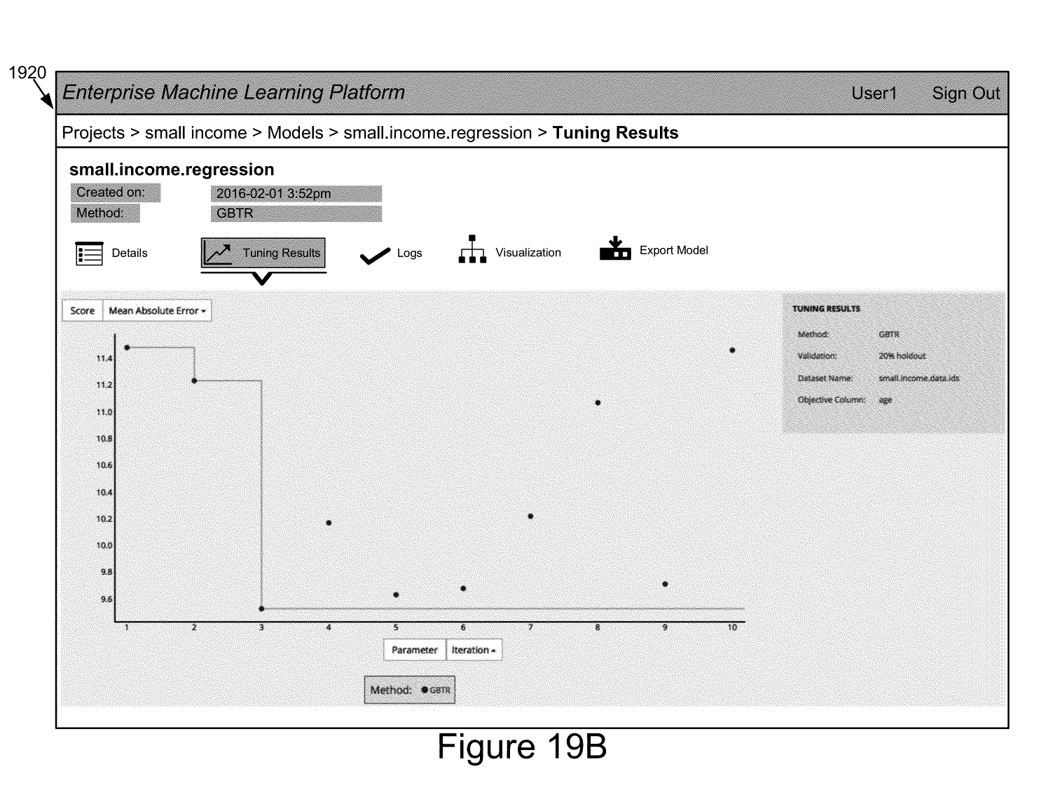

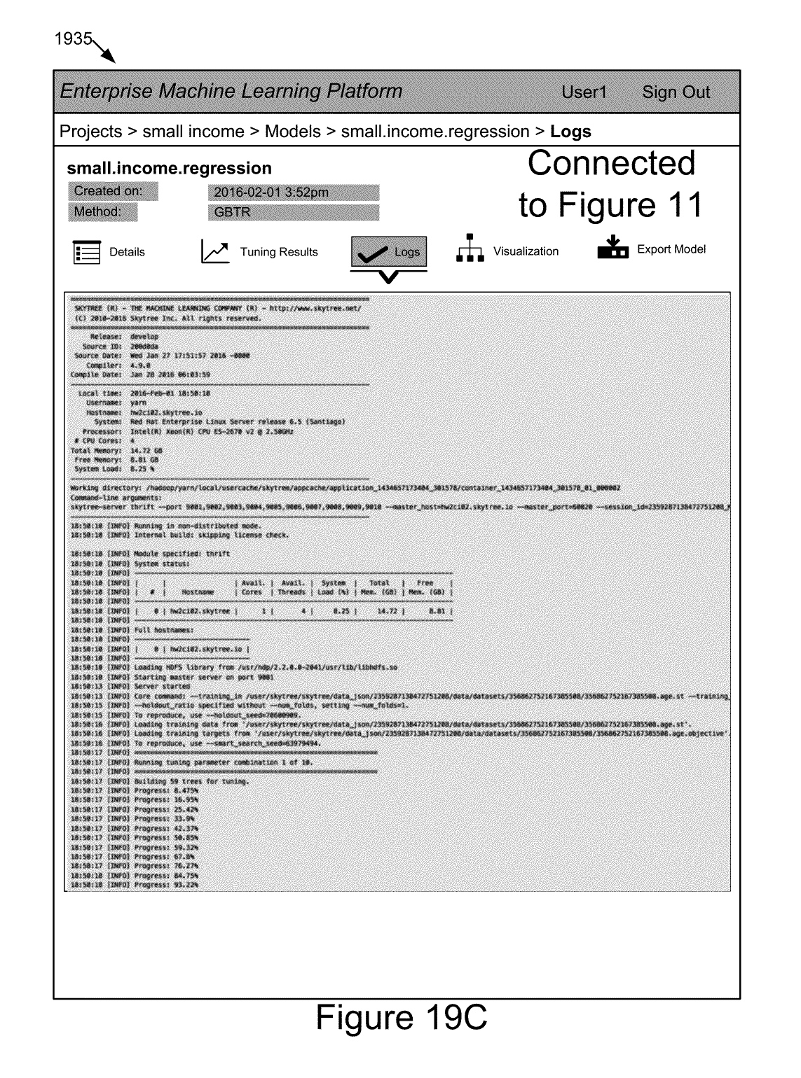

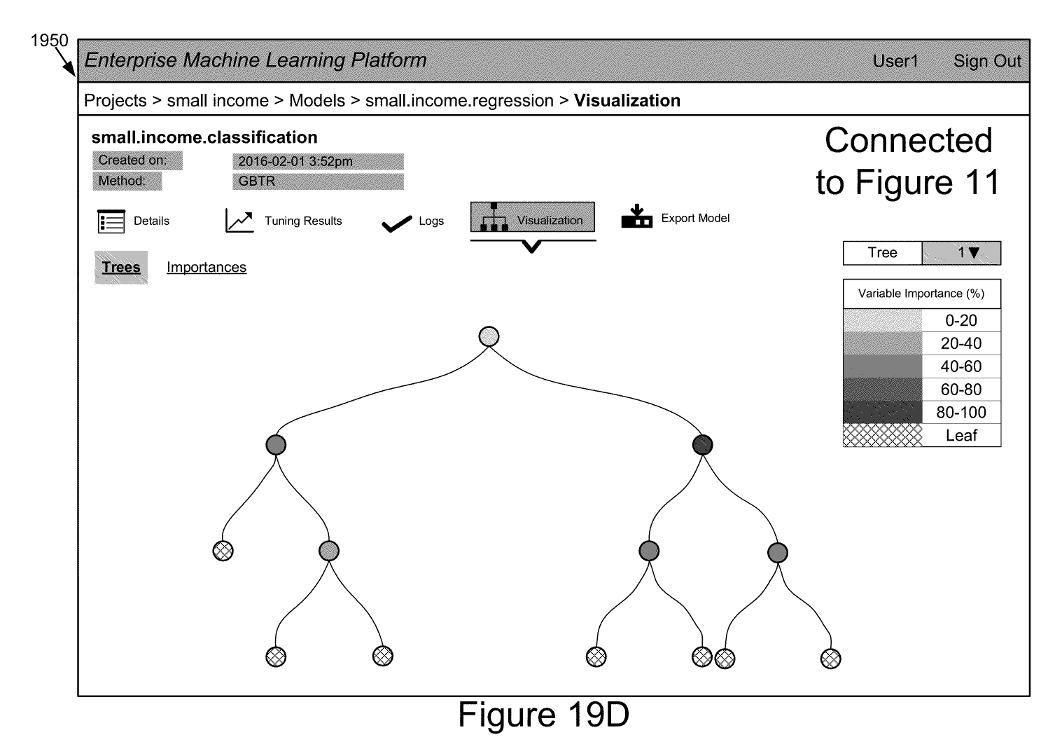

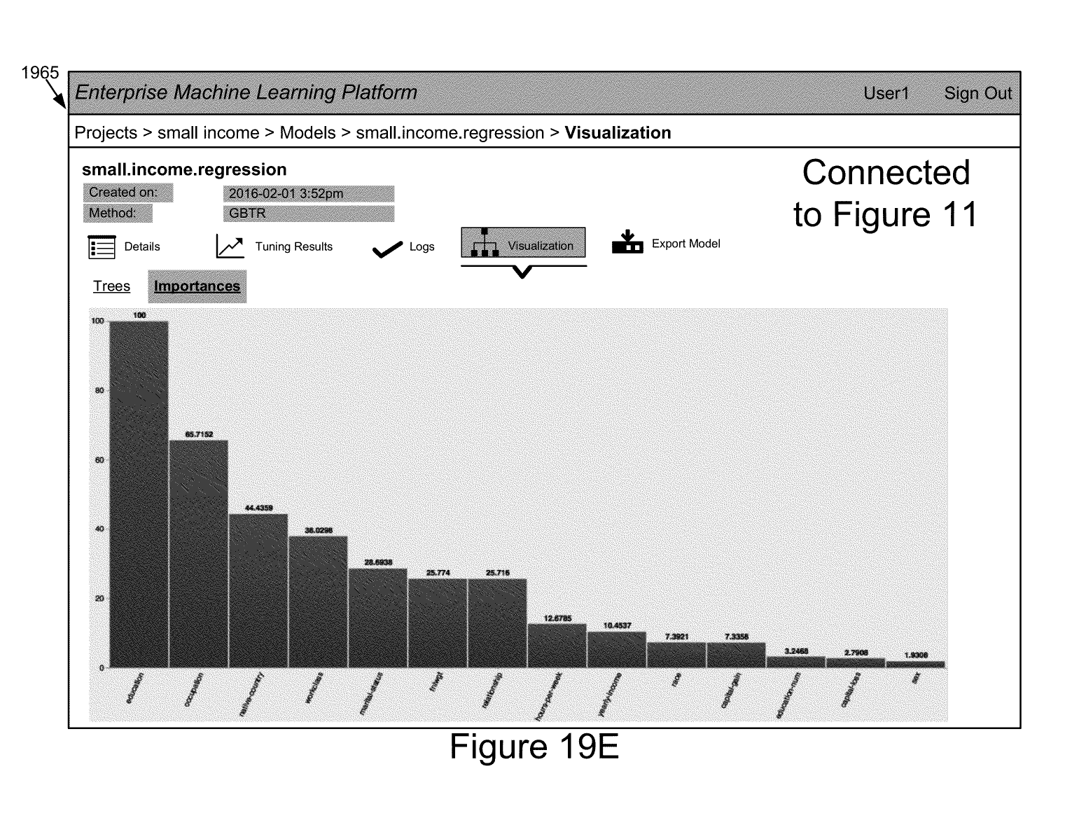

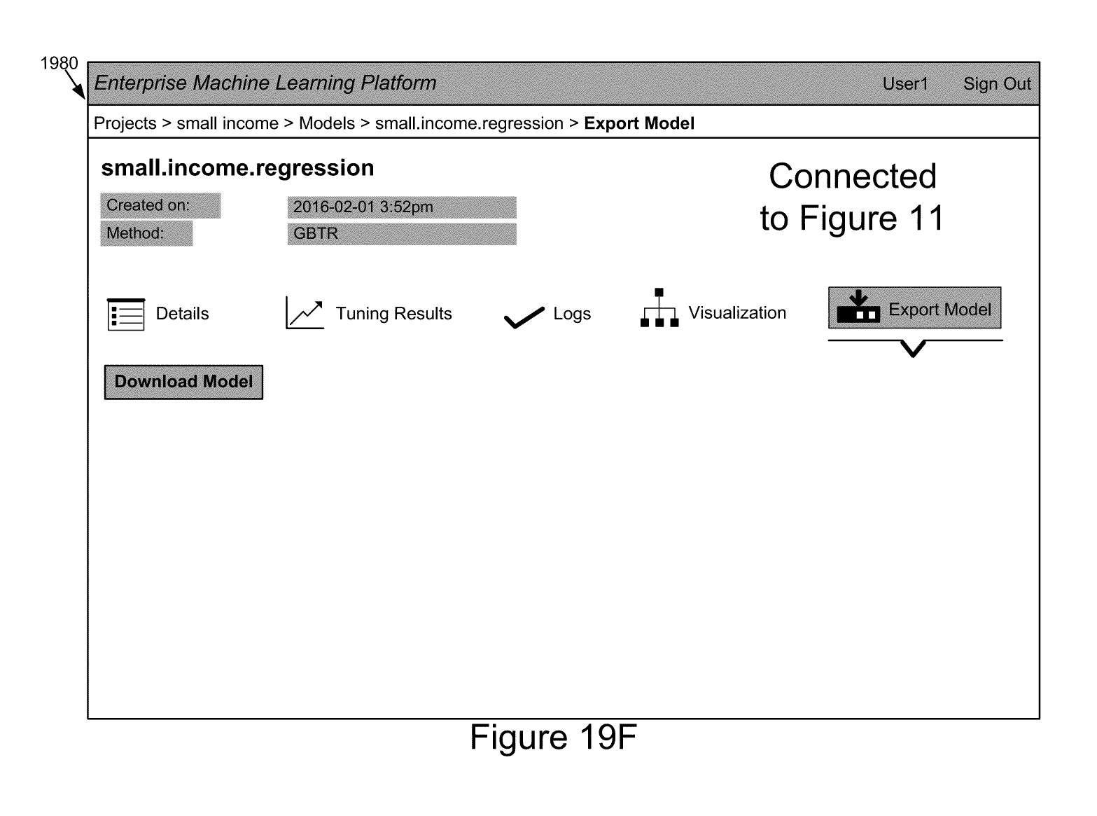

In some implementations, the user interface module 290 cooperates with the auditing module 270 to generate a user interface that provides the user with the ability to point/click on models listed in the tables and see the log of the entire model building job, when/how the models were changed and who made the changes. The user interface module 290 receives information including the audit trail from the auditing module 270 and generates a user interface as shown in the example of FIG. 17C which displays the log in its entirety. In some implementations, the user interface module 290 cooperates with the model management module 260 to generate a user interface that provides the user with the ability to export the model to the production server 108 or client device 114. The user interface module 290 receives the Predictive Model Markup Language (PMML) file format of the models from the model management module 260 and generates a user interface as shown in the example of FIG. 19F. The user can select the “Download Model” to begin exporting the model to the production server 108 or client device 114.

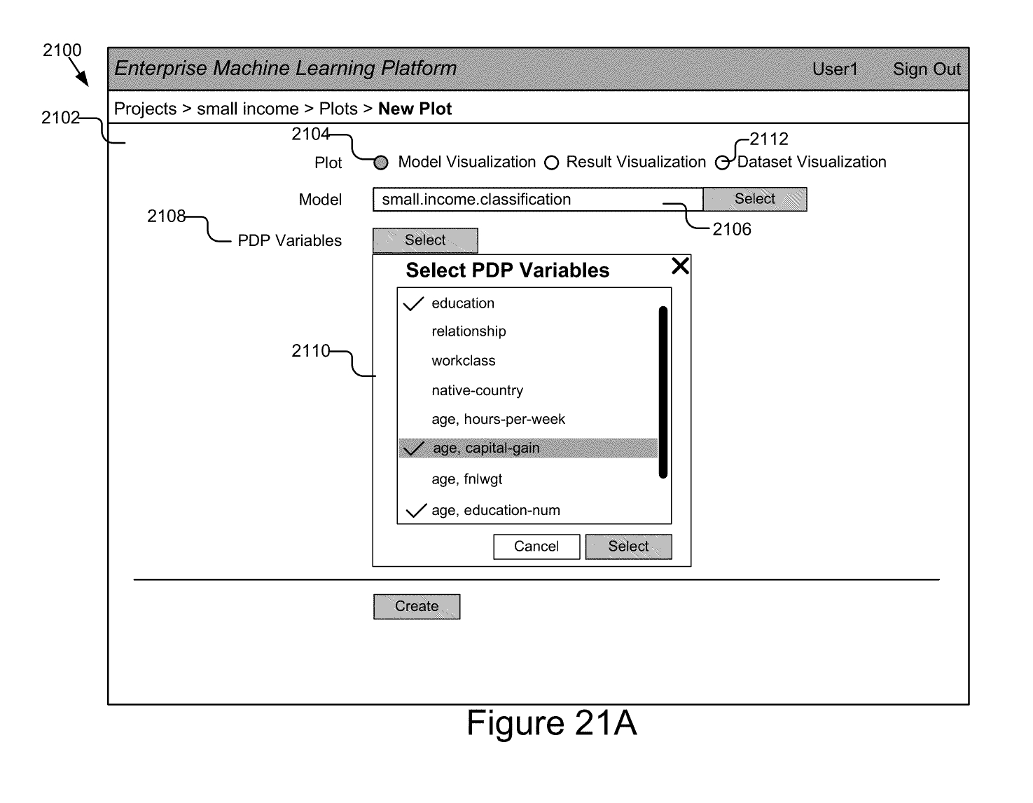

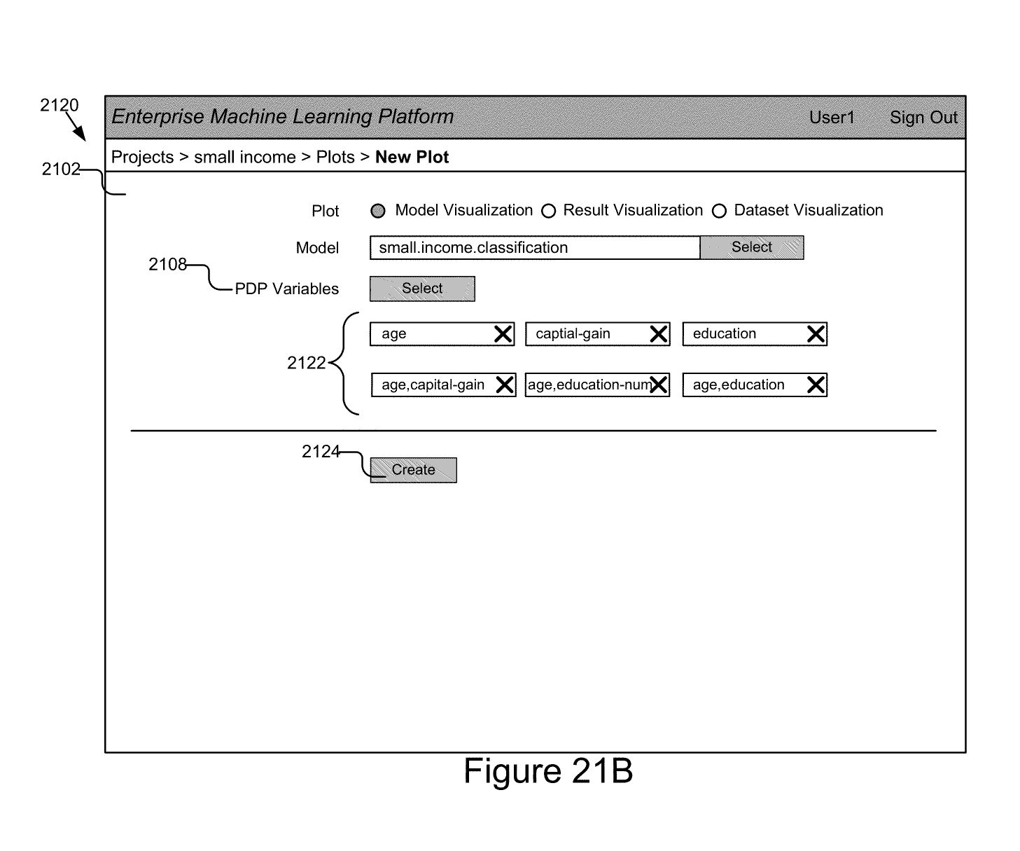

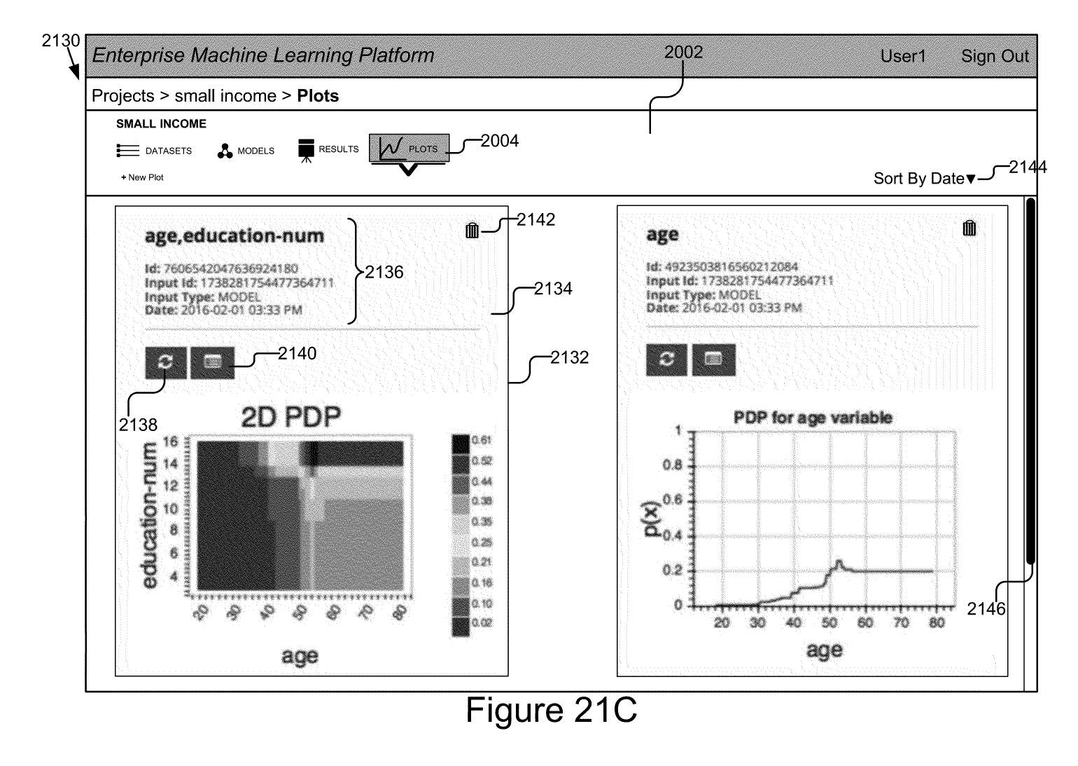

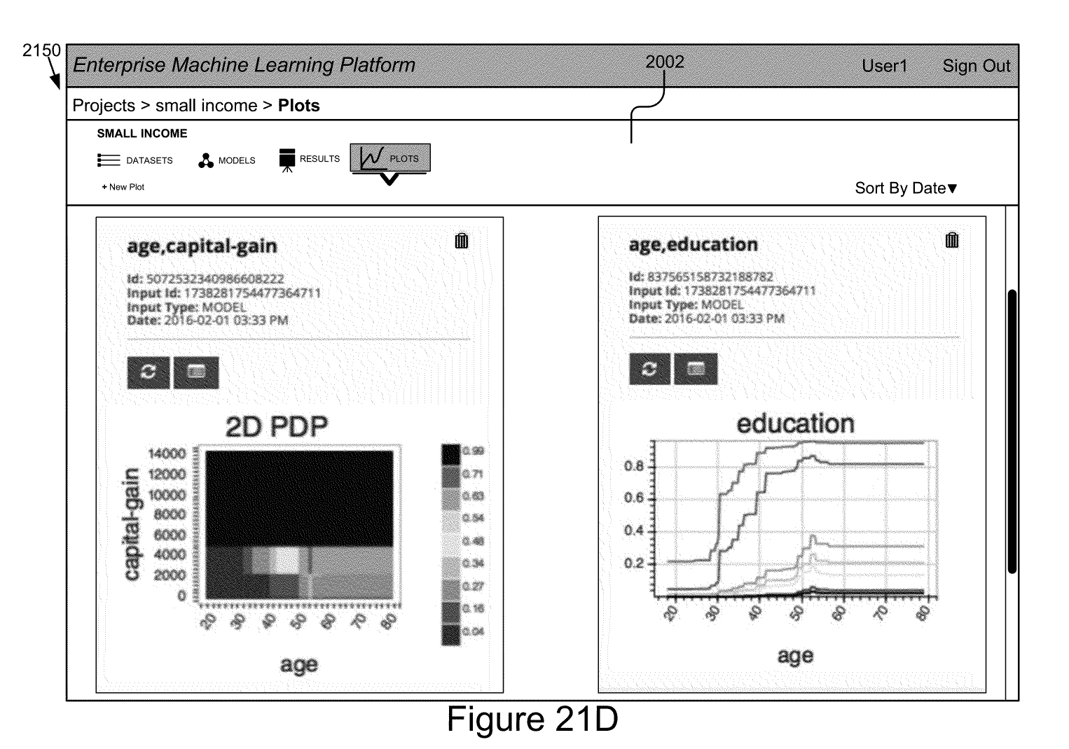

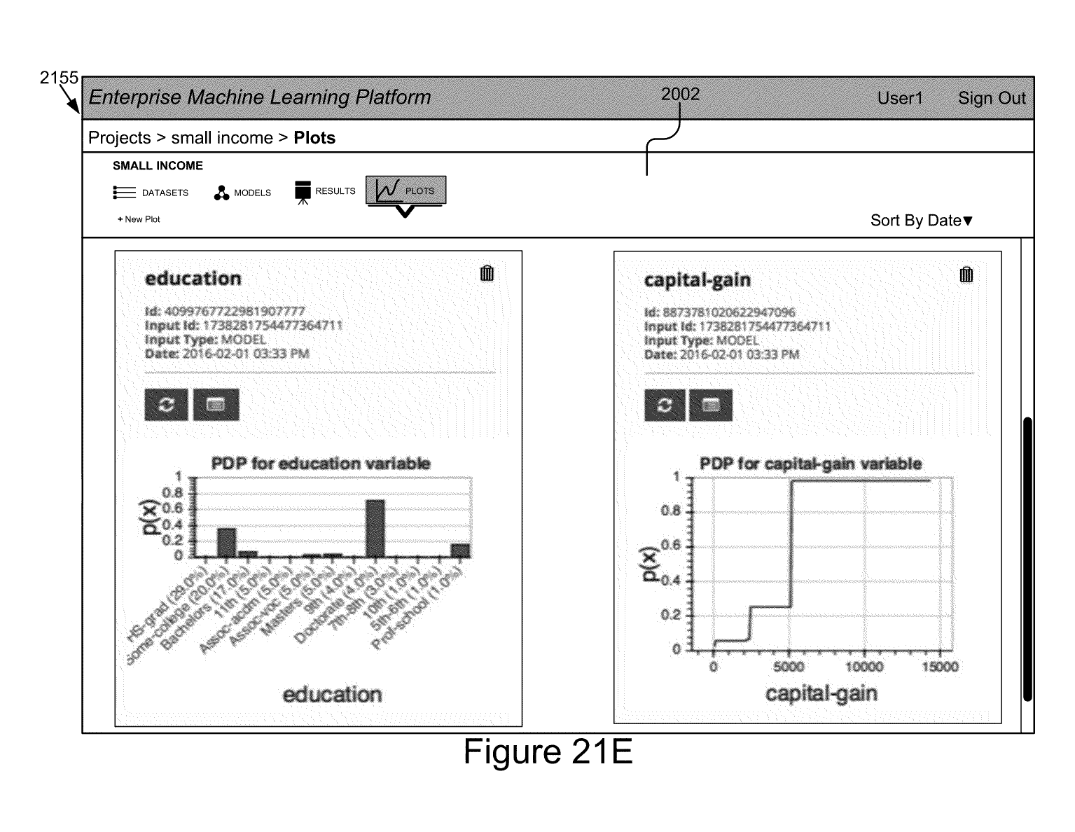

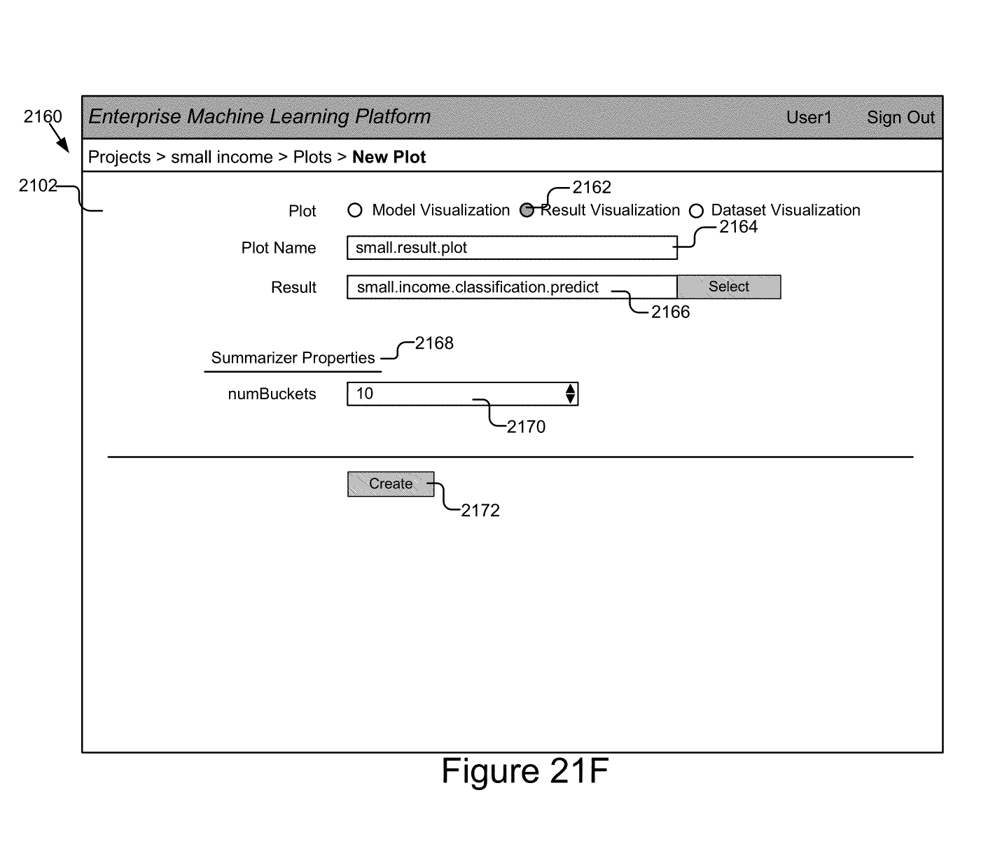

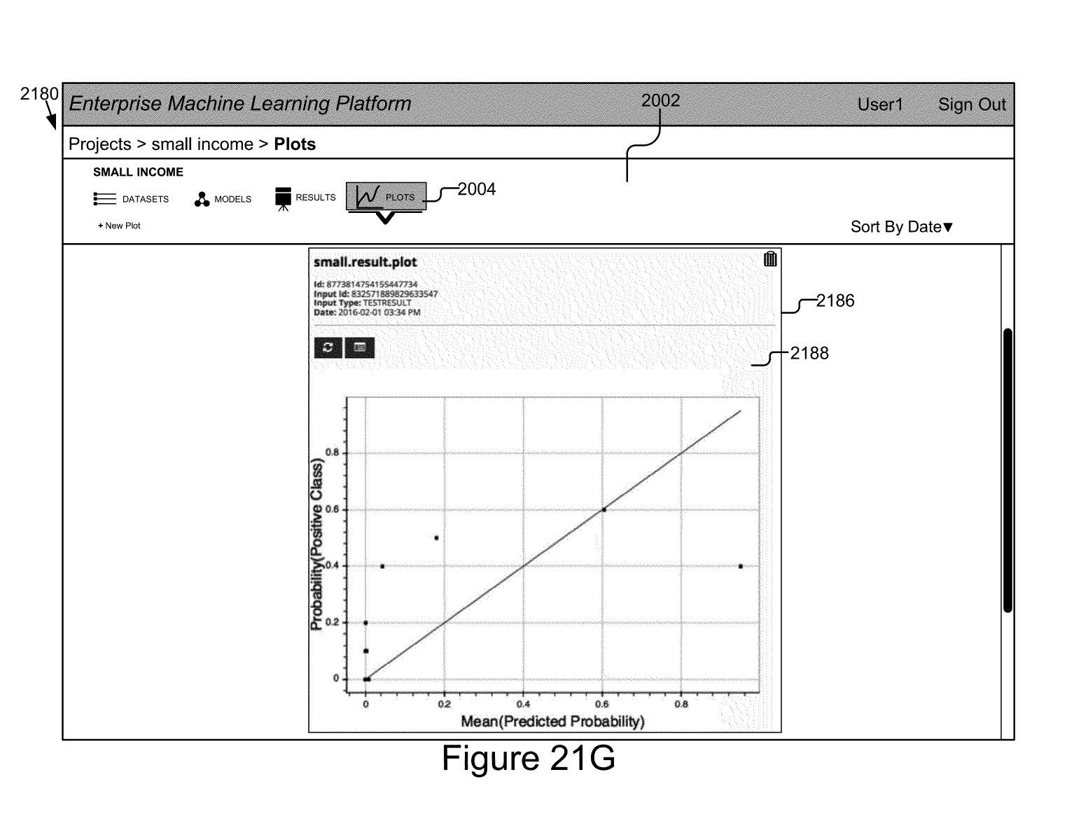

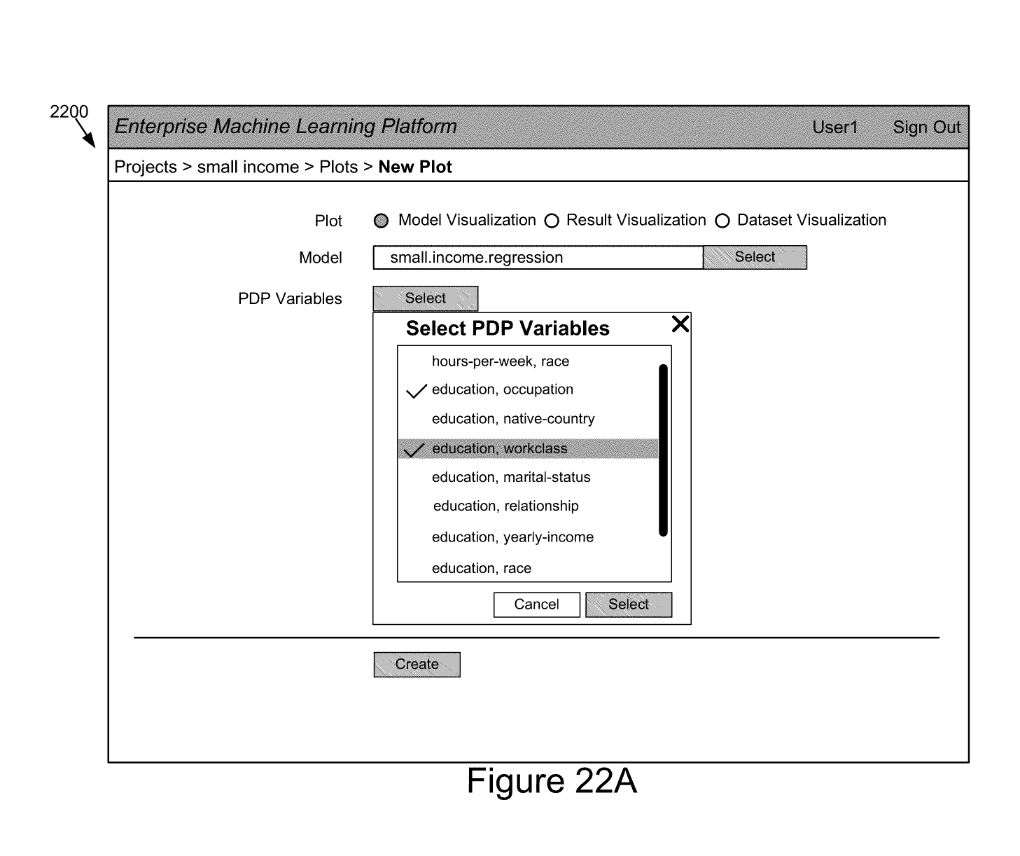

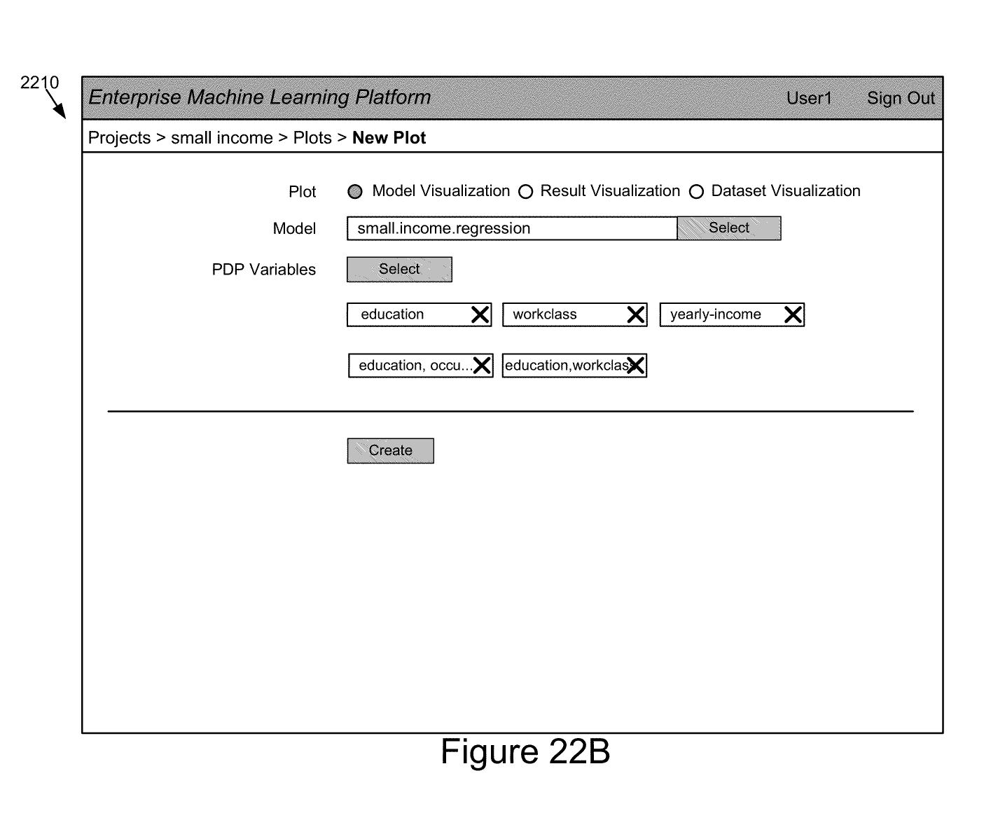

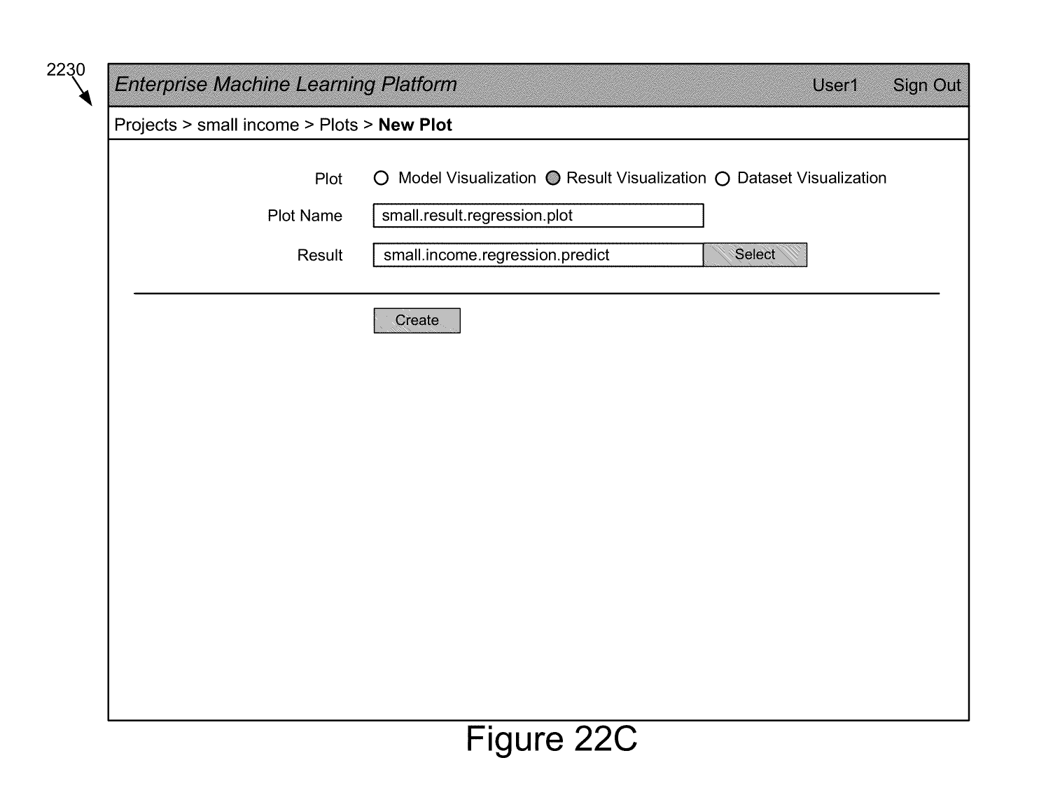

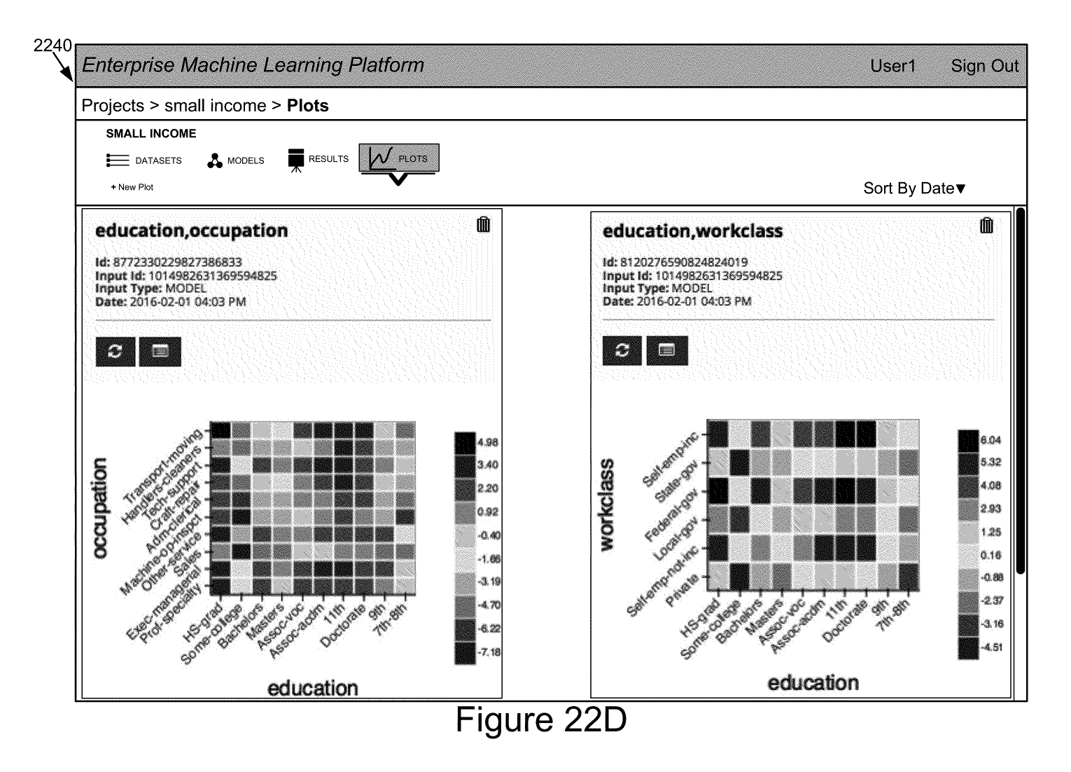

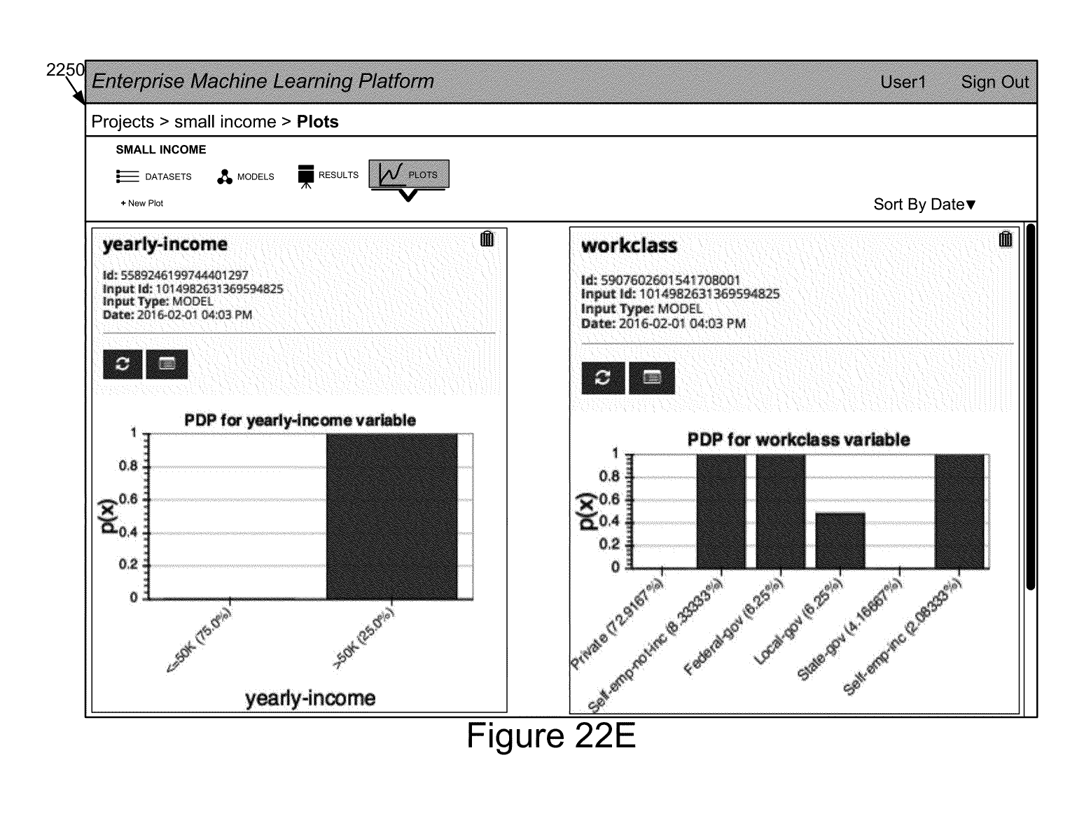

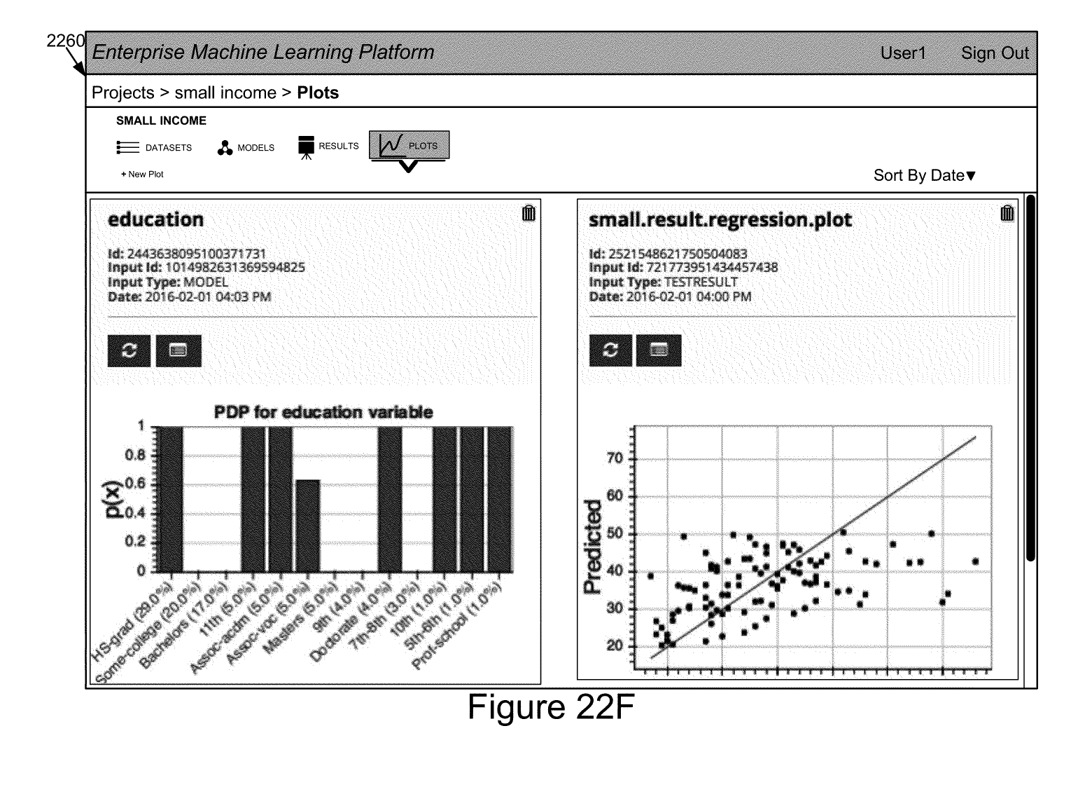

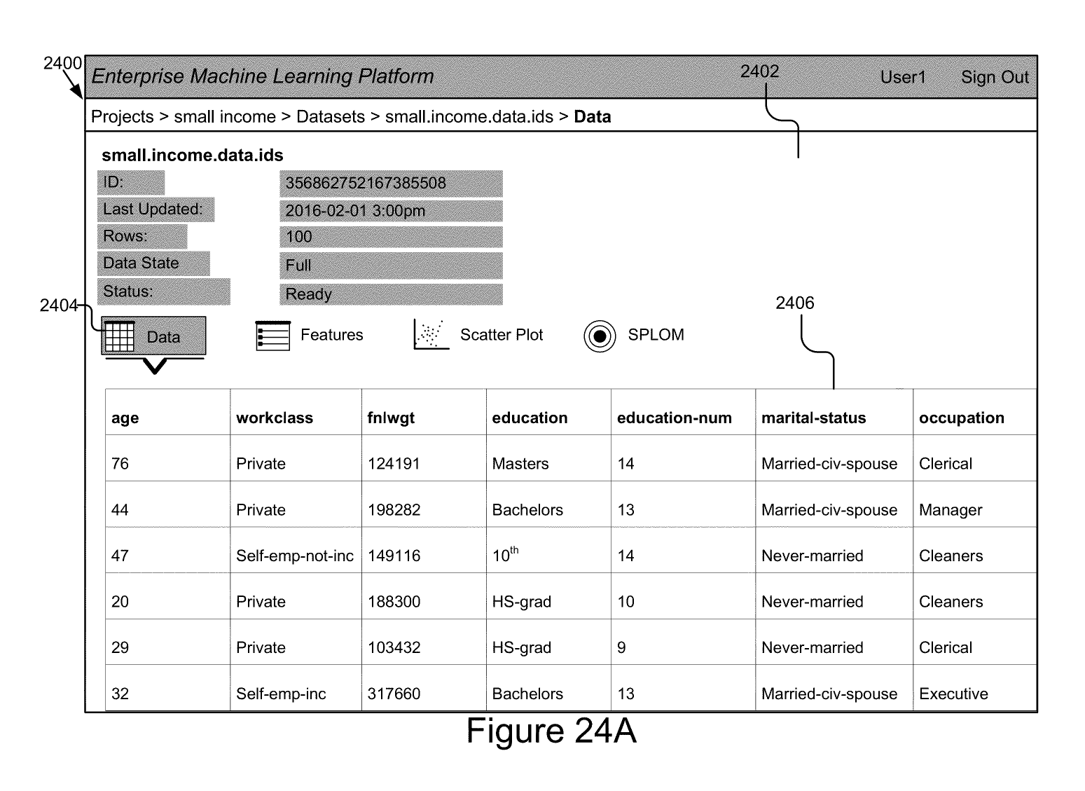

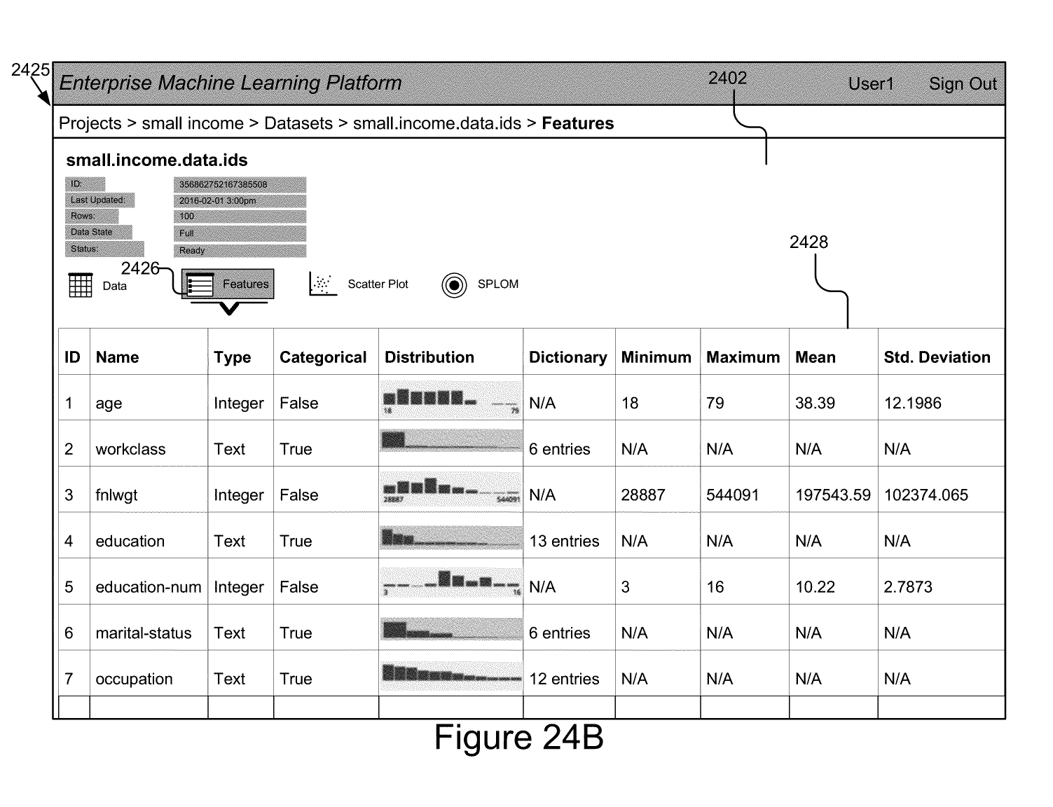

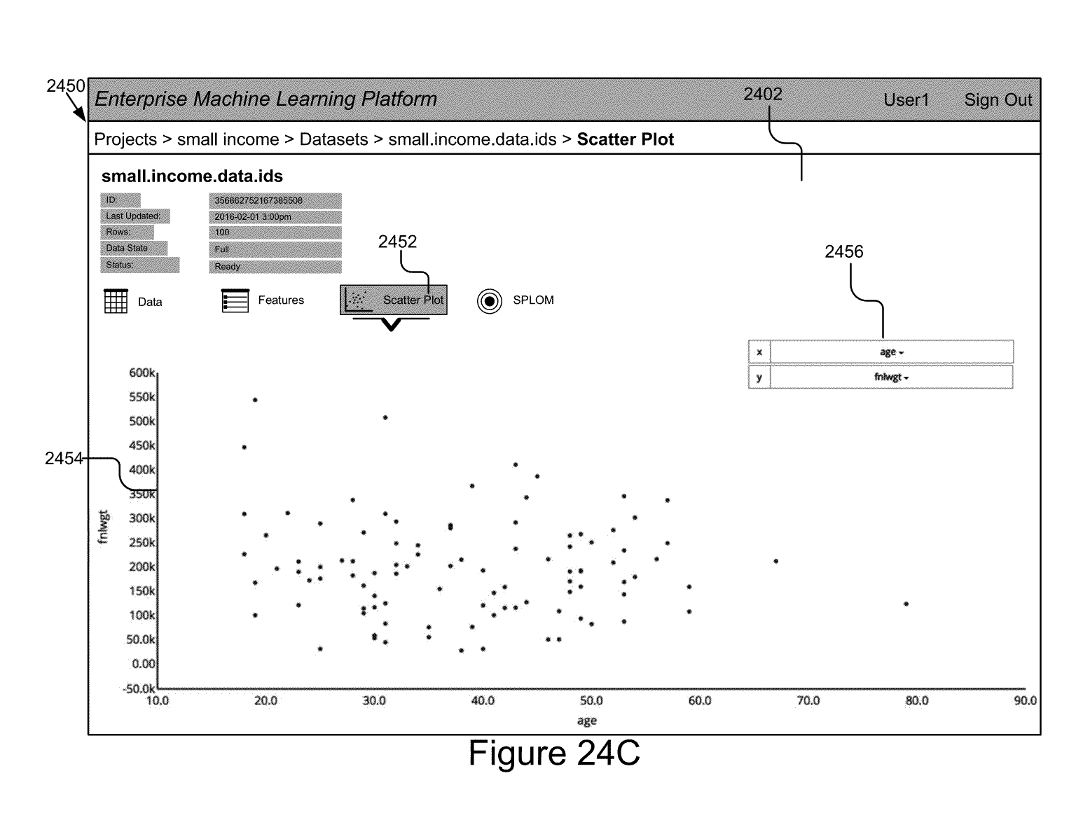

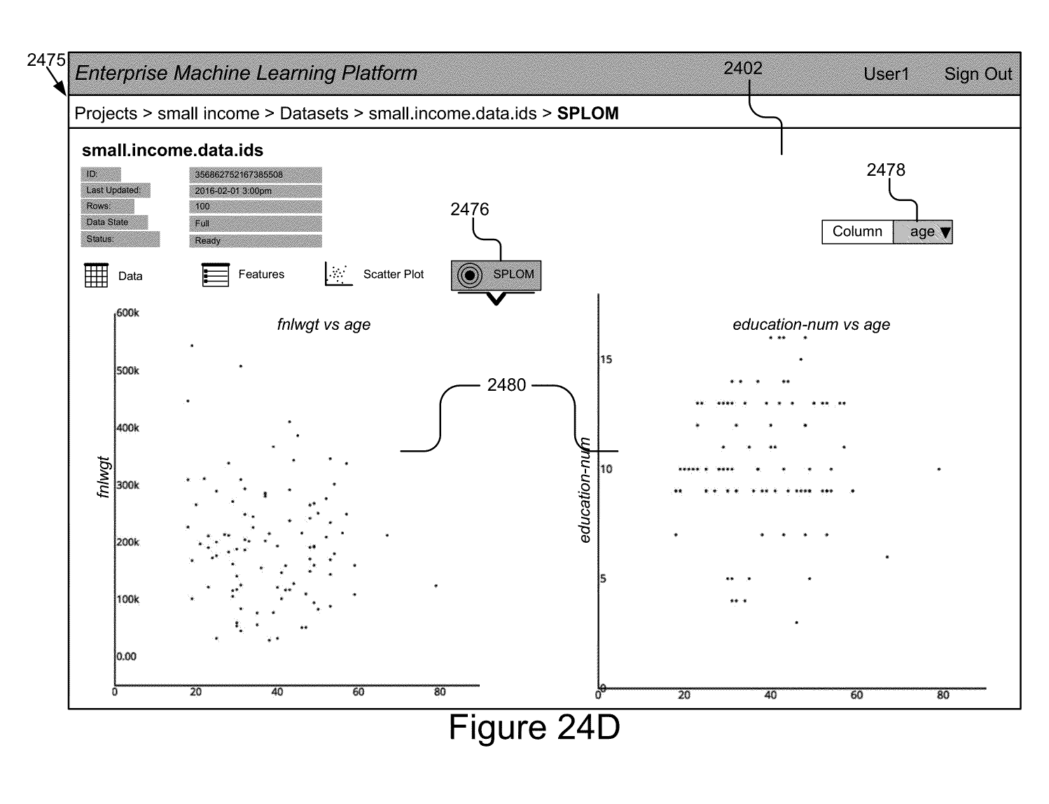

In some implementations, the user interface module 290 cooperates with the data preparation module 250, the model management module 260, and the reporting module 280 to generate a user interface that provides the user with a visualization of the item (e.g., datasets, results, models, etc.) of choice. In some implementations, the user interface module 290 receives model information including the partial dependence plot variables from the model management module 260 and the plot information to render the partial dependence plot variables from the reporting module 280 for generating user interfaces including the visualization of the model as shown in the example of FIGS. 21A-21E. In some implementations, the user interface module 290 receives the results generated by a model from the model management module 260 and the plot information to render the results from the reporting module 280 for generating user interfaces including the visualization of the result as shown in the examples of FIGS. 21F-21G and FIGS. 22A-22F. In some implementations, the user interface module 290 receives the processed information of the datasets from the data preparation module 250 and generates user interfaces for displaying data visualization, data feature visualization, a scatter plot visualization and pair wise comparison of variables in the scatter plot of matrices (SPLOM) visualization as shown in the example of FIGS. 24A-24D.

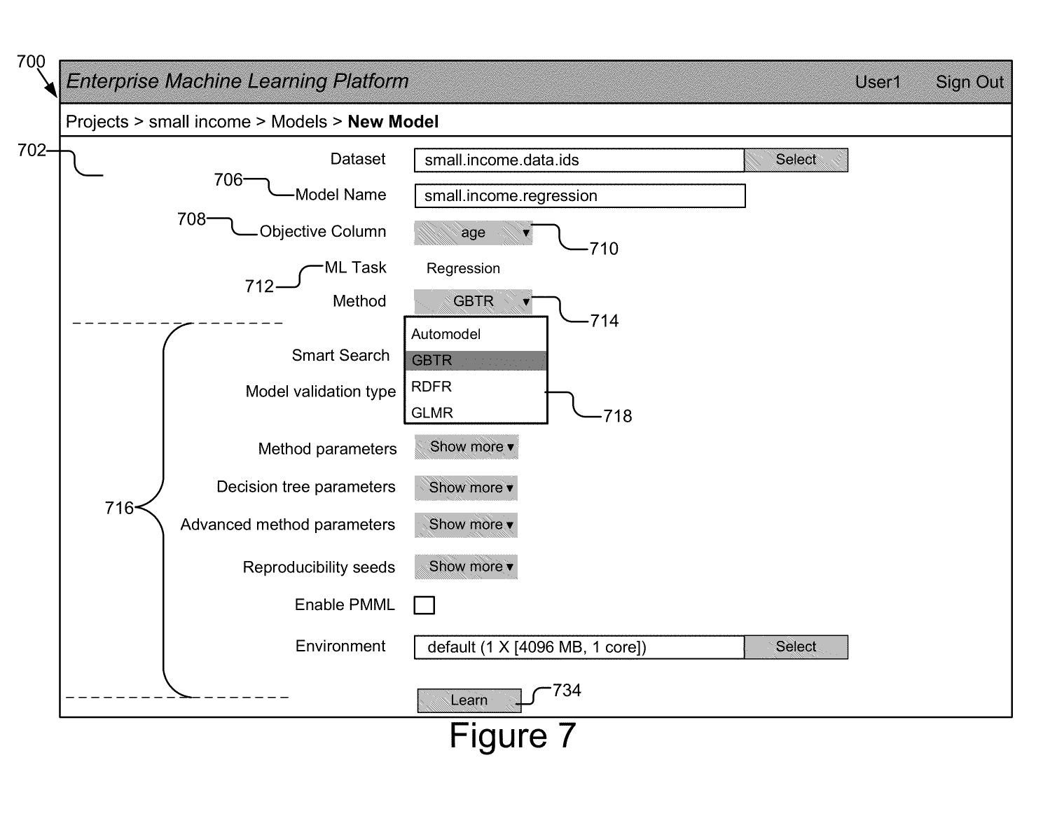

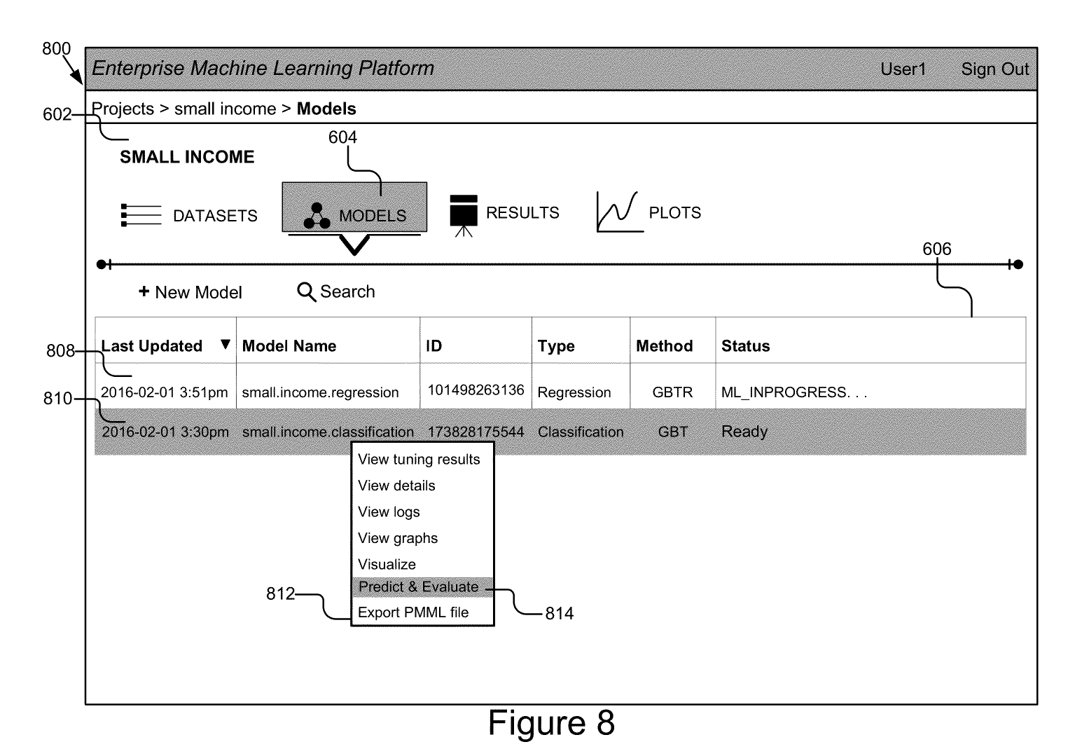

In some implementations, the user interface module 290 is adaptive and learns. For example, the placement of control graphical elements can be modified based on user's interaction with them. The user interface module 290 learns the control graphical elements used and the pattern of use of different control graphical elements. Based upon the user's interaction with the user interface, the user interface module 290 modifies the position, prominence or other display attributes of the control graphical elements and adapts it to the specific user. For example, one or more of the graphical elements in menus such as 410 in FIG. 4, 518 in FIG. 5A, 718 in FIG. 7, 812 in FIG. 8, and 1312 in FIG. 13 may be modified in position, prominence or other display attribute based on user interaction. In some implementations, the user interface module 290 adapts and modifies the user interface and its control graphical elements specifically to the user based on the user's interaction, and to make that user more efficient and accurate.

In some implementations, the user interface module 290 uses the behavior of a particular user as well as other users to provide different user interface elements that the user need not expect. This provides the system with a significant collaborative capability in which the work of multiple users can be shown simultaneously in the user interfaces generated by the user interface module 290 so that users collaborating can see data sets, models, projects, experiments etc. that are being created and/or used by others. The user interface module 290 can also generate and offer best practices, and, as mentioned above, can provide an audit trail so others may see what actions were performed by others as well as identify the others that changed items. In some implementations, the user interface module 290 also provides further collaborative capabilities by allowing users to annotate any item with notes or provide instant messaging about an item or feature.

FIGS. 3A-3B are example graphical representations of embodiments of the user interface for importing a dataset. In FIG. 3A, the graphical representation 300 illustrates a first portion of the user interface 302 that includes a form for importing a dataset. The form includes fields, checkboxes, and buttons for entering information relating to importing a dataset for a project “small income.” The user interface 302 includes a location drop down field 304 that may be used to select a location associated with the file to be imported. For example, the file selected for importing may be a local file as illustrated. Another option could be a selection of a non-local, e.g., a Hadoop Distributed File System (HDFS) file from the location drop down field 304 to link to the HDFS data. The user interface 302 includes a raw data view 306 of the raw dataset that was selected. In one embodiment, the raw data view 306 may present a sampling of the raw dataset that was selected. The user interface 302 includes a name field 308 for entering a name for the dataset. For example, the user may enter a name “small.income.test.ids” to indicate that the dataset selected for importing is a test dataset associated with the user's small income project. Under the name field 308, the user may select the check box 310 to indicate that the first line has column names in the dataset. The user interface 302 includes a separator drop down field 312 that may be used to indicate the separator being used in the selected dataset. For example, the user may indicate whether the separator is a comma, a tab, a semicolon, etc. The user interface 302 includes a check box 314 for the user to select to indicate that the dataset has a missing value identifier and enter the missing value identifier in the missing value indicator field 316. For example, the missing value identifier may be a character such a ‘?’ or a string such ‘null’. In one embodiment, the user interface 302 auto-populates the fields, selects the checkboxes, etc. based on processed information relating to the selected dataset. The user interface 302 includes a “Preview” button 318 which the user may select to preview a sample of the dataset which is illustrated in FIG. 3B.

In FIG. 3B, the graphical representation 350 illustrates a second portion of the user interface 302 that may be accessed by using the scroll bar 320 located on the right of the user interface 302 in FIG. 3A. The user interface 302 includes a dataset preview section that previews a sample set of rows (e.g. rows 1-100) processed from the selected dataset in the table 322 responsive to the user clicking the “Preview” button 318 in FIG. 3A. The user may use the table 322 to help the user identify one or more columns in the dataset as text blob columns and/or identifier columns. For example, a column designated as a text blob column may include a value as a path to an external file which may be a dataset on its own. In another example, the text blob column may be a column including a large piece of text inline as a value. The user interface 302 includes a drop down menu 324 for designating a column as a text blob column. For example, the user may choose “No Selection” from the drop down menu 324 if there are no columns to be designated as text blob columns. The user interface 302 also includes a drop down menu 326 for designating a column as an identifier column. The identifier column is a column in the dataset that is made up of unique values generated by the database from where the dataset is retrieved. When the user is satisfied with the preview of the dataset which resulted from the selections made in the drop down menus 324 and 326, the user may select “Import” button 328 to import the dataset.

FIG. 4 is an example graphical representation 400 of an embodiment of a user interface 402 displaying a list of datasets. The user interface 402 includes information relating to the “Datasets” tab 404 of the project “small income.” For example, the user interface of a project-based workspace consolidates information including the datasets, models, results, and plots associated with the project for the user. The user interface 402 includes a table 406 of the datasets that are associated with the project “small income.” The table 406 includes relevant information that describes the datasets at a glance to the user. For example, the table 406 includes relevant metadata as to when the dataset was last updated, a name of the dataset, an ID of the dataset, a type of dataset (e.g., imported, derived, etc.), data state (e.g., sample, full, etc.), rows, columns, number of models created for the dataset, and a status of the dataset (e.g., in progress, ready, etc.). In one embodiment, the table 406 may be interactive where it can be sorted and/or filtered. For example, the user can sort the datasets in the table 406 based on columns including last updated, ID, data state, number of rows, number of models, status, etc. In another example, the user can filter the datasets in the table 406 based on similar or more extensive criteria. The user may select a dataset 408 in the table 406 and retrieve a drop down menu 410. It should be understood that it is possible for the user to hover over the dataset 408 with an indicator (e.g., a cursor) used for user interaction on the user interface 402 or to right-click on a dataset 408 to retrieve the drop down menu 410. The drop down menu 410 includes a set of options to help the user to understand more about the dataset 408 and/or to perform an action relating to the dataset 408. For example, the user may view details including statistics, columnar information, etc. derived for the dataset 408 during processing by selecting “View details” option in the drop down menu 410. The user may create a model using the dataset 408 by selecting “Create model” option in the drop down menu 410. The user may view the relationship between the dataset, models, results, etc. represented in a directed acyclic graph (DAG) view by selecting “View graph” option in the drop down menu 410. The user may initiate processing of the entire dataset 408 to commit the dataset 408, if the dataset 408 was just sampled initially, by selecting “Commit dataset” option in the drop down menu 410. The user may also test a model, if available, on the dataset by selecting “Predict & Evaluate” option in the drop down menu 410. In one embodiment, when the user selects “Predict & Evaluate” option in a drop down menu similar to drop down menu 410, but associated with the test dataset above dataset 408, the user interface 402 includes models that conform to the test dataset. Also, the user interface 402 may filter out models that are in error state and includes the models that are in the ready state. The user interface 402 identifies models that are applicable to test dataset for “Predict & Evaluate” but in the processing stage in a grayed out fashion to indicate that the model is currently unavailable. In one embodiment, the user interface 402 provides an option in the drop down menu for the user to schedule the “Predict & Evaluate” task on a model that is currently in the processing stage and the task gets triggered once the model is in the complete stage.

FIGS. 5A-5B are example graphical representations of an embodiment of a user interface 502 displaying a model creation form for classification models. In FIG. 5A, the graphical representation 500 includes a user interface 502 that guides the user in creating a model. The user interface 502 may be generated in response to the user selecting “Create model” option in the drop down menu 410 relating to the dataset 408 entry in FIG. 4. Alternatively, the user interface 502 may be reached in response to the user selecting the “Models” tab 412 in FIG. 4. The user interface 502 includes a form. The form includes fields, radio buttons, check boxes, and drop down menus for receiving information relating to creating a model for the project “small income.” In one embodiment, the user interface 502 is dynamic and the form is auto-generated based on a conditional logic that is validating every input entered into the form by the user. The user interface 502 includes a dataset field 504 for selecting a dataset to be used for training and tuning the model. In one embodiment, the dataset field 504 may be auto-populated in response to the user selecting “Create model” option in the drop down menu 410 relating to the dataset 408 entry in FIG. 4. The user interface 502 includes a model name field 506 for entering a name for the model in the form. For example, the user may enter a name “small.income.classification” to associate the model name with a classification model. Next, the user may select an objective column 508 for the model by selecting the drop down menu 510. For example, the user may select “yearly-income” as the objective column. The user interface 502 auto-populates the form and dynamically changes the form according to the objective column value selected. For example, the yearly-income objective column is categorical since it may be a binary value that is less than or greater than some number. The form identifies the machine learning task as a classification problem under ML task 512. In another example, if the objective column selected is a continuous value, then the form may identify the ML task 512 as a regression problem. The user interface 502 includes a method field 514 for selecting a classification method. The user interface 502 initially auto-selects the method to be an “automodel” as shown in the field 514. The user interface 502 dynamically changes the parameter section 516 in the form to match the automodel method and organizes the parameter section 516 hierarchically in the form to enable the user to explore the model creation process. The method field 514 includes a drop down menu 518 that lists a library of classification models available to the user. The user may select a model other than automodel from the library of classification models. For example, the user may select gradient boosted trees (GBT) model for classification by selecting GBT under the drop down menu 518 or another model by selecting the acronym associated with that model (e.g. RDF, GLM and SVM are illustrated as examples of other classification models).

In FIG. 5B, the graphical representation 550 illustrates a dynamically updated user interface 502 in response to the user selecting GBT as a classification method under the method field 514 in FIG. 5A. In one embodiment, the user interface 502 dynamically updates the parameter section 516 in the form based on the JavaScript Object Notation (JSON) specification of what the selected model (i.e. GBT) may expect as input parameters. The parameter section 516 includes a search iterations field 520 for the user to enter the number of iterations to go through during the GBT model building process. The user may select the model validation type to be holdout under the model validation type drop down field 522 and enter the holdout ratio in the holdout ratio field 524 included within the parameter section 516. Similarly, the user may select Gini as the classifier testing objective 526 and F-score as the classification objective 528. In one embodiment, the user may enable the model to be exportable as a Predictive Model Markup Language (PMML) file format by checking the “Enable PMML” check box 530. The user may also select the resource environment 532 to allocate resources for the model building process. For example, the user may decide on how many containers, how much memory and cores to allocate for the model building process. In some implementations, the user interface 502 auto-populates the field of the resource environment 532 based on the size of the dataset in the dataset field 504, the type of classification model selected and the associated model parameters of that type, etc. or a no resource environment field 532 is presented because the system automatically determines the resource environment. Lastly, the user may select the “Learn” button 534 to train and tune the model “small.income.classification” on the dataset “small.income.data.ids.”

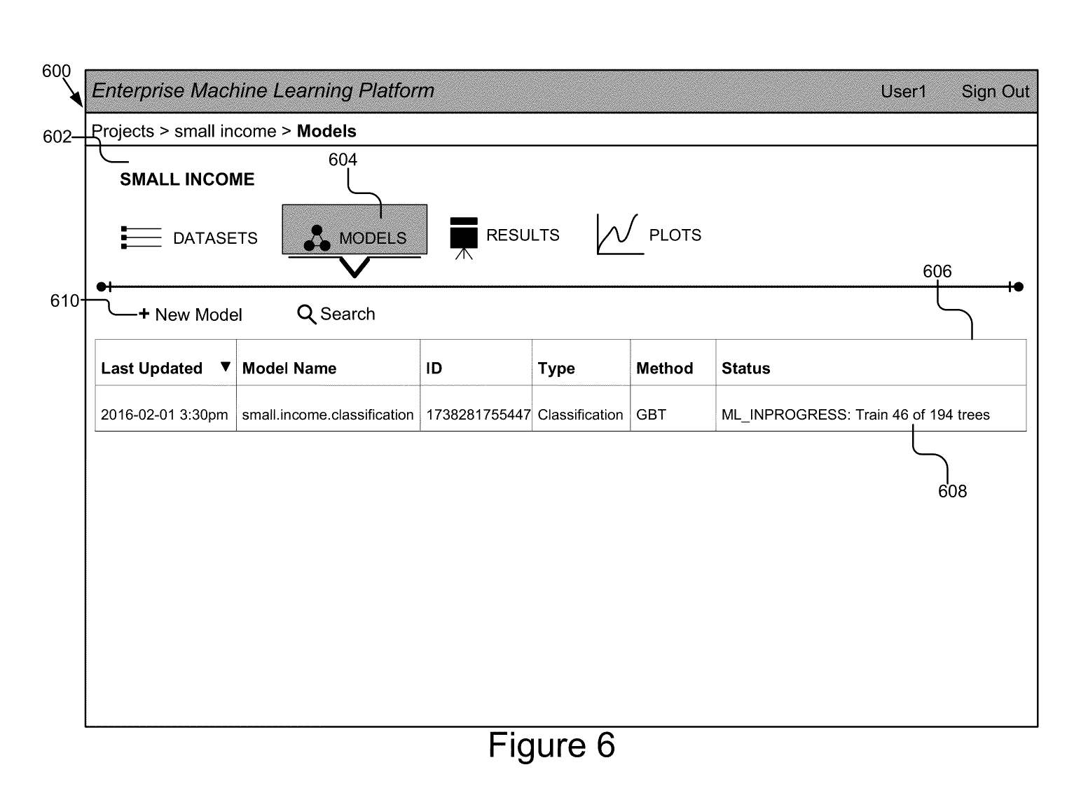

FIG. 6 is an example graphical representation 600 of an embodiment of a user interface 602 displaying a list of the models. The user interface 602 may be generated responsive to selecting the models tab 604 of the project “small income.” Alternatively, the user interface 602 may be generated in response to the user selecting the “Learn” button 534 in FIG. 5B. The models tab 604 includes a table 606 for consolidating presentation of the one or more models generated for the project “small income.” The table 606 includes relevant information that describes the models at a glance to the user. For example, the table 606 includes relevant metadata as to when the model was last updated, a name of the model, an ID of the model, a type of model (e.g., classification, regression, etc.), method (i.e., machine learning method for example automodel, GBT, SVM, etc.), and a status of the model (e.g., in progress, ready, etc.). In this embodiment of the user interface 602, the table 606 indicates the current status 608 of the model “small.income.classification” created from the model creation form in FIGS. 5A-5B. The current status 608 indicates that the learning (training and tuning) of the model is in progress. The entry for the model in the table 606 is selectable by the user to retrieve a set of options to understand the model and/or perform an action relating to the model. However, the set of options may be limited in this embodiment when the learning of the model is in progress. In one embodiment, the same user or another user may concurrently create multiple models on the same dataset in parallel and the user interface 602 dynamically queues up, for presentation, the corresponding model creation jobs in the table 606.

Referring to FIG. 7, an example graphical representation 700 of an embodiment of a user interface 702 displaying a model creation form for a regression model is described. The user interface 702 includes a form for the user to create a regression model on the dataset 408 represented in FIG. 4. In one embodiment, the user interface 702 may be generated in response to the user selecting the “New Model” tab 610 in FIG. 6 or in response to the user selecting the “Datasets” tab 404 and selecting “Create model” from the drop down menu 410 in the “Datasets” interface 402 of FIG. 4. The user interface 702 includes a model name field 706 for entering a name for the model in the form. For example, the user may enter a name “small.income.regression” to associate the model name with a regression model. Next, the user may select an objective column 708 for the model by selecting the drop down menu 710. The user interface 702 auto-populates the form and dynamically changes the form according to the objective column value selected. For example, the user may select “age” as the objective column. The “age” objective column is a continuous value since it may have any value, for example, in the range of 1-130. The user interface 702 identifies the ML task 712 as a regression problem in the form in response to the user selecting “age” as the objective column. The user interface 702 includes a method field 714 for selecting a regression method. The method field 714 includes a drop down menu 718 that lists a library of regression models available to the user. For example, the user may select gradient boosted trees (GBT) model for regression by selecting GBTR under the drop down menu 718. In response, the user interface 702 is dynamically updated so that the parameter section 716 matches the selected GBTR option (i.e. the parameters presented are those associated with GBTR). Lastly, the user may select the “Learn” button 734 to train and tune the model “small.income.regression” on the dataset “small.income.data.ids.”

FIG. 8 is another example graphical representation 800 of an embodiment of an updated user interface 602 displaying a list of models. In one embodiment, the updated user interface 602 in FIG. 8 may be generated in response to the user selecting the “Learn” button 734 in FIG. 7. In this embodiment of the user interface 602, the table 606 from FIG. 6 is updated to include an entry 808 for the regression model “small.income.regression” created from the model creation form in FIG. 7 in addition to a previous entry 810 for the classification model “small.income.classification” in the table 606. In one embodiment, the table 606 can be sorted and/or filtered. For example, the table 606 may be sorted and presented in any order based on one or more of the time when the models were last updated, model name, type, method, status, etc. In another example, the table 606 may be filtered to show only classification models sorted by “last updated” column and so on. The entry 808 for the regression model “small.income.regression” indicates under the status column that the learning of the model is in progress. The entry 810 for the classification model “small.income.classification” indicates under the status column that the model is ready. The user may select the entry 810 in the table 606 and retrieve a drop down menu 812. The drop down menu 812 includes a set of options to help the user to understand more about the model and/or to perform an action relating to the model associated with the entry 810. For example, the user may select “Predict & Evaluate” option 814 from the drop down menu 812 to test the classification model “small.income.classification.”

FIG. 9 is an example graphical representation 900 of an embodiment of a user interface 902 displaying a model prediction and evaluation form. In one embodiment, the user interface 902 may be generated in response to the user selecting “Predict & Evaluate” option 814 from the drop down menu 812 to test the classification model “small.income.classification” in FIG. 8. The user interface 902 includes a form where the user may input information for testing a model. The form includes a model name field 904 for the user to select a model to be tested. In this embodiment of the user interface 902, the model name field 904 may be auto-populated in response to the user selecting “Predict & Evaluate” option 814 from the drop down menu 812 to test the classification model “small.income.classification” in FIG. 8. The form includes a result name field 906 for the user to enter a name for the result to be generated from testing the model. For example, the user may enter a name “small.income.classification.predict” to associate the result with the classification model that is being tested. The form includes a dataset name field 908 for the user to select a test dataset to use in testing of the classification model “small.income.classification.” The test datasets available for selection is based on the model selected in the model field 904. The user interface 902 displays the test datasets that are eligible for the model “small.income.classification” based on matching the data columns of the model with the data columns of the test dataset. For example, the user may select “small.income.test.ids” as the test dataset in the dataset name field 908. In one embodiment, the dataset name field 908 is auto-populated in response to the user selecting “Predict & Evaluate” option in a drop down menu (similar to drop down menu 410, but associated with the test dataset above dataset 408 of FIG. 4) and the user fills out the model field 904 and the result name 906 field. The user may also allocate resources for the model testing by selecting options to populate the environment field 910 accordingly. In some implementations, the user interface 902 auto-populates the environment field 910 based on the size of the test dataset in the dataset field 908, the type of classification model selected and the associated model parameters of that type, result parameters, etc. Lastly, the user may select the “Predict & Evaluate” button 912 to predict and evaluate the model “small.income.classification” using the test dataset “small.income.test.ids.”

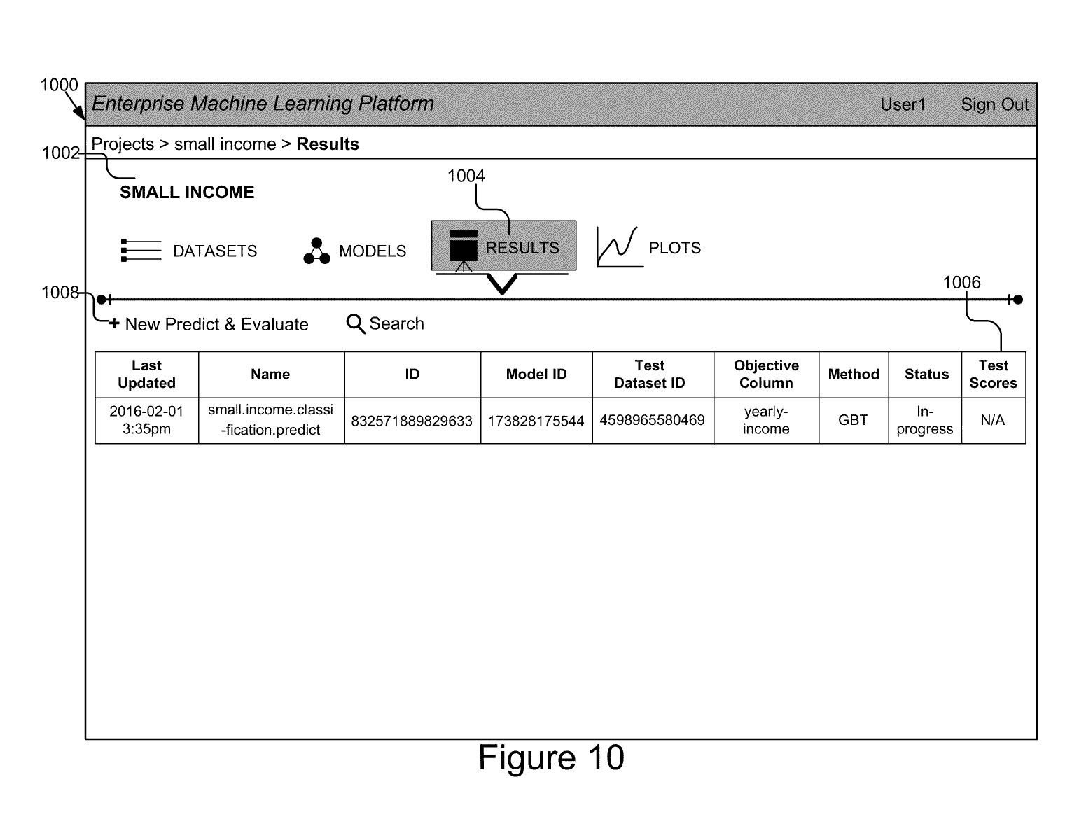

FIG. 10 is an example graphical representation 1000 of an embodiment of a user interface 1002 displaying results. The user interface 1002 may be generated responsive to selecting the results tab 1004 of the project “small income.” Alternatively, the user interface 1002 may be generated in response to the user selecting the “Predict & Evaluate” button 912 in FIG. 9. The results tab 1004 includes a table 1006 that consolidates the results generated from testing models for the project “small income.” The table 1006 includes relevant information that describes the results at a glance to the user. For example, the table 1006 includes relevant metadata as to when the result was last updated, a name of the result, an ID of the result, an ID of the model, an ID of the test dataset, an objective column, a method (i.e., a machine learning methods), a status of the result (e.g., in progress, ready, etc.), and test scores. In this embodiment of the user interface 1002, the table 1006 includes an entry for the result “small.income.classification.predict” input in the model prediction and evaluation form of FIG. 9. The entry in the table 1006 indicates that processing of the result “small.income.classification.predict” is in progress and, therefore, a test score is not yet provided (i.e. N/A).

FIG. 11 is another example graphical representation 1100 of an embodiment of an updated user interface 602 displaying a list of models. In this embodiment of the user interface 602, the table 606 from FIG. 8 is updated. The updated table 606 indicates under the status column for the entry 808 that the regression model “small.income.regression” is ready. The user may select the entry 808 in the table 606 and retrieve a drop down menu 812. The user may select “Predict & Evaluate” option 814 from the drop down menu 812 to test the regression model “small.income.regresssion.”

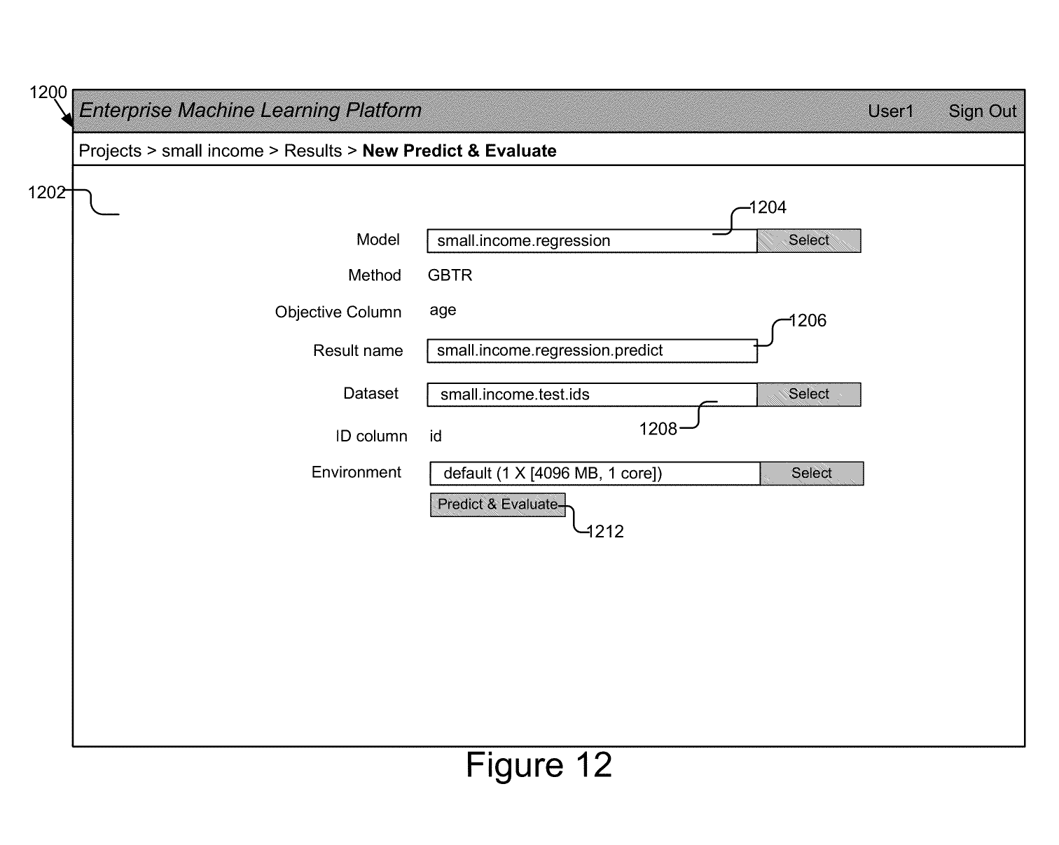

FIG. 12 is another example graphical representation 1200 of an embodiment of a user interface 1202 displaying a model prediction and evaluation form. The user interface 1202 includes a form where the user may input information for testing a model. In one embodiment, the user interface 1202 may be generated in response to the user selecting “Predict & Evaluate” option 814 from the drop down menu 812 to test the regression model “small.income.regression” in FIG. 11. In one such embodiment, the model name field 1204 in the form may be auto-populated to “small.income.regression” in response to the user selecting “Predict & Evaluate” option 814. In one embodiment, the user interface 1202 may be generated in response to the user selecting the “New Predict & Evaluate” tab 1008 in FIG. 10. The user selects the regression model to be tested to fill in the field 1204. The form includes a result name field 1206 for the user to enter a name for the result to be generated from testing the model. For example, the user may enter a name “small.income.regression.predict” to associate the result with the regression model that is being tested. The form includes a dataset name field 1208 for the user to select a test dataset to use in testing of the regression model “small.income.regression.” In one embodiment, the dataset name field 1208 is auto-populated in response to the user selecting “Predict & Evaluate” option in a drop down menu (similar to drop down menu 410, but associated with the test dataset above dataset 408 of FIG. 4) and the user fills out the model field 1204 and the result name 1206 field. Lastly, the user may select the “Predict & Evaluate” button 1212 to predict and evaluate the model “small.income.regression” using the test dataset in field 1208.

FIG. 13 is another example graphical representation 1300 of an embodiment of an updated user interface 1002 displaying a list of results. In this embodiment of the user interface 1002, the table 1006 from FIG. 10 is updated to include both the results generated for the classification model 1310 and the results generated for the regression model 1308. The table 1006 includes an entry 1308 for regression result “small.income.regression.predict” determined in response to the user selecting “Predict & Evaluate” button 1212 in FIG. 12 and the previous entry 1310 for classification result “small.income.classification.predict.” The table 1006 includes test scores for each of the results in entries 1308 and 1310. The test scores may be different based on the type of model. In one embodiment, the user may create multiple models on the same dataset with the same or different objective and test the models using a test dataset or different test datasets. The table 1006 may be updated dynamically to include the test scores for the multiple results on multiple models. In one embodiment, the table 1006 may be subjected to sorting and/or filtering operations. The table 1006 may be ranked based, e.g., on the test scores. For example, the table 1006 may work as a scoreboard so that the user may identify which result on which model out of several other results on different models had best performance accuracy among other metrics. In another example, the table 1006 can be filtered to show only classification models that are sorted by accuracy. In one embodiment, the user may select either of the entries 1308 or 1310 in the table 1006 to retrieve a drop down menu. In the illustrated embodiment, entry 1310 has been selected and drop down menu 1312 is presented. The drop down menu 1312 includes a set of options to help the user to understand more about the result and/or to perform an action relating to the result. For example, the user may view details of the classification result “small.income.classification.predict” by selecting the “View details” 1314 option in the drop down menu 1312 for the entry 1310. The details of classification result “small.income.classification.predict” is described further in reference to FIGS. 14A-14E below.

FIGS. 14A-14E are example graphical representations of an embodiment of the user interface displaying details of results associated with entry 1310 from testing a classification model.

In FIG. 14A, the graphical representation 1400 includes a user interface that includes a first portion 1402 and a second portion 1404. The first portion 1402 includes result information 1406 that summarizes details of the result “small.income.classification.predict,” a confusion matrix 1408 that describes the performance of the classification model “small.income.classification” on a subset of the test dataset “small.income.test.ids” for which ground true values are known, a cost/benefit weighted evaluation subsection 1410 which the user may use by selecting the check box “Enable,” a set of scores 1412 of the results on the model “small.income.classification” determined from the confusion matrix 1408 and test set scores 1414 that allows the user to export the labels and probabilities by selecting download buttons 1432 and 1434 corresponding to the labels 1436 and probabilities 1438 respectively. In one embodiment, the exported labels and probabilities may be joined with the original dataset to generate reports that are useful in data analysis. The second portion 1404 includes an interactive visualization 1416 of the results on the model “small.income.classification.” The user may interact with the visualization 1416 by checking the check box 1418 for “Adjust Probability Threshold” and moving the slider 1420.

In FIGS. 14B-14C, the graphical representations include an expanded view of the first portion 1402 of the user interface in FIG. 14A. In FIG. 14B, the user has selected the check box 1424 to perform a cost/benefit weighted evaluation. The first portion 1402 dynamically updates to reveal a set 1426 of options under the cost/benefit weighted evaluation subsection 1410. The values for the set 1426 of options may be changed by the user as desired to perform the cost/benefit weighted evaluation. The set 1426 of options have default values of 1 or −1 as shown. In FIG. 14C, the user changes the default values in the set 1426 of options as shown. In response, the first portion 1402 updates the confusion matrix 1408 and the scores 1412.

In FIG. 14D, the graphical representation 1460 includes an updated user interface of the combination of the first portion 1402 (with modified cost/benefit weighting as illustrated in the 1410) and the second portion 1404. In the second portion 1404, the user selects the check box 1418 adjacent to “Adjust Probability Threshold” to begin interacting with the visualization 1416. The user may move the slider 1420 anywhere on the straight line. The visualization 1416 includes a coordinate point 1430 that changes position on the visualization 1416 in response to the movement of the slider 1420 on the straight line. Initially, the slider 1420 is all the way to the left in a starting position. The position of the coordinate 1430 lies at the origin on the visualization 1416. The probability threshold and the percentile have initial default values as shown in the box 1428 due to the initial position of the slider 1420. The first portion 1402 updates the confusion matrix 1408, the cost/benefit weighted evaluation 1410, and the scores 1412 in response to a change in position of the slider 1420 on the straight line in the second portion 1404. In some embodiments, the options included under the cost/benefit weighted evaluation 1410 may allow a user to indicate a cost column or a cost based on per test point and that can affect the visualization 1416.

In FIG. 14E, the graphical representation 1480 includes another updated user interface of the combination of the first portion 1402 and the second portion 1404. In the second portion 1404, the user has moved the slider 1420 away from the initial position on the straight line. The coordinate point 1430 on the visualization 1416 moves to a new coordinate position in response. In one embodiment, the user may hover over the coordinate point 1430 with a cursor on the user interface to retrieve calculated values that change based on the movement of the slider 1420. The calculated values corresponding to the position of coordinate point 1430 is displayed in a box element 1432 over the visualization 1416 as shown.

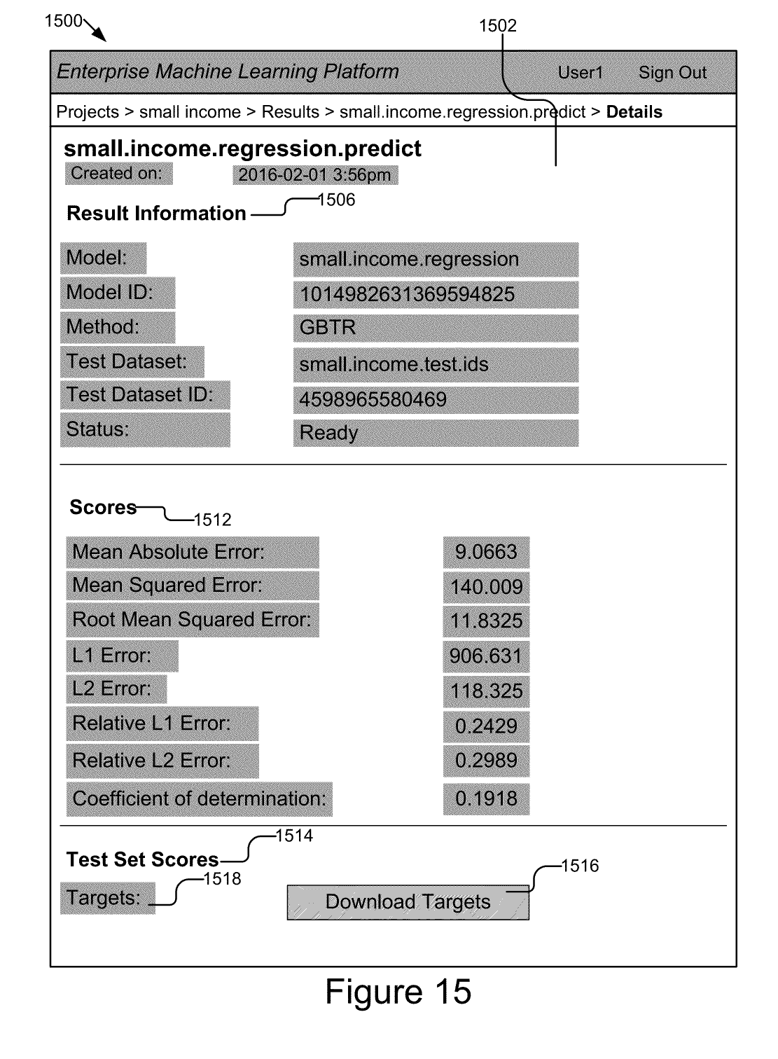

FIG. 15 is an example graphical representation 1500 of an embodiment of a user interface 1502 displaying details of results from testing a regression model. In one embodiment, the user interface 1502 may be generated in response to the user selecting to view details of the regression result “small.income.regression.predict” associated with the entry 1308 in FIG. 13. Similarly to FIGS. 14A-14E associated with the classification result, the user interface 1502 includes result information 1506 that summarizes the basic details of the result “small.income.regression.predict,” a set of scores 1512 of the results on the model “small.income.regression,” and test set scores 1514 that allows the user to export the target dataset by selecting the download button 1516 corresponding to the targets 1518. For example, the target dataset may be a thin vertical dataset including identity and target values and may be exportable as a Comma Separated Values (CSV) file. In one embodiment, the target dataset may be joined with the original dataset to generate a report.

FIGS. 16A-16B are example graphical representations of an embodiment of a user interface 1602 displaying the directed acyclic graph (DAG) for a classification model. The user may select a node in the DAG to identify dependencies that are upstream and/or downstream from the selected node. In FIG. 16A, the graphical representation 1600 includes a user interface 1602 that highlights the path from a selected node to other nodes that are upstream of the selected node in the DAG. In one embodiment, the user interface 1602 is generated in response to the user selecting “View graphs” option in the drop down menu 812 on an entry 810 for the classification model “small.income.classification” in FIG. 8. The DAG in the user interface 1602 is displayed with a node corresponding to the classification model pre-selected in the DAG. It should be understood that the DAG in the user interface 1602 may be generated by the user from a dataset item under the datasets tab 404 of FIG. 4, from a model item under the models tab 604 of FIG. 11, from a result item under the results tab of FIG. 13 and/or from the plot item under the plots tab 2004 of FIGS. 21C-21E. The DAG in the user interface 1602 may get displayed with the node corresponding to the item (e.g. the dataset, the model, etc.) pre-selected in the DAG.

The user interface 1602 includes a first checkbox 1604 for selecting an option “Display Upstream” to highlight the nodes that are upstream of the selected node in the DAG and a second checkbox 1606 for selecting an option “Display Downstream” to highlight the nodes that are downstream of the selected node in the DAG. The DAG represents dependencies between the nodes which may be used to identify relationships between models, datasets, results, etc. In the embodiment of the user interface 1602, the user selects the first check box 1604 for highlighting the one or more nodes that are upstream of the selected node 1608 which is the model “small.income.classification” highlighted in the DAG next to the selected node. There is one node 1612 that is upstream of the selected node 1608. The node 1612 is dataset “small.income.data.ids” which is highlighted in the DAG next to the node 1612. The model node 1608 has a dependency on the dataset node 1612 since the model “small.income.classification” is trained on the dataset “small.income.data.ids.”

In FIG. 16B, the graphical representation 1650 includes a user interface 1602 that highlights the path from a selected node to other nodes that are upstream and downstream of the selected node in the DAG in response to the user selecting the first checkbox 1604 associated with “Display Upstream” option and the second checkbox 1606 associated with “Display Downstream” option. The nodes that are downstream of the selected node 1608 include the nodes 1610, 1614, 1616 and 1618 respectively highlighted in the DAG. In one embodiment, the user may delete a node in the DAG and deletion may happen recursively downstream from the deleted node in the DAG. For example, if the user were to delete the model node 1608 in the DAG, the nodes that are downstream, such as nodes 1610, 1614, 1616 and 1618 may also be deleted from the DAG. In one embodiment, deleting a node in the DAG results in deleting corresponding table entries. For example, if the user were to delete model node 1608 in the DAG, the corresponding model, results and dataset entries would be deleted from the tables 606, 1006 and 406, respectively. In one embodiment, the DAG in the user interface 1602 can be sorted and/or filtered. For example, the DAG can be sorted by in the natural order of the graph in order of parent-child relationship. In another example, the DAG can be sorted and filtered by time, type of model, results, etc.

FIGS. 17A-17F are example graphical representations of embodiments of the user interface displaying details, tuning results, logs, visualizations, and model export options of a classification model. In one embodiment, the user interface illustrated in FIGS. 17A-17F may be generated in response to the user selecting the corresponding options in the drop down menu 812 on an entry 810 for the classification model “small.income.classification” in FIG. 8.

In FIG. 17A, the graphical representation 1700 includes a user interface 1702 that displays the details of the classification model “small.income.classification” under “Details” tab 1704. The details section 1706 includes the metadata associated with the classification model. The metadata may include parameters such as training specifications, tuning specifications, and testing specifications, etc. received as input from the user on the model creation forms in FIGS. 5A-5B. In one embodiment, the details section 1706 stores the metadata of the classification model in JSON format.

In FIG. 17B, the graphical representation 1720 includes the user interface 1702 that displays the tuning results of the classification model under “Tuning Results” tab 1722. The tuning results section 1724 includes a scatter plot visualization of the tuning run of the classification model with the Gini score on the Y axis and the parameter iterations on the X axis. It should be understood that the visualization of the tuning run may change based on one or more of the score selected on the Y-axis and the parameter selected on the X-axis in the tuning results section 1724.

In FIG. 17C, the graphical representation 1735 includes the user interface 1702 that displays the logs of the classification model building under “Logs” tab 1736. The logs section 1738 creates an audit trail of the classification model building by storing the entire log. The log may be useful for debugging and auditing the classification model. For example, there may be errors in the model building process when resource allocation may be insufficient for the task, when the parameter selection may cause the model building to try too many iterations, when the tree depth is too high, etc. The user may look at the logs section 1738 to identify how long it took for the model to be built and what were the different stages of model building.

In FIGS. 17D-17E, the graphical representations include the user interface 1702 that displays visualizations specific to the classification model under “Visualization” tab 1752. In FIG. 17D, the user interface 1702 displays the color coded tree visualization of the classification model when the user selects the “Trees” tab 1754. In this embodiment, the classification model is a Gradient Boosted Trees (GBT) model. The GBT model is a tree based model. It should be understood that there may be other classification models which are not tree based and the visualization of such classification models may not be color coded tree visualization. The user interface 1702 includes a pull down menu 1756 to select more trees of the classification model that may be visualized. The user interface 1702 includes a variable importance color legend 1758 that is linked to the color coded tree being visualized. The user may hover over a node 1760 in the color coded tree visualization to get more information, for example, tree depth, shape of the tree, etc. to understand the classification model and tune it accordingly. In one embodiment, the color coded tree visualization may provide insight about the data by way of its appearance. For example, a line thickness of a branch in the color coded tree visualization may represent a number of data points flowing through that part of the color coded tree.

In FIG. 17E, the user interface 1702 displays the bar chart visualization of variable importances of the classification model when the user selects the “Importances” tab 1766. The user interface 1702 includes the bar chart 1768 that identifies which variable or column is determined to be most valuable to the classification model. For example, the occupation column is determined to be most important for the classification model “small.income.classification.”

In FIG. 17F, the graphical representation 1780 includes the user interface 1702 that displays an option for the user to export the classification model when the user selects the “Export Model” tab 1782. The user interface 1702 includes a “Download” button 1784 that the user may select to export the model. In one embodiment, the classification model “small.income.classification” may be exportable as a PMML file.

FIGS. 18A-18B are example graphical representations of an embodiment of a user interface 1802 displaying the directed acyclic graph (DAG) for a regression model. In the user interface 1802, the user may select a node in the DAG to identify dependencies that are upstream and/or downstream of the selected node similar to the description provided for the DAG of the classification model in FIGS. 16A-16B. In one embodiment, the user interface 1802 is generated in response to the user selecting “View graphs” option in the drop down menu 812 for an entry 808 for the regression model “small.income.regression” in FIG. 11.

In FIG. 18A, the graphical representation 1800 includes a user interface 1802 that displays additional details of the selected node 1808 in the section 1810 adjacent to the DAG. The selected node 1808 is the regression model “small.income.regression” highlighted in the DAG next to the selected node. The additional details in the section 1810 for the selected node 1808 include the status, tree depth, learning rate among other information to give detailed information on the selected node 1808. It should be understood that if the selected node is a different item, for example, a dataset, a result, etc. the section 1810 dynamically updates to display additional details of the corresponding item. It should also be understood that the section 1810 displaying additional details of a selected node is not exclusive to the DAG for the regression model. For example, while not shown or discussed above with reference to FIGS. 16A and 16B, in one embodiment, a section may display details of a selected node in a DAG of a classification model.

FIGS. 19A-19F are example graphical representations of embodiments of the user interface displaying details, tuning results, logs, visualizations, and model export options of a regression model. In one embodiment, the user interface illustrated in FIGS. 19A-19F may have been generated in response to the user selecting the corresponding options in the drop down menu 812 on an entry 808 for the regression model “small.income.regression” in FIG. 11. It should be understood that much of the description provided for FIGS. 17A-17F relating to the classification model may be applicable to the FIGS. 19A-19F relating to the regression model.

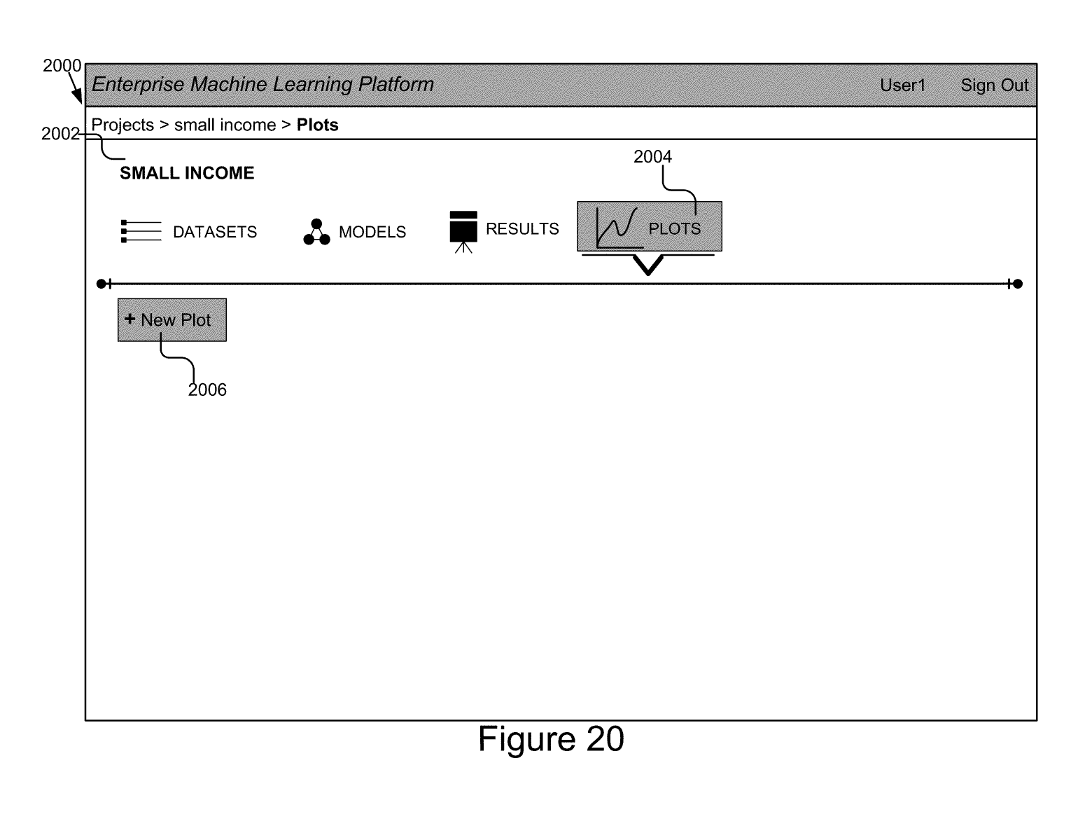

FIG. 20 is an example graphical representation 2000 of an embodiment of a user interface 2002 displaying an option for generating a plot. The user interface 2002 may be generated when the user selects the plots tab 2004. The user may select the “New Plot” button 2006 to generate a new plot. In one embodiment, the plots may be extensible where the user may upload custom visualization operations into the plots library that may be used and re-used for visualization across the items including projects, models, results, datasets, etc.

FIGS. 21A-21G are example graphical representations of embodiments of a user interface displaying model visualization and result visualization of the classification model. In FIG. 21A, the graphical representation 2100 includes a user interface 2102 displaying a form for creating a model visualization for a classification model. The user interface 2102 may be generated in response to the user selecting the “New Plot” button in FIG. 20. The user interface 2102 includes a form where the user may input information for generating a plot. The form includes radio buttons that may be selected by the user to indicate what type of plot is to be generated. For example, a plot for model visualization, a result visualization or a dataset visualization. The user may select the radio button 2104 corresponding to model visualization to indicate that plots for model are to be generated. In response to the selection of the type of visualization (e.g. model, result or dataset), the user interface 2102 dynamically updates the rest of the form to include options that relate to model visualization. Alternatively, the user interface 2102 may be generated and the radio button pre-selected based on selection of an option from a drop down menu. For example, responsive to a user selecting a “Plots” option (not shown) from a drop down menu associated with entry 810, the model visualization radio button 2104 is auto-selected and the model name field 2106 is auto-populated. The form includes a model name field 2106 for the user to select a model to be visualized in the plot. For example, the user may select the classification model “small.income.classification.” Alternatively, the user interface 2102 may be generated and the radio button pre-selected based on selection of an option from a drop down menu. For example, responsive to a user selecting a “Plots” option (not shown) from a drop down menu 812 associated with entry 810 in FIG. 8, the model visualization radio button 2104 is auto-selected and the model name field 2106 is auto-populated. During the building of the classification model “small.income.classification,” the partial dependence plots (PDP) for important variables or features may be automatically generated. For example, the partial dependence plots generated may be a single PDP variable and two PDP variables. The form includes a menu 2110 for the user to select the PDP variables 2108 that the user desires to be visualized.

In FIG. 21B, the graphical representation 2120 includes the updated user interface 2102 that displays the set 2122 of single PDP variable and two PDP variable selected by the user for visualization. The user may select the “Create” button 2124 to generate the plots.

FIGS. 21C-21E are example graphical representations of embodiments of a user interface displaying the model visualization of the classification model. In FIG. 21C, the graphical representation 2130 includes a user interface 2002 that displays the plots generated in response to the user selecting the “Create” button 2124 in FIG. 21B. The user interface 2002 may display different types of plots including, for example, bar graphs, line graphs, color grids, etc. In one embodiment, the user interface 2002 renders the plots based on whether the single PDP variable and the two PDP variables being compared in the plots are categorical or continuous. For example, if the two PDP variables being compared are categorical-categorical, then the plot may be heat map visualization. In another example, if the two PDP variables being compared are continuous-categorical, then the plot may be a bar chart visualization. In one embodiment, the user may override the plots shown in the tiles of the user interface 2002 with a custom plot. The user interface 2002 displays a plot in a single tile 2132 for each of the single variable PDP and two variable PDPs selected by the user in FIGS. 21A-21B. When the plot is being generated in the user interface 2002, the tile 2132 will display a progress icon that indicates to the user that the plot is being generated. In one embodiment, the plots displayed under the plots tab 2004 are persistent so the user may log out, log in, and resume interacting with the plots. Taking the example of the plot 2134 in the tile 2132 corresponding to the two variable PDP (age, education-num), the user interface 2002 includes plot information 2136 that gives some details relating to the plot 2134. The user may hover over the plot 2134 to zoom-in and zoom-out as needed. The user may reset the view of the plot 2134 to normal by selecting the reset button 2138. The user may also choose to view the plot in full screen by selecting the full screen button 2140. The plot 2134 may also include a delete icon 2142 which the user may select to the delete the plot 2134 in the tile 2132. The user interface 2002 includes a “sort by” pull down menu 2144 for the user to sort the plots, for example, by date, by model ID, by plot types, etc. In another embodiment, the plots can be filtered. For example, the user can filter the plots for specific values or ranges of values of any column in the dataset. The user interface 2002 includes a scroll bar 2146 which the user may drag to view the plots generated for other single variable PDP and two variable PDPs included in FIGS. 21D-21E.

FIGS. 21F-21G are example graphical representations of embodiments of a user interface displaying the result visualization of the classification model. In one embodiment, FIG. 21F and user interface 2102 thereof may be generated and the radio button pre-selected based on selection of an option from a drop down menu. For example, responsive to a user selecting a “Plots” option (not shown) from a drop down menu 1312 associated with entry 1310 in FIG. 13, the results visualization radio button 2162 is auto-selected and the results name field 2166 is auto-populated. In one embodiment, FIG. 21F and the graphical representation 2160 includes the user interface 2102 that is an update of the version shown in FIGS. 21A-21B. For example, the form includes a radio button 2162 for result visualization which the user may select. In response, the user interface 2102 dynamically updates the rest of the form to include options that relate to the result visualization. The form includes a plot name field 2164 for the user to enter a name for the plot. For example, the user may enter “small.result.plot” for the name of the result plot. The form includes a result field 2166 for the user to select a result to be visualized. The form is dynamically based on the type of result selected by the user. For example, the user may select a classification result “small.income.classification.predict” to visualize. In response, the user interface 2102 updates the form to include the summarizer properties 2168 and the user may enter parameters in the “numBuckets” field 2170. In one embodiment, the summarizer properties 2168 may be included in the user interface 2102 due to the classification result “small.income.classification.predict” being large in data size and requiring subsampling of the data. The subsampling of the data in the classification result “small.income.classification.predict” generates a plot that is user manipulatable. In one embodiment, the user interface 2102 may include plot properties (not shown) where the user may send parameters to the custom plot script being used for generating a result plot. The user may select the “Create” button 2172 to generate the result visualization plot.

In FIG. 21G, the graphical representation 2180 includes the user interface 2002 that is an update of the version shown in FIGS. 21C-21E. The user interface 2002 includes a tile 2186 that displays the result plot 2188 generated in response to the user selecting the “Create” button 2172 in FIG. 21F. It should be understood that the tile 2186 of the result plot 2188 may be mixed in with the plots generated for the classification model in FIGS. 21C-21E under the plots tab 2004 and/or with plots generated for one or more of a dataset and a model. In one embodiment, under the plots tab 2004 any number of plots may be presented and those may be associated with one or more datasets, one or more models, one or more results or a combination thereof. In one embodiment, the legends and scales of the plots shown in FIGS. 21C-21E and FIG. 21G may also be customizable. For example, the user may view the plots in true scale, log scale, etc. as applicable to the plots.

FIGS. 22A-22F are example graphical representations of embodiments of a user interface displaying model visualization and result visualization of the regression model. It should be understood that the description provided for FIGS. 21A-21G relating to the classification model may be applicable to the FIGS. 22A-22F relating to the regression model.

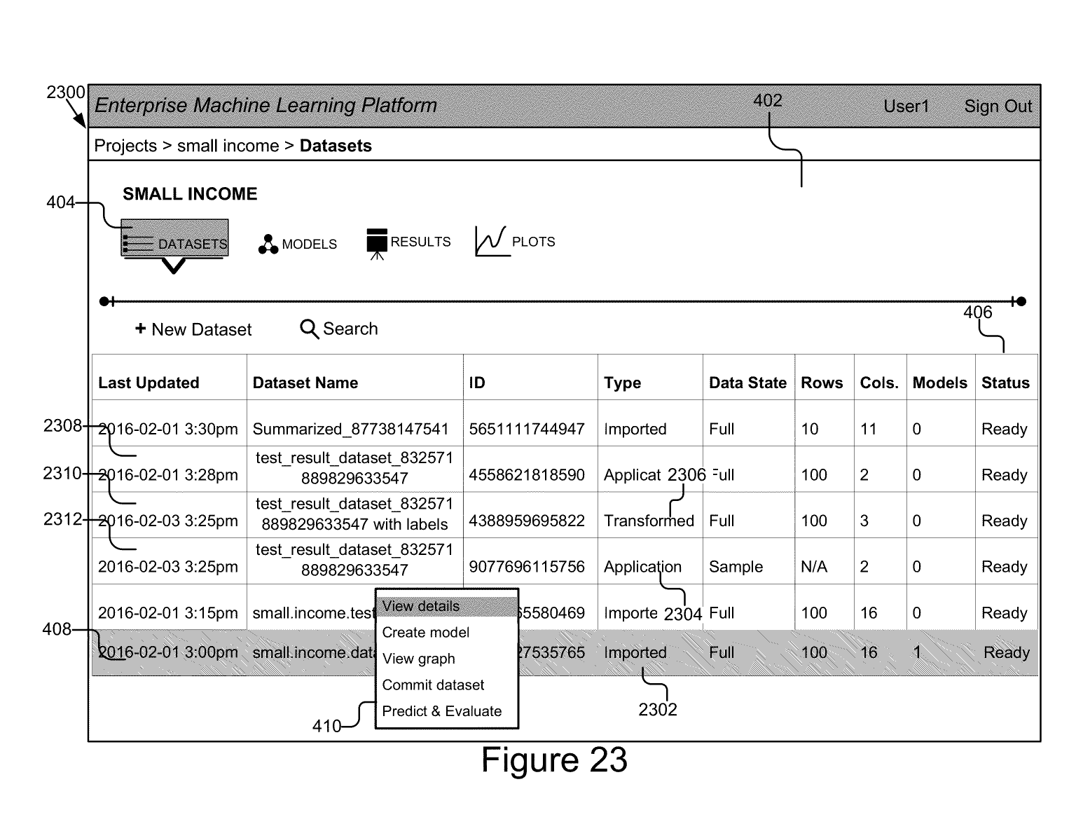

FIG. 23 is an example graphical representation 2300 of another embodiment of a user interface 402 displaying a table 406 of datasets. In FIG. 23, the user interface 402 is an update of the version shown in FIG. 4 after a sequence of model generation and result generation has taken place. The user interface 402 includes an updated table 406, which now includes three types of datasets: imported data type 2302, application data type 2304, and transformed data type 2306. The application data type 2304 and transformed data type 2306 fall under the derived data type as they get derived and created along the sequence of model generation and result generation. For example, the entries 2308, 2310, and 2312 that are added to the table 406 correspond to the nodes downstream of the classification model “small.income.classification” as shown in the DAG of FIG. 16B. These entries 2308, 2310, and 2312 are results of testing the classification model “small.income.classification” and may be alternatively accessed from the table 406.

FIGS. 24A-24D are example graphical representations of embodiments of a user interface displaying data, features, scatter plot, and scatter plot matrices (SPLOM) for a dataset. In one embodiment, the user interface illustrated in FIGS. 24A-24D may have been generated in response to the user selecting the “View details” option in the drop down menu 410 on an entry 408 for the dataset “small.income.data.ids” in FIG. 23.

In FIG. 24A, the graphical representation 2400 includes a user interface 2402 that displays the data view of the dataset “small.income.data.ids” under “Data” tab 2404. The user interface 2402 includes a table 2406 that samples data from the dataset. In FIG. 24B, the graphical representation 2425 includes the user interface 2402 that displays the features view of the dataset “small.income.data.ids” under “Features” tab 2426. The user interface 2402 includes a table 2428 that displays information including statistics of the features of the dataset made available to the user at a glance. In the illustrated embodiment, the table 2428 adds the individual column features of the dataset as a row in the table 2428. The table 2428 includes relevant metadata (e.g., inferred and/or calculated metadata) about the dataset automatically updated by the user interface 2402. For example, the name of the feature (e.g., age, workclass, etc.), a type of the feature (e.g., integer, text, etc.), whether the features is categorical (e.g., true or false), a distribution of the feature in the dataset based on whether the data state is sample or full, a dictionary (e.g., if the feature is categorical), a minimum value, a maximum value, mean, standard deviation, etc.

In FIG. 24C, the graphical representation 2450 includes the user interface 2402 that displays the scatter plot view of the dataset under “Scatter Plot” tab 2452. The user interface 2402 includes a visualization 2454 of the dataset for the user to understand the data. The user interface 2402 includes a pull down menu 2456 for the user to select the pair of feature columns of the dataset to visualize. In one embodiment, the user interface 2402 in FIG. 24C may be generated in response to the user selecting the radio button 2112 for “Dataset Visualization” in FIG. 21A. In one embodiment, the visualization 2454 may be removed by the user in case the user wants to visualize the dataset with a custom scatter plot script. In FIG. 24D, the graphical representation 2475 includes the user interface 2402 that displays scatter plot matrices (SPLOM) for visualizing pairwise comparison of features from the dataset under “SPLOM” tab 2476. The user interface 2402 includes a drop down menu 2478 where the user may select a column, for example, age. In response, the user interface 2402 generates scatter plots 2480 of pairwise comparison with other columns of the dataset. In one embodiment, the user may select a desired set of pairwise comparisons to be displayed in the user interface 2402.

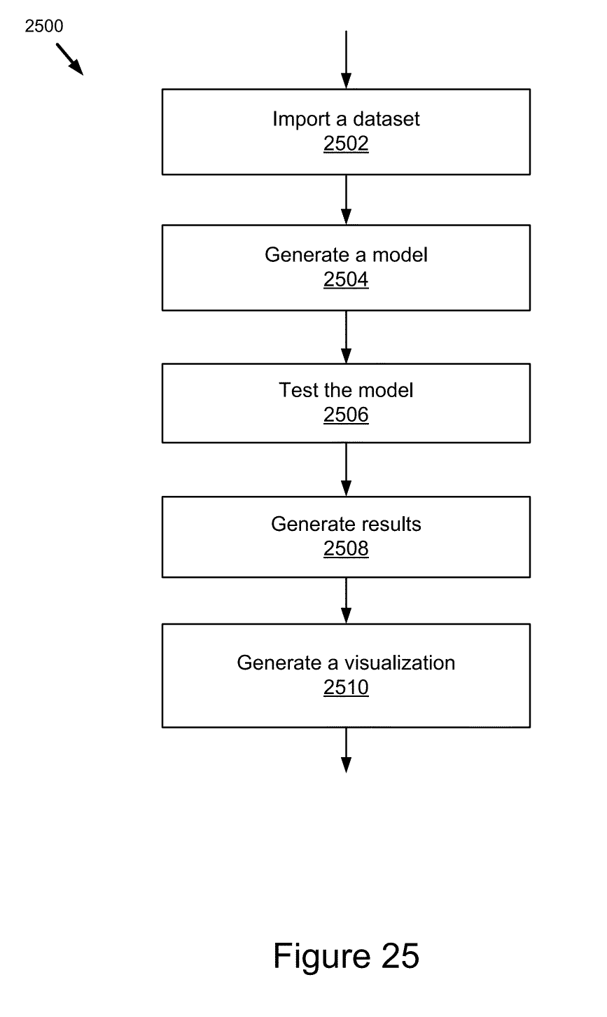

FIG. 25 is an example flowchart for a general method of guiding a user through machine learning model creation and evaluation according to one embodiment. The method 2500 begins at block 2502. At block 2502, the data science unit 104 imports a dataset. At block 2504, the data science unit 104 generates a model. At block 2506, the data science unit 104 tests the model. At block 2508, the data science unit 104 generates results. At block 2510, the data science unit 104 generates a visualization.

While not depicted in the flowchart of FIG. 25, it should be recognized that, in some embodiments, a user may import a test dataset prior to block 2506 and that test dataset may then be used at block 2506 to test the model. In some embodiments, the user may, via user input, indicate that a portion of the dataset imported at block 2502 should be withheld when generating the model at block 2504 and the withheld portion of that dataset is used at block 2506 to test the model generated at block 2504. For example, in one embodiment, while not shown, separate training and test datasets are created and presented in the table 406 under the datasets tab 404 when a user specifies a holdout ratio (e.g. See FIGS. 5A and 5B). It should also be recognized that importation of an independent dataset for test or withholding a portion of a dataset used to generate the model may apply to methods beyond that illustrated in FIG. 25. While not depicted in FIG. 25, it should also be recognized that, in some embodiments, multiple models may be created for the same dataset by the same or multiple users, or multiple results may be generated from the same model (i.e. the same model may be tested multiple times) by the same or multiple users, or multiple visualization may be generated from the same dataset, model or result by the same or multiple users, or a combination thereof.

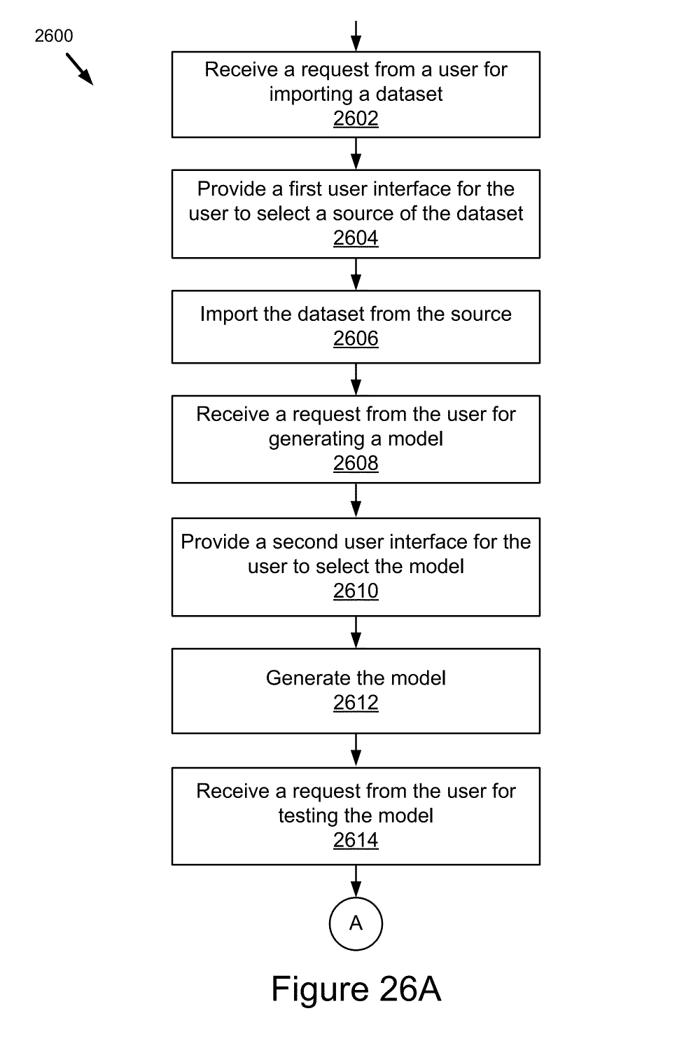

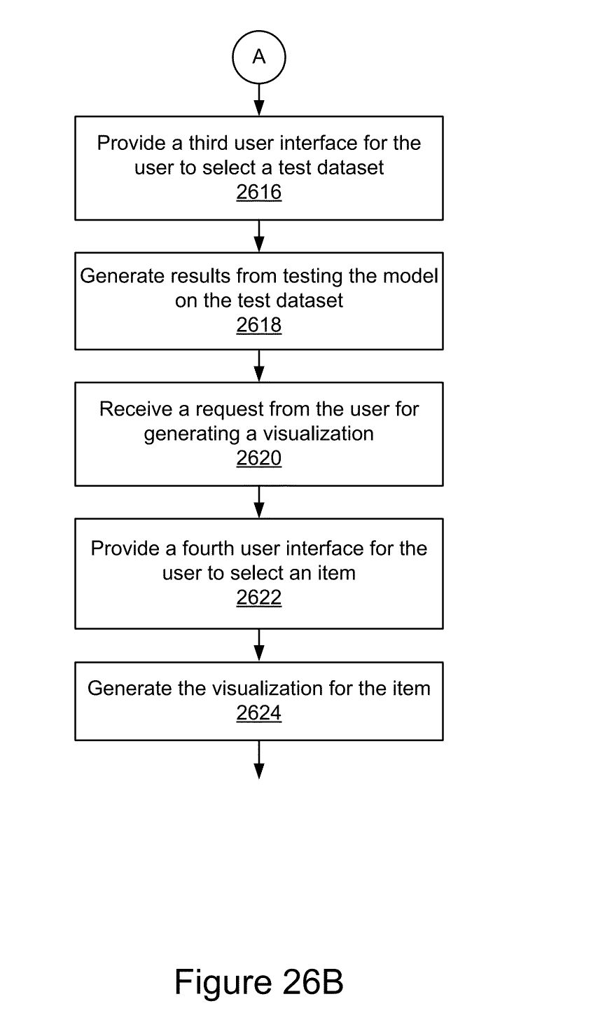

FIGS. 26A-B are an example flowchart for a more specific method of guiding a user through machine learning model creation and evaluation according to one embodiment. The method 2600 begins at block 2602. At block 2602, the data science unit 104 receives a request from a user for importing a dataset. At block 2604, the data science unit 104 provides a first user interface for the user to select a source of the dataset. At block 2606, the data science unit 104 imports the dataset from the source. At block 2608, the data science unit 104 receives a request from the user for generating a model. At block 2610, the data science unit 104 provides a second user interface for the user to select the model. At block 2612, the data science unit 104 generates the model. At block 2614, the data science unit 104 receives a request from the user for testing the model. The method 2600 continues at block 2616 of FIG. 26B. At block 2616, the data science unit 104 provides a third user interface for the user to select a test dataset. At block 2618, the data science unit 104 generates results from testing the model on the test dataset. At block 2620, the data science unit 104 receives a request from the user for generating a visualization. At block 2622, the data science unit 104 provides a fourth user interface for the user to select an item. At block 2624, the data science unit 104 generates the visualization for the item. Again, it should be recognized that the disclosure herein enables the same user or a different user collaborating with the user to generate any number of models (e.g. using different ML methods or parameters, etc.) from a single dataset and test a generated model any number of times (e.g. using different testing objectives).

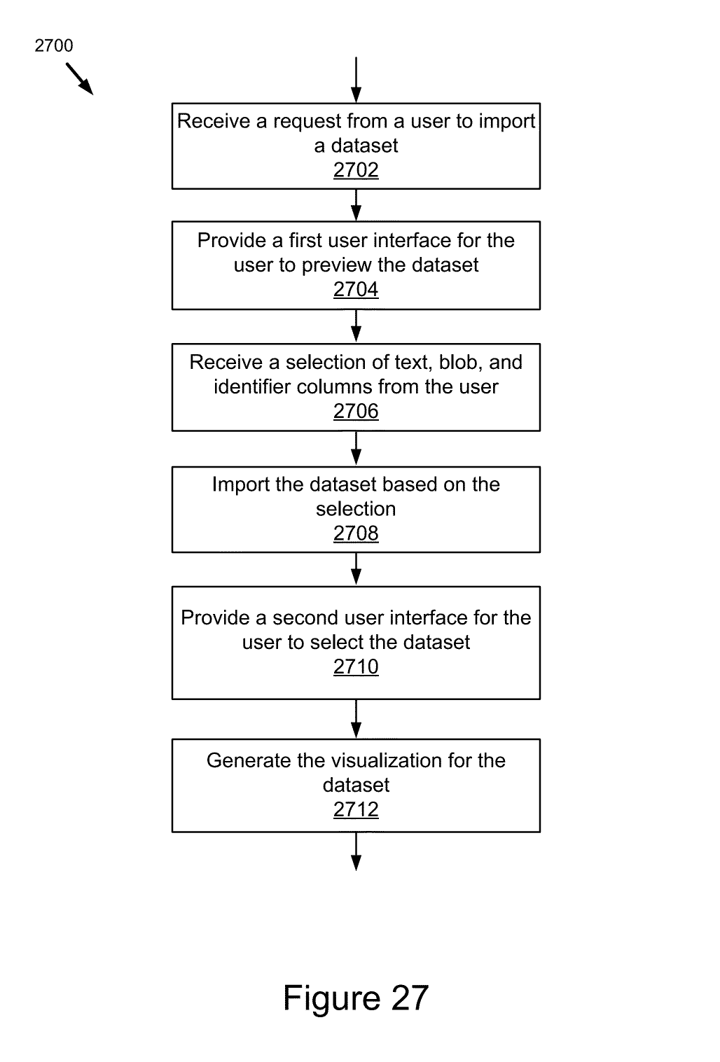

FIG. 27 is an example flowchart for visualizing a dataset according to one embodiment. The method 2700 begins at block 2702. At block 2702, the data science unit 104 receives a request from a user to import a dataset. At block 2704, the data science unit 104 provides a first user interface for the user to preview the dataset. At block 2706, the data science unit 104 receives a selection of a text blob and identifier column(s) from the user. At block 2708, the data science unit 104 imports the dataset based on the selection. At block 2710, the data science unit 104 provides a second user interface for the user to select the dataset. At block 2712, the data science unit 104 generates the visualization for the dataset.

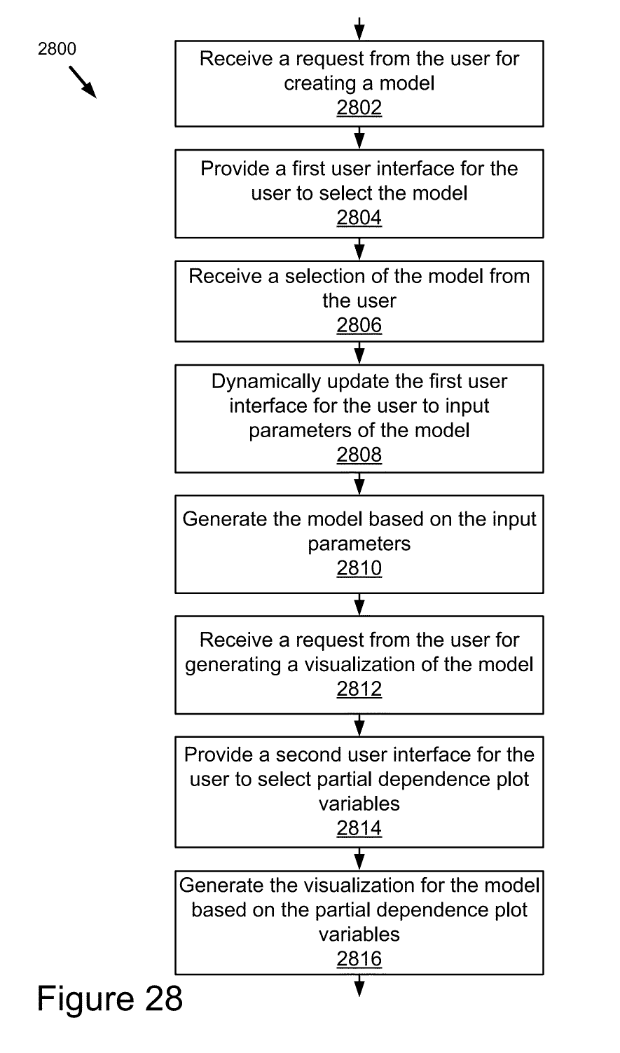

FIG. 28 is an example flowchart for visualizing a model according to one embodiment. The method 2800 begins at block 2802. At block 2802, the data science unit 104 receives a request from the user for creating a model. At block 2804, the data science unit 104 provides a first user interface for the user to select the model. At block 2806, the data science unit 104 receives a selection of the model from the user. At block 2808, the data science unit 104 dynamically updates the first user interface for the user to input parameters of the model selected at block 2804. At block 2810, the data science unit 104 generates the model based on the input parameters. At block 2812, the data science unit 104 receives a request from the user for generating a visualization of the model. At block 2814, the data science unit 104 provides a second user interface for the user to select partial dependence plot variables. At block 2816, the data science unit 104 generates the visualization for the model based on the partial dependence plot variables.

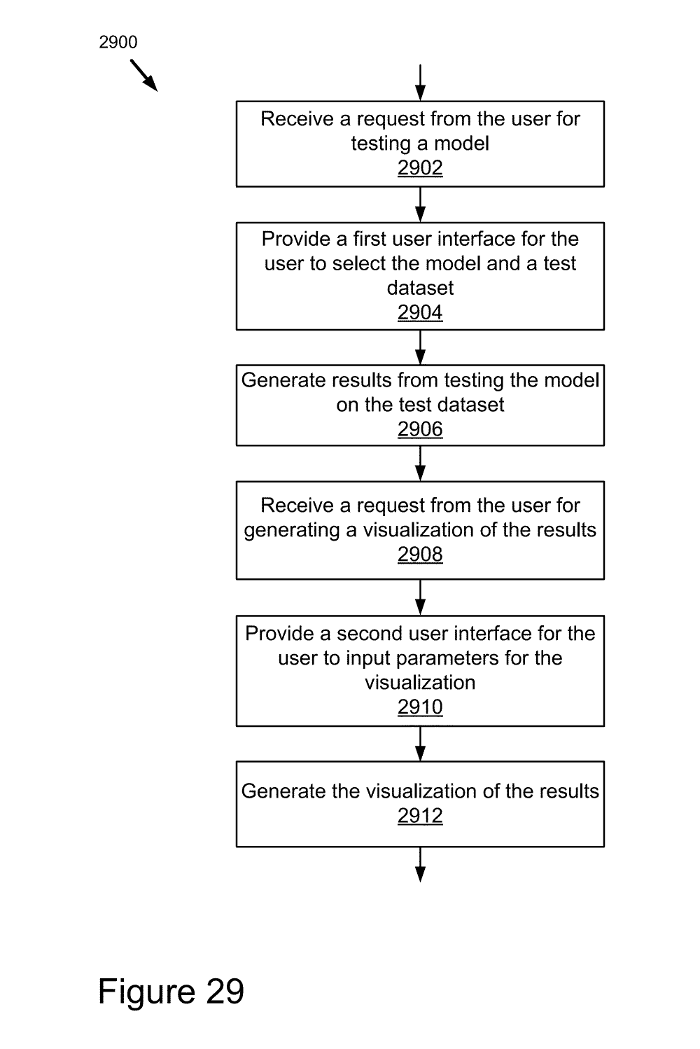

FIG. 29 is an example flowchart for visualizing results according to one embodiment. The method 2900 begins at block 2902. At block 2902, the data science unit 104 receives a request from the user for testing a model. At block 2904, the data science unit 104 provides a first user interface for the user to select the model and a test dataset. At block 2906, the data science unit 104 generates results from testing the model on the test dataset. At block 2908, the data science unit 104 receives a request from the user for generating a visualization of the results. At block 2910, the data science unit 104 provides a second user interface for the user to input parameters for the visualization. At block 2912, the data science unit 104 generates the visualization of the results.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention may be implemented as software, hardware, firmware or any combination of the three. Also, wherever a component, an example of which is a module, of the present invention is implemented as software, the component may be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A method comprising:
generating, using one or more processors, a data import interface for presentation to a user, the data import interface including a first set of one or more graphical elements that receive user interaction defining a dataset to be imported;
generating, using the one or more processors, a machine learning model creation interface for presentation to the user, the machine learning model creation interface including a second set of one or more graphical elements that receive user interaction defining a model to be generated;
generating, using the one or more processors, a model testing interface for presentation to the user, the model testing interface including a third set of one or more graphical elements defining a model to be tested and a test dataset; and
generating, using the one or more processors, a results interface for presentation to the user, the results interface including a fourth set of graphical elements informing the user of results obtained by testing the model to be tested with the test dataset.

2. The method of claim 1, wherein the first set of one or more graphical elements includes a first graphical element, a second graphical element and one or more of a third and a fourth graphical element, and the method further comprises:
receiving, via the user interacting with the first graphical element of the data import interface a user-defined source of the dataset to be imported;
receiving, via the user interacting with the second graphical element of the data import interface, a user-defined file including the dataset to be imported;
dynamically updating the data import interface for the user to preview at least a sample of the dataset to be imported;
receiving, via user interaction with one or more of the third graphical element and the fourth graphical element of the data import interface, a selection of one or more of a text blob and identifier columns from the user, wherein the third graphical element, when interacted with by the user, selects a text blob column and the fourth graphical element, when interacted with by the user, selects an identifier column; and
importing the dataset based on the user's interaction with the first graphical element, the second graphical element and one or more of the third graphical element and the fourth graphical element.

3. The method of claim 1, the second set of one or more graphical elements includes a first graphical element, a second graphical element, a third graphical element, a fourth graphical element and a fifth graphical element, and the method further comprises:
presenting to the user, via the first graphical element, a dataset used in generating the model to be generated;
dynamically modifying the second graphical element based on one or more columns of the dataset to be used in generating the model;
receiving, via user interaction with the second graphical element, a user-selected objective column to be used to generate the model, the objective column associated with the dataset to be used in generating the model;
dynamically modifying a third graphical element to identify a type of machine learning task based on the received, user-selected objective column;
dynamically modifying a fourth graphical element to include a set of one or more machine learning methods associated with the identified machine learning task; the set of machine learning methods omitting machine learning methods not associated with the machine learning task;
dynamically modifying a fifth graphical element such that the fifth graphical element is associated with a user-definable parameter set that is associated with a current selection from the set of a machine learning methods of the fourth graphical element; and
generating, responsive to user input, the currently selected model using the user-definable parameter set for the user-selected objective column of the dataset to be used for model generation.

4. The method of claim 3, wherein the machine learning task is one of classification and regression.

5. The method of claim 3, wherein the machine learning task is classification when the objective column is categorical and the machine learning task is regression when the objective column is continuous.

6. The method of claim 3, wherein the machine learning task is one of classification and regression and the set of machine learning methods includes a plurality of machine learning methods associated with classification when the learning task is classification and the set of machine learning methods includes a plurality of machine learning methods associated with regression when the machine learning task is regression.

7. The method of claim 1, wherein the fourth set of one or more graphical elements includes one or more of a confusion matrix, a cost/benefit weighting, a score, and an interactive visualization of the results, wherein:
the confusion matrix includes information about predicted positives and negatives and actual positives and negatives obtained when testing the model to be tested using the test dataset;
the cost/benefit weighting, responsive to user interaction, changes the reward or penalty associated with one of more of a true positive, a true negative, a false positive and a false negative, the confusion matrix dynamically updated based on the cost/benefit weighting
the score includes one or more scoring metrics describing performance of the model to be tested subsequent to testing; and
the interactive visualization presenting a visual representation of a portion of the results obtained by the testing.

8. The method of claim 7, wherein the fourth set of one or more graphical elements includes one or more of a graphical element associated with downloading one or more targets or labels, a graphical element associated with downloading one or more probabilities, and a graphical element that adjusts the probability threshold, wherein adjusting the probability threshold dynamically updates the score and the interactive visualization.

9. The method of claim 1, comprising:
generating a visualization for presentation to the user, including one or more of a visualization of tuning results, a visualization of a tree, a visualization of importances, and a plot visualization, wherein the plot visualization includes one or more plots associated with one or more of a dataset, a model and a result.

10. A system comprising:
one or more processors; and
a memory including instructions that, when executed by the one or more processors, cause the system to:
generate a data import interface for presentation to a user, the data import interface including a first set of one or more graphical elements that receive user interaction defining a dataset to be imported;
generate a machine learning model creation interface for presentation to the user, the machine learning model creation interface including a second set of one or more graphical elements that receive user interaction defining a model to be generated;
generate a model testing interface for presentation to the user, the model testing interface including a third set of one or more graphical elements defining a model to be tested and a test dataset; and
generate a results interface for presentation to the user, the results interface including a fourth set of graphical elements informing the user of results obtained by testing the model to be tested with the test dataset.

11. The system of claim 10, wherein the first set of one or more graphical elements includes a first graphical element, a second graphical element and one or more of a third and a fourth graphical element, and the instructions, when executed by the one or more processors, cause the system to:
receive, via the user interacting with the first graphical element of the data import interface a user-defined source of the dataset to be imported;
receive, via the user interacting with the second graphical element of the data import interface, a user-defined file including the dataset to be imported;
dynamically update the data import interface for the user to preview at least a sample of the dataset to be imported;
receive, via user interaction with one or more of the third graphical element and the fourth graphical element of the data import interface, a selection of one or more of a text blob and identifier columns from the user, wherein the third graphical element, when interacted with by the user, selects a text blob column and the fourth graphical element, when interacted with by the user, selects an identifier column; and
import the dataset based on the user's interaction with the first graphical element, the second graphical element and one or more of the third graphical element and the fourth graphical element.

12. The system of claim 10, the second set of one or more graphical elements includes a first graphical element, a second graphical element, a third graphical element, a fourth element and a fifth graphical element, and the instructions, when executed by the one or more processors, cause the system to:
present to the user, via the first graphical element, a dataset used in generating the model to be generated;
dynamically modify the second graphical element based on one or more columns of the dataset to be used in generating the model;
receive, via user interaction with the second graphical element, a user-selected objective column to be used to generate the model, the objective column associated with the dataset to be used in generating the model;
dynamically modify a third graphical element to identify a type of machine learning task based on the received, user-selected objective column;
dynamically modify a fourth graphical element to include a set of one or more machine learning methods associated with the identified machine learning task; the set of machine learning methods omitting machine learning methods not associated with the machine learning task;
dynamically modify a fifth graphical element such that the fifth graphical element is associated with a user-definable parameter set that is associated with a current selection from the set of a machine learning methods of the fourth graphical element; and
generate, responsive to user input, the currently selected model using the user-definable parameter set for the user-selected objective column of the dataset to be used for model generation.

13. The system of claim 12, wherein the machine learning task is one of classification and regression.

14. The system of claim 12, wherein the machine learning task is classification when the objective column is categorical and the machine learning task is regression when the objective column is continuous.

15. The system of claim 12, wherein the machine learning task is one of classification and regression and the set of machine learning methods includes a plurality of machine learning methods associated with classification when the learning task is classification and the set of machine learning methods includes a plurality of machine learning methods associated with regression when the machine learning task is regression.

16. The system of claim 10, wherein the fourth set of one or more graphical elements includes one or more of a confusion matrix, a cost/benefit weighting, a score, and an interactive visualization of the results, wherein:
the confusion matrix includes information about predicted positives and negatives and actual positives and negatives obtained when testing the model to be tested using the test dataset;
the cost/benefit weighting, responsive to user interaction, changes the reward or penalty associated with one of more of a true positive, a true negative, a false positive and a false negative, the confusion matrix dynamically updated based on the cost/benefit weighting
the score includes one or more scoring metrics describing performance of the model to be tested; and
the interactive visualization presenting a visual representation of a portion of the results obtained by the testing.

17. The system of claim 16, wherein the fourth set of one or more graphical elements includes one or more of a graphical element associated with downloading one or more targets or labels, a graphical element associated with downloading one or more probabilities, and a graphical element that adjusts the probability threshold, wherein adjusting the probability threshold dynamically updates the score and the interactive visualization.

18. The system of claim 10, wherein the instructions, when executed by the one or more processors, cause the system to:
generate a visualization for presentation to the user, including one or more of a visualization of tuning results, a visualization of a tree, a visualization of importances, and a plot visualization, wherein the plot visualization includes one or more plots associated with one or more of a dataset, a model and a result.

19. A system comprising:
one or more processors; and
a memory including instructions that, when executed by the one or more processors, cause the system to:
generate a user interface associated with a machine learning project for presentation to a user,
the user interface including a first graphical element, a second graphical element, a third graphical element, and a fourth graphical element, a data import interface for presentation to a user,
wherein the first, second, third and fourth graphical elements are user selectable and a first portion of the user interface is modified based on which graphical element the user selects,
the first, second, third and fourth graphical elements presented in a second portion of the user interface and the presentation of the first, second, third and fourth graphical elements is persistent regardless of which graphical element is selected except a selected graphical element is visually differentiated as the selected graphical element,
the first graphical element associated with datasets for the machine learning project, and, when selected, the first portion of the user interface is modified to present a table of any datasets associated with the machine learning project and the first portion includes a graphical element to import a dataset,
the second graphical element associated with models for the machine learning project, and, when selected, the first portion of the user interface is modified to present a table of any models associated with the machine learning project and the first portion includes a graphical element to create a new model,
the third graphical element associated with results for the machine learning project, and, when selected, the first portion of the user interface is modified to present a table of any result sets associated with the machine learning project and the first portion includes a graphical element to create new results, and
the fourth graphical element associated with plots for the machine learning project, and, when selected, the first portion of the user interface is modified to present any plots associated with the machine learning project and the first portion includes a graphical element to create a plot.

20. A system of claim 19, wherein:
the first portion of the user interface, when modified to present the table of any datasets associated with the machine learning project, includes one or more datasets used for one or more of training and testing a first model associated with the machine learning project and information about the one or more datasets,
the first portion of the user interface, when modified to present the table of any models associated with the machine learning project and the first portion, includes the first model and information about the first model,
the first portion of the user interface, when modified to present the table of any result sets associated with the machine learning project, includes a first set of results associated with a test of the first model and a test dataset and information about the first set of results, and
the first portion of the user interface, when modified to present any plots associated with the machine learning project, includes a first set of one or more plots associated with one or more of a dataset, a model and a result.
